(19) United States
(12) Patent Application Publication
(10) Pub. No.: US 2026/0041087 A1
(43) Pub. Date: Feb. 12, 2026

(54) LIPID NANOPARTICLE FORMULATIONS FOR AGRICULTURAL APPLICATIONS

(71) Applicant: INVAIO SCIENCES, INC., Cambridge, MA (US)

(72) Inventors: Myra Afzal, Cambridge, MA (US); Elizabeth Davidson-Lowe, Cambridge, MA (US); Hailey Deanne Hanscom, Cambridge, MA (US); Jeffery Allen Hughes, Cambridge, MA (US); Meghan Lois Powers, Cambridge, MA (US); Robbie Charles Sabatelle, Cambridge, MA (US); Rama Krishna Simhadri, Cambridge, MA (US); Yunlong Yang, Cambridge, MA (US)

(21) Appl. No.: 19/294,545

(22) Filed: Aug. 8, 2025

Related U.S. Application Data
(60) Provisional application No. 63/681,017, filed on Aug. 8, 2024.

(51) Int. Cl. A01N 25/28; A01N 25/30; A01N 53/00; A01N 65/08; A01N 65/10; A01N 65/22; A01N 65/24; A01N 65/28; A01N 65/34; A01P 7/04

(52) U.S. Cl. CPC A01N 25/28; A01N 25/30; A01N 53/00; A01N 65/08; A01N 65/10; A01N 65/22; A01N 65/24; A01N 65/28; A01N 65/34; A01P 7/04

(57) ABSTRACT

Disclosed herein are compositions including a plurality of nature-derived lipid particles (NLPs) comprising phospholipids, essential oils, blends of essential oils and polar lipids, and optionally surface modifiers, and further comprising bioactives, wherein the NLPs comprise a hydrophobic core, for use in a variety of agricultural methods.

### CROSS REFERENCE TO RELATED APPLICATIONS

This application claims priority to provisional application U.S. Ser. No. 63/681,017, filed Aug. 8, 2024, which is hereby incorporated herein by reference in its entirety.

### BACKGROUND

The efficacy of an agricultural agent, e.g., a pesticide, applied to a plant, can be limited by the solubility of the agent, undesired interactions with soil, and the degree to which the agent is taken up by a plant or plant part and is distributed in the plant tissues. A need exists in the art for improving the solubility of hydrophobic agricultural agents, and development of compositions and formulations for efficient delivery of the agricultural agent to plants and biodistribution in plant tissues.

### SUMMARY

In one aspect herein is provided an agricultural composition comprising a plurality of nature-derived lipid particles (NLPs) each comprising: at least one essential oil; at least one phospholipid; and at least one surface modifier; wherein the NLPs comprise a hydrophobic core. In some embodiments the essential oil is derived from a plant or plant part, and comprises at least one or more of a phenolic, alcoholic and terpenoid compound. In some embodiments the essential oil is selected from the group consisting of cinnamon oil, tea tree oil, clove oil, Eucalyptus oil, hemp seed oil, patchouli oil, marjoram oil, thyme oil, sweet almond oil, cassia oil, lavender oil, basil oil, castor oil, pumpkinseed oil, citronella oil, cumin oil, amaranth oil, camphor oil, red raspberry oil, peanut oil, pine oil, tobacco oil, carrot seed oil, and spearmint oil.

In some embodiments the at least one essential oil is cinnamon oil.

In some embodiments the composition further comprises a non-polar lipid comprising at least one fatty acid. In some embodiments the non-polar lipid comprising at least one fatty acid is soybean oil or sunflower oil.

In some embodiments the at least one phospholipid is selected from the group consisting of phosphatidylcholine, phosphatidylethanolamine, phosphatidylinositol, phosphatidic acid, phosphatidyl serine, and 1.2-dimyristoyl-sn-glycero-3-phosphate. In some embodiments the at least one phospholipid is derived from a lecithin. In some embodiments the lecithin is sunflower lecithin, soy bean lecithin, or a synthetic lecithin.

In some embodiments the hydrophobic core comprises the essential oil. In some embodiments the hydrophobic core comprises the essential oil and the non-polar lipid comprising at least one fatty acid.

In some embodiments the NLPs comprise at least one phospholipid layer. In some embodiments the NLPs comprise at least one phospholipid bilayer. In some embodiments the NLPs have a micellar structure.

In some embodiments the surface modifier is selected from the group consisting of a glycolipid, a polysaccharide, a fatty acid ethoxylate, a linear alcohol ethoxylate, a cetyl trimethyl, a linear isopropylamine dodecybenzene sulfonate, a tristyrlphenol ethoxylate phosphate ester, a modified styrene acrylic co-polymer, a hydrophobically modified polycarboxylate polymer, an anionic polymer, a non-ionic acrylic copolymer, a non-ionic combination polymer, a tristyrlphenol polyalkylene oxide block copolymer, or a head group modified PEG lipid. In some embodiments the surface modifier is a modified styrene acrylic polymer. In some embodiments the surface modifier is a nonionic comb polymer. In some embodiments the surface modifier is integrated in the phospholipid layer. In some embodiments the surface modifier stabilizes the integrity of the NLPs.

In some embodiments the NLPs exhibit a negative surface charge as evidenced from a negative zeta potential. In some embodiments the negative zeta potential ranges between −5 and −100 mV.

In some embodiments the NLP particle size ranges between 50-1000 nm.

In some embodiments the composition further comprises at least one heterologous functional agent.

In some embodiments the heterologous functional agent is selected from the group consisting of a pesticidal agent, a fertilizing agent, a herbicidal agent, a plant-modifying agent, an insect attractant, a plant growth promoting agent, a biostimulant, and a plant immunity elicitor.

In some embodiments the pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.

In some embodiments (a) the antifungal agent includes at least one of azoxystrobin, mancozeb, prothioconazole, folpet, tebuconazole, difenoconazole, captan, bupirimate, fosctyl-AI, a strobilurin, dimoxystrobin, enestroburin, fluoxastrobin, kresoxim-methyl, metominostrobin, picoxystrobin, pyraclostrobin, trifloxystrobin, orysastrobin, a carboxamide, a carboxanilide, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M, methfuroxam, metsulfovax, ofurace, oxadixyl, oxycarboxin, penthiopyrad, pyracarbolid, salicylanilide, tecloftalam, thifluzamide, tiadinil, an N-biphenylamide, bixafen, boscalid, a carboxy lic acid morpholide, dimethomorph, flumorph, a benzamide, flumetover, fluopicolid, zoxamid, carpropamid, diclocymet, mandipropamid, silthiofam, an azole, a triazole, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, an imidazole, cyazofamid, imazalil, pefurazoate, prochloraz, triflumizole, a benzimidazole, benomyl, carbendazim, fuberidazole, thiabendazole, cthaboxam, etridiazole, hymexazol, a pyridine, fuazinam, pyrifenox, pyrimidines, cyprodinil, ferimzone, fenarimol, mepanipyrim, nuarimol, pyrimethanil, a piperazine, triforine, a pyrrole, fludioxonil, fenpiclonil, a morpholine, aldimorph, dodemorph, fenpropimorph, tridemorph, a dicarboximide, iprodione, procymidone, vinclozolin, acibenzolar-S-methyl, anilazine, captafol, dazomet, diclomezin, fenoxanil, folpet, fenpropidin, famoxadon, fenamidon, octhilinone, probenazole, proquinazid, pyroquilon, quinoxyfen, tricyclazole, a carbamate, a dithiocarbamate, ferbam, maneb, metiram, metam, propineb, thiram, zineb, ziram, diethofencarb, flubenthiavalicarb, iprovalicarb, propamocarb, a guanidine, dodine, iminoctadine, guazatine, kasugamycin, a polyoxin, streptomycin, validamycin A, a fentin salt, a sulfur-containing heterocyclyl compound, isoprothiolane, dithianone, an organophosphorous compound, edifenphos, fosetyl, fosetyl-aluminum, iprobenfos, pyrazophos, tolclofos-methyl, an organochlorine compound, thiophanate-methyl, chlorothalonil, dichlofluanid, toly lfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon. N-2-cyanophenyl-3.4-dichloroisothiazol-5-carboxamide. N-(3′0.4′0.5′-trifluorobiphenyl-2-yl)-3-difluoromethyl-1-methylpyrazole-4-carboxamide. 3-[5-(4-chlorophenyl)-2.3-dimethy lisoxazolidin-3-yl]-pyridine. N-(3′.+′-dichloro-4-fluorobiphenyl-2-yl)-3-difluoromethyl-1-methylpyrazol-e-4-carboxamide. 5-chloro-7-(4-methylpiperidin-1-yl)-6-(2.4.6-trifluorophenyl)-[1.2.4]tria-zolo [1.5-a]pyrimidine. 2-butoxy-6-iodo-3-propylchromen-4-one. N,N-dimethyl-3-(3-bromo-6-fluoro-2-methy]indole-1-sulfonyl)-[1.2.4]triazo-le-1-sulfonamide, methyl-(2-chloro-5-[1-(3-methylbenzyloxyimino)-ethyl]benzyl) carbamate, methyl-(2-chloro-5-[1-(6-methylpyrid in-2-ylmethoxy-imino)ethyl]benzyl) carbamate, methyl 3-(4-chlorophenyl)-3-(2-isopropoxy carbonyl lamino-3-methyl butyryl-amino) propionate. 4-fluorophenyl N-(1-(1-(4-cyanophenyl) ethanesulfonyl) but-2-yl) carbamate. N-(2-(4-[3-(4-chlorophenyl) prop-2-ynyloxy]-3-methoxyphenyl)ethyl)-2-metha-nesulfonylamino-3-methylbutyramide. N-(2-(4-[3-(4-chlorophenyl) prop-2-ynyloxy]-3-methoxyphenyl)ethyl)-2-ethan-esulfonylamino-3-methylbutyramide. N-(4′-bromobiphenyl-2-yl)-4-difluoromethyl-2-methylthiazol-5-carboxamide. N-(4′-trifluoromethylbiphenyl-2-yl)-4-difluoromethyl-2-methylthiazol-5-carboxamide. N-(4′-chloro-3′-fluorobiphenyl-2-yl)-4-difluoromethyl-2-methylt-hiazol-5-carboxamide, methyl 2-(ortho-((2.5-dimethylphenyloxy-methylene)phenyl)-3-methoxyacrylate, oxathiapiprolin, and esters and salts thereof: (b) the antibacterial agent includes at least one of a hypochlorite, sodium hypochlorite, a chloramine, dichloroisocyanurate, trichloroisocyanurate, wet chlorine, chlorine dioxide, a peroxide, peracetic acid, potassium persulfate, sodium perborate, sodium percarbonate, urea perhydrate, iodine, iodpovidone, ethanol. 1-propanol. 2-propanol. 2-phenoxyethanol, phenol, a cresol, a halogenated phenol, hexachlorophene, triclosan, trichlorophenol, tribromophenol, pentachlorophenol, a cationic surfactant, benzalkonium chloride, cetyl trimethylammonium bromide, cetyl trimethylammonium chloride, didecyldimethylammonium chloride, cetylpyridinium chloride, benzethonium chloride, chlorhexidine, glucoprotamine, octenidine dihydrochloride, an ozone solution, colloidal silver, silver nitrate, mercury chloride, phenylmercury salts, copper sulfate, copper oxide-chloride, copper hydroxide, copper octanoate, copper oxychloride sulfate, copper sulfate pentahydrate, phosphoric acid, nitric acid, sulfuric acid, amidosulfuric acid, toluenesulfonic acid, sodium hydroxide, potassium hydroxide, calcium hydroxide, sorbic acid, benzoic acid, lactic acid, salicylic acid, a penicillin, a cephalosporin, vancomycin, a polymyxin, a rifamycin, a lipiarmycin, a quinolone, a sulfonamide, an aminoglycoside, kasugamycin, a macrolide, a lincosamide, a tetracycline, a cyclic lipopeptide, daptomycin, a glycylcycline, tigecycline, an oxazolidinone, linezolid, fidaxomicin, rifampicin, ciprofloxacin, doxycycline, ampicillin, polymyxin B, gramicidin, isoniazid, pyrazinamide, ethambutol, myambutol, streptomycin, and esters and salts thereof: (c) the insecticidal agent includes at least one of a chloronicotinyl, a neonicotinoid, acetamiprid, clothianidin, dinotefuran, imidacloprid, nitenpyram, nithiazine, thiacloprid, thiamethoxam, imidaclothiz. (2E)-1-[(2-chloro-1.3-thiazol-5-yl)methyl]-3.5-dimethyl-N-nitro-1.3.5-tri-azinan-2-imine, an acetylcholinesterase (AChE) inhibitor, a carbamate, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chloethocarb, dimetilan, ethiofencarb, fenobucarb, fenothiocarb, formetanate, furathiocarb, isoprocarb, metam-sodium, methiocarb, methomyl, metolcarb, oxamyl, phosphocarb, pirimicarb, promecarb, propoxur, thiodicarb, thiofanox, triazamate, trimethacarb, XMC, xylylcarb, an organophosphate, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton. EPN, ethion, ethoprophos, ctrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos sulfotep, sulprofos, tebupirimfos, temephos, terbufos, tetrachlorvinphos, thiometon, triazophos, triclorfon, vamidothion, a pyrethroid, acrinathrin, allethrin (d-cis-trans, d-trans), cypermethrin (alpha-, beta-, theta-, zeta-), permethrin (cis-, trans-), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cyphenothrin. DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda, metofluthrin, phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralocythrin, tralomethrin, transfluthrin. ZXI 8901, a pyrethrin, pyrethrum, an oxadiazine, indoxacarb, an acetylcholine receptor modulator, a spinosyn. Spinosad, a cyclodiene, camphechlor, chlordane, endosulfan, gamma-HCH. HCH, heptachlor, an organochlorine, lindane, methoxychlor, a fiprole, acetoprole, ethiprole, vaniliprole, fipronil, a mectin, abamectin, avermectin, emamectin, emamectin-benzoate, fenoxycarb, hydroprene, kinoprene, methoprene, ivermectin, lepimectin, epofenonane, pyriproxifen, milbemectin, milbemycin, triprene, a diacy lhydrazine, chromafenozide, halofenozide, methoxyfenozide, tebufenozide, a benzoylurea, bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron, an organotin, azocyclotin, cyhexatin, fenbutatin oxide, a pyrrole, chlorfenapyr, a dinitrophenol, binapacyrl, dinobuton, dinocap. DNOC, a METI, fenazaquin, fenpyroximate, pyrimidifen, pyridaben, tebufenpyrad, tolfenpyrad, rotenone, acequinocyl, fluacrypyrim, a microbial disrupter of the intestinal membrane of insects, a Bacillus thuringiensis strain, an inhibitor of lipid synthesis, a tetronic acid, a tetramic acid, spirodiclofen, spiromesifen, spirotetramat, cis-3-(2.5-dimethylphenyl)-8-methoxy-2-oxo-1-azaspi ro [4.5]dec-3-en-4-yl ethyl carbonate, a carboxamide, flonicamid, an octopaminergic agonist, amitraz, an inhibitor of the magnesium-stimulated ATPase, propargite, a ryanodin receptor agonist, a phthalamide, rynaxapyr. N2-[1.1-dimethyl-2-(methylsulphonyl)ethyl]-3-iodo-N1-]2-methyl--4-[1.2.2.2-tetrafluoro-1-(trifluoromethyl)ethyl]phenyl]-1.2-benzenedi-carboxamide, spidoxamat, nicofluprole, tetraniliprole, tioxazafen, flupyradifuron, fluopyram, flubendiamide, deltametrin, permethrin, dimpropyridaz, broflanilide, afidopyropen, fluopyram, fluazaindolizine, triflumezopyrim, sulfoxaflor, spinetoram, chlorpyrifos, spinosad, cyantraniliprole, chlorantraniliprole, cypermethrin, plinazolin, cyclobutrifluram, spiropidion, fluensulfone, pymetrozine, thiamethoxam, lamda cy halothrin, oxazosulfyl, benzpyrimoxan, dichloromezotiaz, flupentiofenox, fluhexafon, fluxametamide, flupyrimin, cyhalodiamide, acynonapyr, cyclaniliprole, cyetpyrafen, cyproflanilide, tetrachlorantraniliprole, isocycloseram, broflanilide, spiropidion, and esters and salts thereof: (d) the molluscicidal agent includes at least one of a metal salt, iron phosphate, aluminium sulfate, ferric sodium EDTA, metaldehyde, methiocarb, and an acetylcholinesterase inhibitor: (c) the nematicidal agent includes at least one of a fumigant. D-D,1.3-dichloropropene, ethylene dibromide. 1.2-dibromo-3-chloropropane, methyl bromide, chloropicrin, metam sodium, dazomet, methyl Isothiocyanate (MITC), sodium tetrathiocarbonate, a carbamate, aldicarb, aldoxycarb, carbofuran, oxamyl, cleothocarb, an organophosphate, ethoprophos, fenamiphos, cadusafos, fosthiazate, fensulfothion, thionazin. Isazofos, and a biochemical; and (f) the herbicidal agent includes at least one of glufosinate, propaquizafop, metamitron, metazachlor, pendimethalin, flufenacet, diflufenican, clomazone, nicosulfuron, mesotrione, pinoxaden, sulcotrione, prosulfocarb, sulfentrazone, bifenox, quinmerac, triallate, terbuthylazine, atrazine, oxyfluorfen, diuron, trifluralin, chlorotoluron, a benzoic acid herbicide, dicamba, a phenoxyalkanoic acid herbicide. 2.4-D. MCPA, a 2.4-DB ester, an aryloxyphenoxypropionic acid herbicide, clodinafop, cyhalofop, fenoxaprop, fluazifop, haloxyfop, a quizalofop ester, a pyridinecarboxylic acid herbicide, aminopyralid, picloram, a clopyralid ester, a pyrimidinecarboxy lic acid herbicide, an aminocyclopyrachlor ester, a pyridyloxyalkanoic acid herbicide, fluoroxypyr, triclopyr, a hydroxy benzonitrile herbicide, bromoxynil, ioxynil, an arylpyridine carboxylic acid, an arylpyrimidine carboxylic acid, acetochlor, acifluorfen, alachlor, ametryn, amitrole, asulam, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate. DCPA, desmedipham, dichlobenil, diclofop, diclosulam, diethatyl, difenzoquat, diflufenzopyr, dimethenamid-p, diquat. DSMA, endothall. EPTC, cthalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glyphosate, halosulfuron, haloxyfop, hexazinone, imazamethabenz, imazamox, imazapic, imazaquin, imazethapyr, isoxaben, isoxaflutole, lactofen, linuron, MCPB, methazole, metolachlor-s, metribuzin, metsulfuron, molinate. MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triflusulfuron, vernolate, and esters and salts thereof.

In some embodiments the heterologous functional agent is hydrophobic. In some embodiments the heterologous functional agent is chlorantraniliprole (CTPR). In some embodiments the heterologous functional agent is fully soluble in the essential oil. In some embodiments the heterologous functional agent is fully dissolved in the essential oil. In some embodiments the heterologous functional agent is fully dissolved in the hydrophobic core. In some embodiments the heterologous functional agent is encapsulated in the NLP.

In some embodiments the essential oil increases the encapsulation efficiency of the heterologous functional agent in the NLP. In some embodiments the essential oil is cinnamon oil. In some embodiments the encapsulation efficiency is 100%.

In some embodiments the composition is formulated for delivery to a plant, a plant part, or a plant pest.

In some embodiments the composition further comprises an agriculturally acceptable carrier.

In some embodiments the heterologous functional agent is a volatile agent.

In some aspects, herein provided is an agricultural composition for increasing the solubility of a hydrophobic heterologous functional agent, comprising a plurality of NLPs each comprising: at least one essential oil, at least one phospholipid; at least one surface modifier; and a heterologous functional agent; wherein the NLPs comprise a hydrophobic core.

In some aspects, herein provided is an agricultural composition, comprising a plurality of NLPs each comprising; soy bean or sunflower lecithin: cinnamon oil; a nonionic, polymeric dispersant or a modified styrene acrylic polymer; and CTPR; wherein the NLPs comprise a hydrophobic core, and wherein the percent of cinnamon oil in the NLPs is at least 50% (w/w).

In some aspects, herein provided is a method of making an agricultural composition comprising a plurality of NLPs each comprising a heterologous functional agent, the method comprising the step of: applying energy to a solution comprising: at least one phospholipid; at least one essential oil; at least one surface modifier; a heterologous functional agent; and an aqueous solution; thereby forming the NLPs, wherein the NLPs comprise a hydrophobic core.

In some aspects, herein provided is an agricultural composition for increasing the uptake of a hydrophobic heterologous functional agent in a plant, the composition comprising a plurality of NLPs each comprising: at least one non-polar lipid comprising at least one fatty acid; at least one phospholipid or a synthetic lecithin derivative; and at least one heterologous functional agent; wherein the NLPs comprise a hydrophobic core.

In some embodiments the synthetic lecithin derivative is a lysophosphatidylcholine analog.

In some embodiments the composition further comprises an essential oil. In some embodiments the essential oil is spearmint oil or thyme oil. In some embodiments the composition further comprises at least one surface modifier. In some embodiments the surface modifier is a hydrophobically modified polycarboxylate or a modified styrene acrylic polymer.

In some embodiments the surface charge of the NLPs range between −20 to 60 mV.

In some embodiments the size of the NLPs range 150 and 450 nm.

In some embodiments the heterologous functional agent is hydrophobic. In some embodiments the at least one heterologous functional agent is a pyrethroid. In some embodiments the pyrethroid is permethrin. In some embodiments the at least one heterologous functional agent is pyrethroid and deltamethrin. In some embodiments the concentration of permethrin is about 10-100 mg/ml.

In some embodiments the heterologous functional agent is fully dissolved in the hydrophobic core. In some embodiments the heterologous functional agent is encapsulated in the NLP.

In one aspect herein is provided an agricultural composition comprising a plurality of NLPs each comprising; sunflower oil or a sunflower-spearmint oil blend; sunflower lecithin or a modified lecithin; at least one hydrophobic heterologous functional agent; and optionally, a hydrophobically modified polycarboxylate or modified styrene acrylic polymer; wherein the NLPs comprise a hydrophobic core.

In one aspect herein is provided an agricultural composition comprising a plurality of nature-derived lipid particles (NLPs) each comprising; sunflower oil; a synthetic lecithin derivative; and at least one hydrophobic heterologous functional agent; wherein the NLPs comprise a hydrophobic core. In some embodiments the synthetic lecithin derivative is a lysophosphatidylcholine analog.

In one aspect herein is provided an agricultural composition comprising a plurality of NLPs each comprising; sunflower oil; sunflower lecithin; a hydrophobically modified polycarboxylate; and at least one hydrophobic heterologous functional agent; wherein the NLPs comprise a hydrophobic core.

In one aspect herein is provided an agricultural composition comprising a plurality of NLPs each comprising; a sunflower-spearmint oil blend; a synthetic lecithin derivative; a modified styrene acrylic polymer; and at least one hydrophobic heterologous functional agent; wherein the NLPs comprise a hydrophobic core.

In some embodiments the synthetic lecithin derivative is a lysophosphatidylcholine analog. In some embodiments the composition comprises an agriculturally acceptable carrier. In one aspect herein is provided a method of making an agricultural composition comprising a plurality of NLPs each comprising a heterologous functional agent, the method comprising the step of: applying energy to a solution comprising; sunflower oil or a sunflower-spearmint oil blend; sunflower lecithin or a modified lecithin; at least one hydrophobic heterologous functional agent; optionally, a hydrophobically modified polycarboxylate or a modified styrene acrylic polymer; and an aqueous solution; thereby forming the NLPs, wherein the NLPs comprise a hydrophobic core.

In one aspect herein is provided a method of increasing the uptake of a heterologous functional agent in a plant, the method comprising contacting the plant with any of the compositions of the preceding embodiments, wherein the uptake of the heterologous functional agent is increased compared to the uptake of the same heterologous functional agent contacted with the plant in an unencapsulated form. In some embodiments the plant is a corn plant. In some embodiments the composition comprising a plurality of NLPs is contacted with the corn seedlings in a hydroponic system. In some embodiments the heterologous functional agent is detectable in the shoots of the corn within 7 days of contacting the roots in the hydroponic system with the composition comprising the plurality of NLPs.

In one aspect herein is provided a method of reducing the viability of foliar insect pest, the method comprising: applying to soil infested with root worm any of the compositions of the preceding embodiments, wherein the heterologous functional agent contacts the foliar insect pest, thereby reducing the viability of the foliar insect pest. In some embodiments the foliar insect pest is a lepidopteran, coleopteran, hemipteran insect pest. In some embodiments the foliar insect pest is a fall army worm. In some embodiments the NLP composition is applied to soil as a soil drench.

In some embodiments the NLP composition is applied to soil in furrow. In some embodiments the NLP composition is applied to a plant part.

In one aspect herein is provided a method of treating a disease in a plant, the method comprising contacting the plant with any of the compositions of the preceding embodiments, thereby treating the disease in the plant.

In one aspect herein is provided a method of preventing a plant from developing a disease, the method comprising contacting the plant with any of the compositions of the preceding embodiments, thereby preventing disease development.

In one aspect herein is provided a kit comprising an agricultural composition, the composition comprising a plurality of NLPs each comprising: at least one essential oil; at least one phospholipid; at least one surface modifier; and a heterologous functional agent; wherein the NLPs comprise a hydrophobic core.

In one aspect herein is provided a kit comprising an agricultural composition, the composition comprising a plurality of NLPs each comprising: at least non-polar lipid comprising at least one fatty acid a phospholipid or a synthetic lecithin derivative optionally at least one surface modifier; and a heterologous functional agent; wherein the NLPs comprise a hydrophobic core.

In some embodiments, a composition comprises a mixture of two or more distinct NLP populations differing in core polarity (e.g., hydrophilic vs, hydrophobic), cargo type, lipid composition, or particle size. Mixed formulations allow for co-delivery of diverse functional agents, such as a hydrophobic insecticide and a hydrophilic dsRNA, to achieve improved biological effects or layered defense mechanisms. Each NLP type may be independently formulated and blended prior to application, or co-formulated using multi-stream microfluidics. The ratio of NLP types may be optimized based on plant species, tissue target, or delivery route.

### BRIEF DESCRIPTION OF THE DRAWINGS

FIG. 1 depicts NLP particle size (white bars) and the amount of CTPR encapsulated (grey bars) in NLP particles comprising cottonseed oil, or one of the following essential oils: tobacco oil, hemp seed oil or cinnamon oil. The target concentration of CTPR in the NLPs was 2000 μg/ml.

FIG. 2A-2C depict a comparison of the amount of CTPR encapsulated in NLPs comprising either cinnamon oil or sunflower oil. FIG. 2A, log of the concentration of CTPR recovered from NLPs. FIG. 2B log of the concentration of CTPR plotted against the weight percent of cinnamon oil present in the NLP particles: FIG. 2C, log of the concentration of CTPR encapsulated plotted against weight percent of any non-polar lipid or essential oil present in the NLPs presented in Table 4.

FIG. 3A-3B depict the assessment of DCM uptake and distribution in corn shoots by fluorescence detection upon extraction of DCM from leaf tissue (FIG. 3A) or ImageJ analysis of fluorescence images of corn shoots (FIG. 3B). * or ** depicts statistically significant difference compared to the water treatment. *, p<0.01: **, p<0.001.

FIG. 4A-C depicts the translatability of uptake and distribution of NLPs in Arabidopis. Soy and Corn plants. FIG. 4A shows fluorescent (left panels) and light (right panels) micrographs of Arabidopsis (top). Soy (middle), and Corn (bottom) roots treated with NLP580-DCM. Fluorescent signal is detected in all cell layers of Arabidopsis. Soy, and Corn roots, indicating the NLP580 promotes systemic delivery of the DCM dye. FIG. 4B shows fluorescent (left panels) and light (right panels) micrographs of Arabidopsis (top). Soy (middle), and Corn (bottom) roots treated with NLP487-DCM. Fluorescent signal is detected only in the outer cell layer of Arabidopsis. Soy, and Corn roots. FIG. 4C shows fluorescent (left panels) and light (right panels) micrographs of Arabidopsis (top). Soy (middle), and Corn (bottom) roots treated with non-encapsulated Exalite. Fluorescent signal was not detected in any cell layer of Arabidopsis. Soy, and Corn roots.

FIG. 4D-E depicts systemic distribution of NLP647-DCM and NLP655-DCM in corn seedlings. FIG. 4D shows a photograph of 10)-day old corn plants depicting where cross sections were taken for examination by confocal microscopy. FIG. 4E shows confocal images of root (bottom panels) and mesocotyl (top panels) cross sections of 10-day old corn plants treated with Control, non-encapsulated Exalite. NLP647-DCM and NLP655-DCM. Fluorescent signal was detected in both the root and mesocotyl tissue of corn plants treated with NLP647-DCM and NLP655-DCM.

FIG. 5A-C shows graphs of 3 independent replicates of testing mortality of Fall Army Worm fed corn seedlings treated with PE-NLP compositions. Percent mortality for conditions, separated by the top and bottom of the leaves. Error bars shown are 95% confidence interval, and the annotated numbers represent the mean. Means above 80% mortality indicate a successful formulation.

### DETAILED DESCRIPTION

Featured herein is an agricultural composition comprising a plurality of nature-derived lipid particles (NLPs) that each comprise a polar lipid, e.g, a phospholipid component, a non-polar lipid and/or an essential oil component, and optionally a surface modifier. NLPs can optionally include agents (e.g., heterologous functional agents. (e.g., a heterologous agricultural agent (e.g., pesticidal agent, fertilizing agent, herbicidal agent, plant-modifying agent, an insect attractant, plant growth promoting agent, biostimulants, or plant immunity elicitors) or a heterologous therapeutic agent (e.g., an antifungal agent, an anti-oomycete agent, an antibacterial agent, a virucidal agent, an anti-viral agent, an insecticidal agent, a nematicidal agent, an antiparasitic agent, or an insect repellent). In some embodiments, the heterologous functional agent is hydrophobic. In some embodiments, the heterologous functional agent is encapsulated. In some embodiments, the encapsulated heterologous functional agent is a pyrethroid, e.g., deltamethrin. In some embodiments the non-polar oil comprised in the NLPs is an essential oil. In some embodiments, the essential oil increases the encapsulation efficiency of the heterologous functional agent in the NLPs. In some embodiments, the weight percentage of essential oil in the NLP is positively correlated with the encapsulation efficiency of the heterologous functional agent. In some embodiments the essential oil is cinnamon oil. In some embodiments, the heterologous functional agent is chlorantraniliprole (CTPR).

Several embodiments relate to methods and compositions for altering the uptake and biodistribution of a heterologous functional agent in a plant. In some embodiments, a heterologous functional agent that is taken up by a plant or a plant part is encapsulated in an NLP comprising a polar lipid, e.g, a phospholipid component, a non-polar lipid and/or an essential oil component, and optionally a surface modifier. In some embodiments, a heterologous functional agent with low plant uptake is encapsulated in an NLP, thereby increasing plant uptake and biodistribution of the heterologous functional agent in a plant. In some embodiments, the NLPs that promote plant uptake and biodistribution of a heterologous functional agent in a plant comprise a modified lecithin. In some embodiments, the modified lecithin is a lysophosphatidylcholine analog. In some embodiments. NLPs that promote plant uptake and biodistribution of a heterologous functional agent in a plant comprise at least 50% (w/w) of oil (e.g, sunflower oil or a blend of sunflower oil and spearmint oil). In some embodiments. NLPs that promote plant uptake and biodistribution of a heterologous functional agent in a plant do not comprise a surface modifier.

Further featured herein are compositions comprising NLPs comprising different heterologous functional agents (e.g, permethrin and deltamethrin). The NLP compositions and methods described herein can be used in a variety of agricultural applications.

### Definitions

As used herein. “delivering” or “contacting” refers to applying an NLP composition as described herein either directly to a plant, animal (e.g., insect, nematode, etc.), fungus, or bacterium, or adjacent to the plant, animal, fungus, or bacterium, in a region where the composition is effective to alter the fitness of the plant, animal, fungus, or bacterium. In methods where the composition is directly contacted with a plant, animal, fungus, or bacterium, the composition may be contacted with the entire plant, animal, fungus, or bacterium or with only a portion of the plant, animal, fungus, or bacterium. In some embodiments, the NLP composition may be ingested by a plant pest, such as an insect or nematode.

As used herein, the term “effective amount.” “effective concentration.” or “concentration effective to” refers to an amount of a heterologous functional agent provided in a NLP composition as described herein, sufficient to affect the recited result or to reach a target level (e.g., a predetermined or threshold level) in or on a target organism.

As used herein. “increasing the fitness of a plant” refers to an increase in the production of the plant, for example, an improved yield, improved vigor of the plant, or improved quality of the harvested product from the plant as a consequence of administration of a composition described herein (e.g., an NLP composition including a heterologous functional agent as described herein). An improved yield of a plant relates to an increase in the yield of a product (e.g., as measured by plant biomass, grain, seed or fruit yield, protein content, carbohydrate or oil content or leaf area) of the plant by a measurable amount over the yield of the same product of the plant produced under the same conditions, but without the application of the instant compositions or compared with application of conventional agricultural agents. For example, yield can be increased by at least about 0.5%, about 1%, about 2%, about 3%, about 4%, about 5%, about 10%, about 20%, about 30%, about 40%, about 50%, about 60%, about 70%, about 80%, about 90%, about 100%, or more than 100%. Yield can be expressed in terms of an amount by weight or volume of the plant or a product of the plant on some basis. The basis can be expressed in terms of time, growing area, weight of plants produced, or amount of a raw material used. An increase in the fitness of plant can also be measured by other means, such as an increase or improvement of the vigor rating, increase in the stand (the number of plants per unit of area), increase in plant height, increase in stalk circumference, increase in plant canopy, improvement in appearance (such as greener leaf color as measured visually), improvement in root rating, increase in seedling emergence, protein content, increase in leaf size, increase in leaf number, fewer dead basal leaves, increase in tiller strength, decrease in nutrient or fertilizer requirements, increase in seed germination, increase in tiller productivity, increase in flowering, increase in seed or grain maturation or seed maturity, fewer plant verse (lodging), increased shoot growth, or any combination of these factors, by a measurable or noticeable amount over the same factor of the plant produced under the same conditions, but without the administration of the instant compositions or with application of conventional agricultural agents.

As used herein. “decreasing the fitness of a plant” refers to any disruption of the physiology of a plant (e.g., a weed) as a consequence of administration of a composition described herein (e.g., an NLP composition including a heterologous functional agent as described herein), including, but not limited to, decreasing a population of a plant (e.g., a weed) by about 10%, 20%, 30%, 40%, 50%, 60%, 70%, 80%, 90%, 95%, 99%, 100% or more. A decrease in plant fitness can be determined in comparison to a plant to which the composition has not been administered.

As used herein, the term “heterologous” refers to an agent that is exogenous to the plant or plant part that is contacted with the NLP (e.g., originating from a source that is not the plant itself, e.g., the pesticidal agent incorporated in an NLP may be heterologous). In some embodiments, one or more components of the NLP are heterologous.

As used herein, the term “functional agent” refers to an agent (e.g., an agricultural agent (e.g., pesticidal agent, insecticidal, bactericidal agent, nematocidal, fertilizing agent, herbicidal agent, plant-modifying agent, insect attractant, etc.) or a therapeutic agent (e.g., an antifungal agent, an anti-oomycete agent, an antibacterial agent, a virucidal agent, an anti-viral agent, an insecticidal agent, a nematocidal agent, an antiparasitic agent, or an insect repellent)) that is or can be associated with an NLP composition as described herein (e.g., loaded into or onto NLPs (e.g., encapsulated by, embedded in, or conjugated to NLPs)) and is capable of effecting the recited result (e.g., increasing or decreasing the fitness of a plant, plant pest, plant symbiont, animal (e.g., human) pathogen, or animal pathogen vector) in accordance with the present compositions or methods. In some aspects, the functional agent is a polynucleotide. In some aspects, the functional agent is a polypeptide. In some aspects, the functional agent is a small molecule. In some embodiments, the functional agent is a volatile agent and has a high vapor pressure. In some embodiments, the volatile functional agent is a fumigant. In some embodiments the volatile functional agent is a pheromone. In some embodiments, the volatile functional agent is an essential oil. As used herein, the term “agricultural agent” refers to an agent that can act on a plant, a plant pest, or a plant microorganism (e.g, a plant symbiont), such as a pesticidal agent, pest repellent, fertilizing agent, plant-modifying agent, plant growth promoting agent, biostimulants, plant immunity elicitors or plant-microorganism modifying agent.

As used herein, the term “pest” refers to organisms that cause damage to plants or other organisms, are present where they are not wanted, or otherwise are detrimental to humans, for example, by negatively impacting human agricultural methods or products. Pests may include, for example, invertebrates (e.g., insects, nematodes, or mollusks), microorganisms (e.g., phytopathogens, endophytes, obligate parasites, facultative parasites, or facultative saprophytes), such as bacteria, fungi, oomycetes, or viruses: or weeds.

As used herein, the term “pesticidal agent” or “pesticide” refers to an agent, composition, or substance therein, that controls or decreases the fitness (e.g., kills or inhibits the growth, reduces fecundity, proliferation, division, reproduction, or spread) of an agricultural, environmental, or domestic/household pest, such as an insect, mollusk, nematode, fungus, bacterium, weed, or virus. Pesticides are understood to encompass naturally occurring or synthetic insecticides (larvicides or adulticides), insect growth regulators, acaricides (miticides), molluscicides, nematicides, ectoparasiticides, bactericides, fungicides, or herbicides. The term “pesticidal agent” may further encompass other bioactive molecules such as antibiotics, antivirals pesticides, antifungals, antihelminthics, nutrients, and/or agents that stun or slow insect movement.

As used herein, the term “antibacterial agent” refers to any material that kills or inhibits the growth, proliferation, division, reproduction, or spread of bacteria, such as phytopathogenic bacteria, and includes bactericidal (e.g., disinfectant compounds, antiseptic compounds, antibiotics, etc.) and bacteriostatic agents (e.g., growth or reproduction inhibiting compounds or antibiotics). Bactericidal agents kill bacteria, while bacteriostatic agents only slow their growth or reproduction.

As used herein, the term “fungicide” or “antifungal agent” refers to a substance that kills or inhibits the growth, proliferation, division, reproduction, or spread of fungi, such as phytopathogenic fungi or animal pathogenic fungi.

As used herein, the term “viricide” or “antiviral” or “antiviral agent” refers to any substance that deactivates a virus, destroys a virus, or otherwise interferes with or inhibits any stage of the viral life cycle (e.g., prevents infection (e.g., attachments to the host cell), uncoating, integration, transcription, translation, replication, assembly, or release of viruses). In some embodiments, the virus is a viral plant pathogen. A number of agents can be employed as a viricide, including chemicals and biological agents (e.g., biomimetics, nucleic acids (e.g., dsRNA, morpholinos, etc.).

As used herein, the term “insecticide” or “insecticidal agent” refers to a substance that decreases the fitness (e.g., kills, inhibits the growth, inhibits proliferation, inhibits reproduction, inhibits spread, inhibits feeding, reduces fecundity, etc.) of an insect, such as an agricultural insect pest (e.g., corn root worm, stink bug, canola flea beetle. THRIPS, fall army worm, etc.), an insect vector of an animal pathogen, or a parasitic insect.

As used herein, the term “nematicide” or “nematocidal agent” refers to a substance that decreases the fitness (e.g., kills, inhibits growth, inhibits proliferation, inhibits reproduction, inhibits spread, inhibits feeding, etc.) of a nematode, such as an agricultural nematode pest or a parasitic nematode.

As used herein, the term “antiparasitic” or “antiparasitic agent” refers to a substance that kills or inhibits the growth, proliferation, reproduction, or spread of a parasite, such as parasitic protozoa, a parasitic nematode, or a parasitic insect.

As used herein, the term “molluscicide” or “molluscicidal agent” refers to a substance that decreases the fitness (e.g., kills, inhibits the growth, inhibits proliferation, inhibits reproduction, inhibits spread, inhibits feeding, etc.) of a mollusk, such as agricultural mollusk pests.

As used herein, the term “plant-modifying agent” refers to a substance that alters a phenotype of a plant provided with the plant-modifying agent compared to a plant not receiving the plant-modifying agent.

As used herein, the term “herbicide” or “herbicidal agent” refers to a substance that decreases the fitness (e.g., kills, inhibits the growth, inhibits proliferation, inhibits reproduction, inhibits spread, etc.) of a plant.

As used herein, the term “repellent” refers to any substance that acts to repel or discourage entry of a pest (e.g., insects, nematodes, mollusks, endophytes, fungi, weeds, etc.). In some instances, the repellent is an insect repellent.

As used herein, the term “plant-modifying agent” refers to an agent that can alter the genetic properties (e.g., increase gene expression, decrease gene expression, or otherwise alter the nucleotide sequence of DNA or RNA), epigenetic properties, or biochemical properties of a plant in a manner that results in a change (e.g., increase or decrease) in plant fitness.

As used herein, the term “fertilizing agent” refers to a substance that can increase the fitness of a plant or plant microorganism (e.g, a plant symbiont). A fertilizing agent includes any material of natural or synthetic origin that is applied to soils or to plant tissues to increase the fitness of plants and plant microorganisms. A heterologous fertilizing agent may stimulate soil microbial population growth and activities. Increased soil microbial population (e.g., plant symbionts) may have significant beneficial effects on the physical and chemical properties of the soil, as well as increasing disease and pest resistance.

As used herein, an “agriculturally acceptable” carrier is one that is suitable for use in agriculture, e.g., for use on plants. In certain embodiments, the agriculturally acceptable carrier does not have undue adverse side effects to the plants, the environment, or to humans or animals who consume the resulting agricultural products derived therefrom commensurate with a reasonable benefit/risk ratio.

As used herein, the term “formulated for delivery to a plant” refers to an NLP composition that includes an agriculturally acceptable carrier. As used herein, an “agriculturally acceptable” carrier is one that is suitable for use in agriculture without undue adverse side effects to the plants, the environment, or to humans or animals who consume the resulting agricultural products derived therefrom commensurate with a reasonable benefit/risk ratio. Non-limiting examples of agriculturally acceptable carriers or excipients are known in the art; sec, e.g., the Compendium of Herbicide Adjuvants.

As used herein, the term “peptide.” “protein.” or “polypeptide” encompasses any chain of naturally or non-naturally occurring amino acids (either D- or L-amino acids), regardless of length (e.g., at least 2, 3, 4, 5, 6, 7, 10, 12, 14, 16, 18, 20, 25, 30, 40, 50, 100, or more amino acids), the presence or absence of post-translational modifications (e.g., glycosylation or phosphorylation), or the presence of, e.g., one or more non-amino acyl groups (for example, sugar, lipid, etc.) covalently linked to the peptide, and includes, for example, natural proteins, synthetic, or recombinant polypeptides and peptides, hybrid molecules, peptoids, or peptidomimetics.

As used herein, the term “plant” refers to whole plants, plant parts, plant organs, plant tissues, seeds, plant cells, seeds, and progeny of the same. Plant cells include, without limitation, cells from seeds, suspension cultures, embryos, meristematic (e.g, meristem) regions, callus tissue, leaves, roots, shoots, gametophytes, sporophytes, pollen, and microspores. Plant parts include differentiated and undifferentiated tissues including, but not limited to the following: roots, stems, shoots, leaves, pollen, seeds, fruit, harvested produce, tumor tissue, sap (e.g., xylem sap and phloem sap), and various forms of cells and culture (e.g., single cells, protoplasts, embryos, and callus tissue).

As used herein the term “soil mobility” refers to the potential of an agent, e.g, an NLP, a heterologous functional agent, or an NLP comprising a heterologous functional agent, to move in soil from the site of application to a location in the soil at a distance (e.g., 1 mm. 5 mm. 1 cm, 5 cm, 10 cm. 15 cm, 20 cm, 25 cm, 30 cm, 35 cm, 40 cm, 45 cm, 50 cm, 55 cm, 60 cm, 65 cm, 70 cm, 75 cm, 80 cm, 85 cm, 90 cm, 95 cm, 1 meter. 1.5 meters. 2 meters. 2.5 meters. 3 meters. 3.5 meters. 4 meters. 4.5 meters. 5 meters, etc.) from the site of application. If a component is mobile in soil, it means that the component generally moves freely through soil to at least reach a position distant from the site of application. The site distant from the site of application can be, e.g, anywhere from about. 1 mm. 1 cm, 10 cm, 50 cm, 1 meter or 5 meter from the site of application.

As used herein, the term “cellular uptake” refers to uptake of a NLP or a portion or component thereof (e.g., a heterologous functional agent carried by the NLP) by a cell, such as an animal cell, a plant cell, bacterial cell, or fungal cell. For example, uptake can involve transfer of the NLP or a portion of component thereof from the extracellular environment into or across the cell membrane, the cell wall, the extracellular matrix, or into the intracellular environment of the cell). Cellular uptake of NLPs may occur via active or passive cellular mechanisms. Cellular uptake includes aspects in which the entire NLP is taken up by a cell, e.g., taken up by endocytosis. In embodiments, one or more heterologous functional agents (e.g., polynucleotides, polypeptides, small molecule chemistries, etc.) are exposed to the cytoplasm of the target cell following endocytosis and endosomal escape. In some embodiments, an NLP (e.g., an NLP comprising a charged surface modifier (e.g., a polycarboxylate) has an increased rate of endosomal escape relative to an unmodified NLP. Cellular uptake also includes aspects in which the NLP fuses with the membrane of the target cell. In some embodiments, one or more heterologous functional agents (e.g., polynucleotides, polypeptides, small molecule chemistries, etc.) are exposed to the cytoplasm of the target cell following membrane fusion. In some embodiments, an NLP comprising a surface modifier (e.g., a hydrophobically modified polycarboxylate or an alkyl polysaccharide) has an increased rate of fusion with the membrane of the target cell (e.g., is more fusogenic) relative to an NLP not comprising a surface modifier.

As used herein, the term “NLPs” refers to a composition including a plurality of nature-derived lipid particles, wherein the NLPs comprise at least one polar lipid, e.g, a phospholipid (e.g, phosphatidyl choline), at least one non-polar lipid (e.g, sunflower oil) and/or at least one essential oil component (e.g, cinnamon oil), or a blend of those oils, and optionally at least one surface modifier (e.g., a modified styrene acrylic polymer). In some embodiments. NLPs further comprise a heterologous functional agent, e.g., a pesticidal agent, fertilizing agent, plant-modifying agent, small molecules, etc. In some embodiments, the NLP encapsulates the heterologous functional agent. NLPs are a lipid structure (e.g., a micellar structure, lipid bilayer, unilamellar, multilamellar structure: e.g., a vesicular lipid structure), that is about 5-2000 nm (e.g., at least 5-1000 nm, at least 5-500 nm, at least 400-500 nm, at least 25-250 nm, at least 50-150 nm, or at least 70-120 nm) in diameter including at least one phospholipid (e.g., phosphatidic acid. PA), at least one non-polar lipid (e.g., a triglyceride) and/or at least one essential oil (e.g, cinnamon oil), and at least one surface modifier (e.g., a modified styrene acrylic polymer). In some embodiments. NLPs are produced by applying energy to a mixture of phospholipids, non-polar lipids and/or essential oils and optionally a surface modifier component provided in organic and aqueous phases. In some embodiments, the surface modifier component may be added after the NLP is formed. Nonlimiting examples of a means of applying energy include one or more of sonication, vortexing, mixing, or heating a mixture of organic solutions and aqueous solutions to form the NLPs. In some embodiments, the NLPs may further be subjected to sonication, freeze/thaw treatment, and/or lipid extrusion, e.g., to reduce the size of the NLPs. In some embodiments, the NLPs have a hydrophobic core.

As described herein, the term “hydrophobic core” refers to the most inner part of an NLP that is hydrophobic in nature. In some embodiments, the hydrophobic core comprises one or more non-polar, non-liposome forming lipids (e.g., triglycerides in sunflower oil) and/or an essential oil (e.g, cinnamon oil). In some embodiments, the NLPs comprise an essential oil an essential oil. In some embodiments, a hydrophobic agent (e.g., permethrin) is dissolved in the hydrophobic core. In some embodiments, the NLP comprises in its membrane compartment or in its hydrophobic core a fluorescent dye. In some embodiments, the hydrophobic dye comprised in the hydrophobic core is 4-(Dicyanomethylene)-2-methy 1-6-(+-dimethylaminostyryl)-4H-pyran (DCM)). Several embodiments relate to an NLP having a hydrophobic core encapsulated by an outer phospholipid-comprising monolayer, wherein the fatty acid chains of the phospholipids face inwards and are in contact with the hydrophobic core. In some embodiments, the fatty acid chains are part of the hydrophobic corc.

As used herein, the term “polar lipid” refers to a lipid comprising a hydrophilic head and a hydrophobic tail, e.g, a phospholipid. As used herein, the term “phospholipid” refers to a lipid that has a glycerol or sphingosine backbone to which two fatty acid chains and a phosphate-containing head group are attached. In some embodiments, a polar lipid is a lecithin, comprising a mixture of phospholipids. In some embodiments, the phospholipid is chemically synthesized or modified, e.g, ly sophosphatidylcholine.

As used herein the term “non-polar lipid” refers to a compound comprising at least one fatty acid chain. In some embodiments a non-polar lipid is a fatty acid. In some embodiments the non-polar lipid is a triglyceride. Triglycerides are esters comprised of three fatty acid units linked to glycerol. Fatty acids may be unsaturated or saturated, depending on the presence or absence of double bonds in the hydrocarbon chain. If only single bonds are present, they are known as saturated fatty acids. A triglyceride is called a fat if it is a solid at 25° C.: it is called an oil if it is a liquid at that temperature. Exemplary non-polar lipids, that are liquid at room temperature include sunflower oil and soy bean oil.

As used herein, the term “essential oil” refers to an oil isolated from a plant or plant part, comprising one or more of a phenolic, alcoholic and terpenoid compound. Most essential oils are volatile, e.g, spearmint oil, and most essential oils do not comprise fatty acids, unlike e.g, sunflower oil. Exemplary essential oils are hemp oil, cinnamon oil, and tobacco oil.

As used herein, the term “surface modifier” refers to a compound that is capable modifying one or more characteristics of the NLP. In some embodiments, an NLP as described herein may comprise one or more surface modifiers affecting the surface characteristics of the NLP (e.g., the zeta potential of the NLP). In some embodiments, the surface modifier affects the mobility of the NLP (or of a heterologous functional agent comprised in the NLP) in soil. In some embodiments, the surface modifier increases the binding of an NLP to a plant or a plant part as compared to an NLP not comprising the surface modifier. In some embodiments, the surface modifier increases the biodistribution of a heterologous functional agent comprised in the NLP upon contacting of a plant or plant part with the NLP as compared to the biodistribution of a heterologous agent comprised in an NLP not comprising the surface modifier. In some embodiments, the surface modifier confers charge to a NLP, e.g., renders a NLP more negatively charged or more positively charged. In some embodiments, the surface modifier is an amphiphilic molecule. In some embodiments, the surface modifier is a zwitterionic agent. In some embodiments the surface modifier is a cationic agent, e.g., a cationic lipid. In some embodiments, the surface modifier is an anionic polymer, e.g., a polycarboxylate. In some embodiments, the surface modifier is a lipoid compound with glycosylated moieties attached, e.g., a rhamnolipid, a sophorolipid, etc. In some embodiments, the surface modifier comprises a group (e.g., a head group) that is charged (e.g., is cationic or anionic) or that can be ionized under a given condition (e.g., pH) to produce one or more electrically charged species. Nonlimiting examples of surface modifiers are JEFFSPERSER X3202. Atlox™ 500L. Atlox™ 550S. Atlox™ AL2575. Atlox™ CS100B. NINEXR MT-615. STEPFLOW R 1500. STEPFLOW R 4000. BIO-SOFTR N91-8. BIO-SOFR N-411. Sugarbeet pectin. CRODESTA™ F160. Rhamnolipid. Sophoro lipid, STEPFACT TSP-PE K, and AMMONYX R CETAC-30.

As used herein, the term “stable NLP composition” (e.g., a composition including loaded or non-loaded NLPs) refers to an NLP composition that over a period of time (e.g., at least 24 hours, at least 48 hours, at least 1 week, at least 2 weeks, at least 3 weeks, at least 4 weeks, at least 30 days, at least 60 days, or at least 90 days) retains at least 5% (e.g., at least 5%, 10%, 15%, 20%, 25%, 30%, 35%, 40%, 45%, 50%, 55%, 60%, 65%, 70%, 75%, 80%, 85%, 90%, 95%, or 100%) of the initial number of NLPs (e.g., NLPs per mL of solution) relative to the number of NLPs in the NLP starting material (e.g., at the time of production or formulation) optionally at a defined temperature range (e.g., a temperature of at least 24° C. (e.g., at least 24° C. 25° C. 26° C. 27° C. 28° C. 29° C., or 30° C.), at least 20° C. (e.g., at least 20° C. 21° C. 22° C., or 23° C.), at least 4° C. (e.g., at least 5° C. 10° C., or 15° C.), at least −20° C. (e.g., at least −20° C. −15° C..−10° C. −5° C., or 0° C.), or −80° C. (e.g., at least −80° C. −70° C..−60° C. −50° C. −40° C., or −30° C.)); or retains at least 5% (e.g., at least 5%, 10%, 15%, 20%, 25%, 30%, 35%, 40%, 45%, 50%, 55%, 60%, 65%, 70%, 75%, 80%, 85%, 90%, 95%, or 100%) of its activity (e.g., cell wall penetrating activity and/or pesticidal and/or repellent activity) relative to the initial activity of the NLP (e.g., at the time of production or formulation) optionally at a defined temperature range (e.g., a temperature of at least 24° C. (e.g., at least 24° C. 25° C. 26° C. 27° C. 28° C. 29° C., or 30° C.), at least 20° C. (e.g., at least 20° C. 21° C. 22° C., or 23° C.), at least 4° C. (e.g., at least 5° C. 10° C., or 15° C.), at least −20° C. (e.g., at least −20° C..−15° C. −10° C. −5° C., or 0° C.), or −80° C. (e.g., at least-80° C..−70° C. −60° C..−50° C. −40° C., or −30° C.)).

As used herein, the term “untreated” refers to a plant, animal, fungus, or bacterium that has not been contacted with or delivered a NLP composition as described herein, including a separate plant, animal, fungus, or bacterium that has not been delivered the NLP composition, the same plant, fungus, or bacterium undergoing treatment assessed at a time point prior to delivery of the NLP composition, or the same plant, fungus, or bacterium undergoing treatment assessed at an untreated part of the plant, animal, fungus, or bacterium.

As used herein, the term “polydispersity index” (PDI) is a unitless value derived from dynamic light scattering (DLS) measurements and is calculated based on the width of the particle size distribution. The PDI score of an NLP formulation reflects the uniformity of particle size distribution in the formulation. A lower PDI indicates a more monodisperse (uniform) population of particles, whereas a higher PDI reflects greater size heterogeneity.

As used herein. “Systemic distribution” refers to the movement of a functional agent, typically after initial uptake, through internal plant tissues including vascular pathways, such that the agent reaches tissues remote from the site of application.

### I. NLP Composition

Several embodiments relate to an NLP composition wherein the composition comprises at least one polar lipid (e.g, a phospholipid), at least one non-polar lipid (e.g, soybean oil), and or at least one essential oil (e.g, cinnamon oil), and optionally at least one surface modifier (e.g, a modified styrene acrylic polymer), and wherein the NLP has a hydrophobic core. In some embodiments, the NLP composition further comprises a co-solvent. In some embodiments, the NLP composition further comprises one or more excipients. In some embodiments, the NLP composition further comprises one or more heterologous functional agents. In some embodiments, the heterologous functional agent is a hydrophobic agent. In some embodiments, the hydrophobic heterologous functional agent is a pesticide (e.g, permethrin). In some embodiments the NLP composition further comprises a dye (e.g. DCM). In some embodiments, the NLP composition comprises a lipid layer isolated from a natural source (e.g., naturally occurring phospholipids), semi-synthetic or fully synthetic lipid.

### A. Phospholipids (PL)

Several embodiments relate to an NLP composition comprising at least one phospholipid. In some embodiments, the phospholipids in the NLP form one or more phospholipid layers (e.g., a phospholipid monolayer, a phospholipid bilayer, etc.). In some embodiments, the phospholipids form a micellar structure with a hydrophilic core surrounded by a phospholipid bilayer. In some embodiments, the NLP comprises several layers of phospholipid layers akin to the layers of an onion. In some embodiments, the NLPs are sealed structure in the micron and submicron range dispersed in an aqueous solution. In some embodiments. NLPs comprise one or more bilayers (lamellae) separating the external aqueous solution from the internal phase, or the “core”. In some embodiments, the core is hydrophobic. In other embodiments, the core is hydrophilic. In some embodiments, the one or more phospholipid layers (e.g., a monolayer, a bilayer, etc.) comprises one or more amphipathic agents. Amphipathic agents comprise both polar and apolar regions. When amphipathic agents are present in an aqueous phase, they self-aggregate such that their hydrophilic moiety faces the aqueous phase, while their hydrophobic domain is “protected” from the aqueous phase. In some embodiments, an NLP may comprise a phospholipid bilayer wherein the hydrophobic domains face each other. In some embodiments, an NLP may comprise a phospholipid monolayer, wherein the hydrophobic domains face the hydrophobic core of the NLP. In some embodiments. NLPs are formed by organizing amphipathic agents, e.g., phospholipids, in a lamellar phase wherein the lamellae form closed structures and organize into vesicles.

Several embodiments relate to an NLP composition used as a carrier to facilitate movement of a heterologous functional agent through soil. In some embodiments, an NLP composition comprising two or more types of liposomes are used to facilitate movement of a heterologous functional agent through soil. In some embodiments, the liposomes can be any one or combination of vesicles selected from the group consisting of small unilamellar vesicles (SUV), large unilamellar vesicles (LUV), multilamellar vesicles (MLV), multivesicular vesicles (MVV), large multivesicular vesicles ((LMVV), also referred to, at times, by the term giant multivesicular vesicles. (“GMV”)), oligolamellar vesicles (OLV), and others.

Several embodiments relate to NLP compositions comprising at least one phospholipid, at least one of which is a liposome forming phospholipid. Without being limited by theory, the amount of phospholipids in the NLP can be determined as organic phosphorous by the modified Bartlett method (Shmeeda H. Even-Chen S. Honen R. Cohen R. Weintraub C. Barenholz Y. 2003. Enzymatic assays for quality control and pharmacokinetics of liposome formulations: comparison with nonenzymatic conventional methodologies. Methods Enzymol 367:272-92).

In some embodiments, the NLP compositions comprise at least one phospholipid selected from glycerophospholipids and sphingomyelins. The glycerophospholipids have a glycerol backbone wherein at least one, preferably two, of the hydroxyl groups at the head group is substituted by one or two hydrocarbon tails (chains), typically, an acyl, alkyl or alkenyl tails, and the third hydroxyl group is substituted by a phosphate (phosphatidic acid) or a phospho-ester such as phosphocholine group (as exemplified in phosphatidylcholine), being the polar head group of the glycerophospholipid or combination of any of the above, and/or derivatives of same and may contain a chemically reactive group (such as an amine, acid, ester, aldehyde or alcohol). Examples of glycerophospholipids include, but are not limited thereto, phosphatidylglycerols (PG) including dimyristoyl phosphatidylglycerol (DMPG): phosphatidylcholine (PC), including egg yolk phosphatidylcholine, soy bean PC, sunflower PC, rapeseed PC, krill PC, canola PC, flax seed lecithin, wheat lecithin, dimyristoyl phosphatidylcholine (DMPC. Tm 24° C.). 1-palmitoy 1-2-oleoy lphosphatidyl choline (POPC), hydrogenated soy phosphatidylcholine (HSPC. Tm 65° C.), distearoylphosphatidylcholine (DSPC. Tm 55° C.): di-lauroyl-sn-glycero-2phosphocholine (DLPC): 1.2-dipalmitoyl-sn-glycero-3-phosphocholine (DPPC. Tm 41° C.): 1.2-dinonadecanoyl-sn-glycero-3-phosphocholine: 1.2-diarachidoyl-sn-glycero-3-phosphocholine (DBPC): 1.2-dihenarachidoyl-sn-glycero-3-phosphocholine: 1.2-dibehenoyl-sn-glycero-3-phosphocholine 1.2-ditricosanoyl-sn-glycero-3-phosphocholine 1.2-dilignoceroy l-sn-glycero-3-phosphocholine: 1-myristoy 1-2-stearoyl-sn-glycero-3-phosphocholine: 1-palmitoyl-2-stearoyl-sn-glycero-3-phosphocholine (PSPC): 1-stearoy 1-2-palmitoyl-sn-glycero-3-phosphocholine (SPPC): 1.2-di-oleoyl-sn-glycero-3-phosphocholine (DOPC−1.7° C.); phosphatidic acid (PA), phosphatidylinositol (PI), phosphatidylserine (PS), phosphatidylethanolamine (PE). The sphingomyelins consist of a ceramide (N-acyl sphingosine) unit having a phosphocholine moiety attached to position 1 as the polar head group. The term “sphingomyelin” or “SPM” as used herein denotes any N-acetyl sphingosine conjugated to a phosphocholine group, the later forming the polar head group of the sphingomyelin (N-acyl sphingosyl phospholcholines). The acyl chain bound to the primary amino group of the sphingosine (to form the ceramide) may be saturated or unsaturated, branched or unbranched.

In some embodiments, an NLP composition comprises a phospholipid having one or two C14 to C24 hydrocarbon tails (e.g., acyl, alkyl or alkenyl chain) with varying degrees of saturation, from being fully saturated to being fully, partially or non-hydrogenated lipids. In some embodiments, natural phospholipids may be further converted to saturated phospholipids by means of hydrogenation or further treated with enzymes to, e.g., remove partially fatty acids (e.g, using phospholipase A2) or to convert a polar head group (e.g, using phospholipase D). The saturated phospholipids are considered as natural phospholipids because the resulting saturated lipids are also occurring in nature (e.g., natural identical).

In some embodiments, the NLP composition comprises at least one phospholipid comprising a polar head group. In some embodiments, the polar head group comprises an alcohol moiety. In some embodiments, the polar head group is one comprising a serine moiety. In some embodiments, the polar head group is one comprising a choline moiety. In some embodiments, the polar head group is one comprising ethanolamine. In some embodiments, the polar head group is one comprising glycerol.

In some embodiments, an NLP composition comprises at least one phospholipid comprising a polar inositol head group. In some embodiments, the phospholipid comprising an inositol head group is selected from the group consisting of phospatidy linositol (PI). PI (4) P. PI (3) P. PI (3.4.5) P3. PI (4.5) P2. PI (3.5) P2, and PI (3.4) P2. In some embodiments, at least one phospholipid has an acidic head group. In some embodiments, the acidic head group comprises a moiety selected from the group consisting of glycerol, hydroxyl, carboxyl, amine, and phosphoric group.

In some embodiments, an NLP composition comprises at least one acidic phospholipids include natural or synthetic lipid selected from phosphatidylglycerols (PGs) such as dilauroy lphosphatidylglycerol (DLPG), dimyristoy lphosphatidylglycerol (DMPG), dipalmitoylphosphatidylglycerol (DPPG), distearoy lphosphatidylglycerol (DSPG), dioleoylphosphatidylglycerol (DOPG), egg yolk phosphatidylglycerol (egg yolk PG), hydrogenated egg yolk phosphatidylglycerol: phosphatidylinositols (PIs) such as phosphatidylinositol, dimyristoy lphosphatidylinositol, dipalmitoylphosphatidylinositol (DPPI), distearoy lphosphatidylinositol (DSPI), dioleoy lphosphatidylinositol (DOPI), soy bean phosphatidylinositol (soy bean PI), hydrogenated soybean phosphatidylinositol, phosphoinositides, sphingomyelin and phosphatidic acid. Each of these acidic phospholipids can be used alone or in combination of two or more in the NLPs of the presented disclosure.

In some embodiments, the at least one phospholipid in the NLPs is derived from lecithin. Lecithin is described in the United States Pharmacopoeia (USP) as a complex mixture of acetone-insoluble phosphatides, which consists chiefly of PC. PE, phosphatidylserine, and phosphatidylinositol, combined with various amounts of other substances such as triglycerides, fatty acids, and carbohydrates, as separated from the crude vegetable oil source. In some embodiments, the lecithin is a modified lecithin. Modified lecithins are specially formulated to be highly dispersible in water, excellent emulsifiers in water or to have resistance to heat when exposed to high temperatures. In some embodiments, the modified lecithin is a synthetic lecithin. In some embodiments, the modified lecithin is a lysophosphatidylcholine (e.g, lysolecithin) or a synthetic analogue thereof. In some embodiments, the modified lecithin is Emulfluid™

In some embodiments, an NLP composition comprises one or more phospholipids. In some embodiments, about 5% −50% (w/w) of the lipids in an NLP composition is phospholipid (e.g., about 10%-20% of the lipids in an NLP composition is phospholipid, e.g., about 10%. 12.5%, 16%, or 20% of the lipids in an NLP composition is phospholipid). In some embodiments, about 30%-75% (e.g., about 35% or about 50% phospholipid) of the lipids in an NLP composition is phospholipid. In some embodiments, about 35%-50% (e.g., about 36%. 36.5%. 37%. 37.5%. 38%. 38.5%, 39%. 39.5%, 40%, 40.5%. 41%. 41.5%. 42%, 42.5%, 43%, 43.5%, 44%, 44.5%, 45%. 45.5%, 46%. 46.5%. 47%. 47.5%. 48%. 48.5%. 49%, 49.5%) of the lipids in an NLP composition is phospholipid.

In some embodiments, the phospholipids are selected from the group consisting of Crude lemon lipids, purified lemon phospholipids, phosphatidy lethanolamine (PE). LIPOID H PS 70 (Phosphatidylserine). 14C-PA (Phosphatidic acid). LIPOID H90 (Phosphatidylcholine). Sunflower lecithin. Soybean lecithin, and De-oiled soybean lecithin.

### B. Non-Polar Lipids (NP)

Several embodiments relate to an NLP composition comprising at least one non-polar lipid. A non-polar lipid is understood to be non-amphipathic and non-liposome forming. A non-liposome forming lipid refers to a lipid that does not spontaneously form into a vesicle when brought into an aqueous medium. In some embodiments, the non-polar lipids are derived from natural sources. In some embodiments, the non-polar lipids are derived from plant sources. In some embodiments, an NLP composition comprises one or more natural/plant derived non-polar lipids obtained from vegetable sources like, e.g., seed oil (from soy beans, rape (canola), wheat germ, sunflower, flax, cotton, corn, coconut, arachis, sesame), pulp oil (palm, olive, avocado pulp), desert shrub, tobacco, bean, and carrot. In some embodiments, the non-polar lipids comprise triglycerides that typically each comprise at least one fatty acid selected from the group consisting of C6:0. C8:0, C10:0. C12:0. C14:0. C15:0. C16:0. C17:0. C18:0. C20:0. C22:0, and C24:0, saturated fatty acids are selected from C16:1 (n-7). C16:1 (n-9). C17:1 (n-7). C18:1 (n-7). C20:1 (n-7). C20:1 (n-9). C22: (n-9) and C24:1 (n-9), and mono-unsaturated fatty acids C18:2 (n-6). C18:3 (n-3). C18:3 (n-6). C18:4 (n-3). C20:2 (n-6). C20:3 (n-6). C20:4 (n-6). C20:5 (n-3). C22:2 (n-6), and C22:4 (n-6). The types of fatty acid profiles of 80 vegetable oils are described by Dubois et al., Eur. J. Lipid Sci. Technol. 109 (2007) 710-732, which is incorporated herein by reference.

In some embodiments, an NLP composition comprises a non-polar lipid comprising 40% of at least one fatty acid chain selected from the group consisting of a poly-unsaturated fatty acid; a mono-unsaturated fatty acid, and a saturated fatty acid. In some embodiments, an NLP composition comprises at least 1%. 5%, 10%, 15%, 20%, 25%, 30%, 35%, 40%, 45%, 50%, 55%, 60%, or more than 60% (w/w) oil (e.g., soy bean oil), e.g., 1%-10%, 10%-20%, 20%-30%, 30%-40%, 40%-50%, or 50%-60% (w/w) soy bean oil. In some embodiments, an NLP composition comprises a molar ratio of about 35%-50% oil (e.g., soy bean oil), e.g., about 36%. 38.5%. 42.5%, or 46.5% oil. In some embodiments, an NLP composition comprises about 20%-60% oil.

In some embodiments, an NLP composition comprises one or more lipids that do not spontaneously vesiculate yet can be incorporated into vesicles. Nonlimiting examples of non-vesiculating lipids include, sterols, sphingolipids (e.g., sphingomyelin), lipoproteins. In some embodiments, the NLP composition comprises one or more sterols selected from the group consisting of β-sitosterol. B-sitostanol, stigmasterol, stigmastanol, campesterol, campestanol, ergosterol, avenasterol, brassicasterol, fucosterol, cholesterol (CHOL), cholesteryl hemisuccinate, and cholesteryl sulfate any combination of two or more of these sterols. In some embodiments, the sterol is a plant derived sterol (e.g., phytosterol). In the NLP composition comprises one or more phytosterols selected from the group consisting of β-sitosterol. B-sitostanol, stigmasterol, stigmastanol, campesterol, campestanol, ergosterol, avenasterol, brassicasterol and any combination of two or more of these sterols. In some embodiments, the NLP composition comprises one or more phytosterols selected from the group consisting of β-sitosterol, stigmasterol, and ergosterol.

In some embodiments, an NLP composition comprises one or more lipid membranes comprising a mole ratio between phospholipids and non-polar lipids between 10%: 90% to 90%: 10%, at times, a mole ratio of between 20%: 80% to 80%: 20%, at times, a mole ratio between 30%: 70% to 70%: 30%, at times, a mole ratio between 20%: 80% to 50%: 50%, at times, a mole ratio of between 20:80 to 40%: 60%. In some embodiments the non-polar lipids are selected from the group consisting of sunflower oil, canola oil, soy bean oil, olive oil, coconut oil, and purified lemon lipids.

### C. Essential Oils (EO)

In some embodiments NLPs comprise an essential oil. Essential oils do not typically comprise fatty acids. Non-limiting examples of essential oils are cinnamon, cedar, castor, clove, geranium, lemongrass, mint, thyme, turmeric, wintergreen, rosemary, anise, cardamom, chamomile, coriander, cumin, dill, mint, parsley, lavender, basil, camphor, citronella, eucalyptus, fennel, ginger, grapefruit, lemon, mandarin, orange, pine needle, pepper, rose, sweet orange, tangerine, tea tree, tea seed, caraway, garlic, peppermint, onion, and spearmint oil.

In some embodiments, the essential oils are volatile oils. In some embodiments, essential oil is included in an NLP composition to improve the efficiency of encapsulation of a cargo (e.g., a heterologous functional agent) compared to an NLP not comprising one or more essential oils. In some embodiments, an NLP composition comprising one or more essential oils have a cargo encapsulation efficiency that is at least 5%, 10%, 15%, 20%, 30%, 40%, 50%, 60%, 70%, 80%, 90%, 95%, 98%, 99%, or more than 99% higher than the cargo encapsulation efficiency of an NLP composition not comprising the one or more essential oils. In some embodiments the cargo is a heterologous functional agent. In some embodiments the cargo is a hydrophobic agent. In some embodiments, the cargo is chlorantraniliprole (CTPR). Not wishing to be bound to a particular theory, inclusion of one or more essential oils increases the solubility of a cargo (e.g., a heterologous functional agent (e.g., of CTPR).

In some embodiments the NLPs described herein comprises any mixture or blend of non-polar lipids described herein, in any weight ratio described herein. For example, an NLP may comprise a blend of sunflower oil and soy bean oil. In some embodiments. NLPs comprise a mixture of a non-polar lipid, e.g sunflower oil, and an essential oil, e.g, spearmint oil or thyme oil. In some embodiments, the essential oil comprises 5%, 10%, 15%, 20%, 30%, 40%, 50%, 60%, 70%, 80%, 90%, 95%, 98%, 99%, or more than 99% of the total of non-polar lipids and essential oils combined.

### D. Surface Modifiers (SM)

Several embodiments relate to an NLP composition comprising at least one surface modifier. In some embodiments, the surface modifier stabilizes an NLP composition. In some embodiments, the surface modifier is an emulsifier. An NLP composition as described herein may comprise (e.g., be loaded with, encapsulate, be conjugated to) or be formulated with (e.g., be suspended or resuspended in a solution comprising) one or more surface modifiers. In some embodiments, the surface modifier affects the binding of any of the constituents of the NLP composition to any components present in soil. In some embodiments, one or more surface modifiers are integrated into one or more of the phospholipid layers of the NLP. In some embodiments, an NLP composition comprises at least one surface modifier selected from Table 1. In some embodiments, an NLP composition comprises at least two, three, four, five or more surface modifiers selected from Table 1.

In some embodiments, an NLP composition comprises at least 1%. 5%, 10%, 20%, 30%, 40%, 50%, 60%, 70%, 80%, 90%, or more than 90% of one or more surface modifiers. In some embodiments, an NLP composition comprises a weight/weight ratio of at least 0.1%. 1%, 5%, 10%, 15%, 20%, 25%, 30%, 35%, 40%, 45%, 50%, 55%, 60%, 65%, 70%, 75% 80%, 85%, 90%, or more than 90% of a synthetic chemical surface modifier (e.g., a pegylated compound, a polycarboxylate, etc.). In some embodiments, an NLP composition comprises a weight/weight ratio of at least 1%-10%, 10%-20%, 20%-30%, 30%-40%, 40%-50%, 50%-60%, 60%-70%, 70%-80%, or 80%-90% of one or more surface modifiers (e.g., a polycarboxylate). In some embodiments, an NLP composition comprises a weight/weight ratio of at least about 30%-75% of a polycarboxylate surface modifier. In some embodiments, the NLPs contain up to 5 mole % surface modifier. In some embodiments, an NLP composition comprises between about 0.1 mole % to 5 mole %, between about 0.5 mole % to 4 mole %, between about 1 mole % to 3 mole % of one or more surface modifiers. In some embodiments, an NLP composition comprises 25% Atlox™ 500L. In some embodiments, an NLP composition comprises a molar ratio of 35% Atlox™ 500L. In some embodiments, an NLP composition comprises a molar ratio of 50% Atlox™ 500L.

Several embodiments relate to an NLP composition comprising one or more surface modifiers. In some embodiments, the surface modifier is a synthetic compound that affects plant uptake, wherein the NLP composition optionally comprises a heterologous functional agent (e.g, a pyrethroid). In some embodiments, the surface modifier alters one or more surface characteristics of an NLP composition. In some embodiments, a surface modifier structurally alters the NLP, e.g., by adding a chemical group to the exterior surface of the NLP. In some embodiments, an NLP composition comprises a glycolipid moiety exposed at the external surface of the NLP composition. In some embodiments, an NLP composition comprises at least one glycoprotein embedded in the outer surface of the NLP composition. In some embodiments, at least a portion of the surface modifier is integrated into a lipid membrane of the NLP, e.g., a lipoid domain that is embedded into the phospholipid membrane. In some embodiments, at least a portion of the surface modifier is exposed to the outside of the NLP, facing e.g., the air, the soil, or a solution in which the NLPs are dispersed. In some embodiments, the surface modifier is an emulsifier. In some embodiments, the surface modifier is amphipathic in nature, e.g., comprises a hydrophobic part and a hydrophilic part chemically connected in one molecule. In some embodiments, the surface modifier is a surfactant. In some embodiments, the surface modifier affects the surface charge of an NLP, e.g., by making the surface charge of an NLP more or less negative in charge. In some embodiments, the surface charge of an NLP is expressed as the zeta potential of the NLP.

In some embodiments, the surface charge of the NLP affects the affinity of the NLP for charged matrix. In some embodiments, the charged matrix is soil. In some embodiments, the surface charge affects the affinity of the NLP for one or more components present in soil (e.g, sillicates, clay, biological components, etc.). In some embodiments, the surface charge of the NLP affects the biodistribution of NLPs in a plant. In some embodiments, an NLP composition comprises at least two, three, four, five or more surface modifiers selected from Table 1.

Several embodiments relate to an NLP composition comprising one or more surface modifiers that increase uptake of the NLP composition by a plant or plant part (e.g., root, leaf, plant cell, etc.). In some embodiments, the one or more surface modifiers increase the uptake of the NLP composition as a whole. In some embodiments, the one or more surface modifiers increase the uptake of a portion or component of the NLP composition, such as the uptake of a heterologous functional agent (e.g., a heterologous agricultural agent (e.g., pesticidal agent, fertilizing agent, herbicidal agent, plant-modifying agent, plant growth promoting agent, biostimulants, or plant immunity elicitors) carried by the NLP. The degree to which NLP uptake is increased by the surface modifier may vary depending on the plant or plant part to which the NLP composition is delivered. In some embodiments, one or more surface modifiers may increase uptake of an NLP composition by a plant or plant part by at least 1%. 2%. 5%, 10%, 15%, 20%, 30%, 40%, 50%, 60%, 70%, 80%, 90%, or 100% relative to an NLP composition lacking the one or more surface modifiers. In some embodiments, one or more surface modifiers may increase uptake of an NLP composition by a plant or plant part by at least 2×-fold. 4×-fold. 5×-fold. 10×-fold. 100×-fold, or 1000×-fold relative to an NLP composition lacking the one or more surface modifiers. In some embodiments, an NLP composition comprises at least one surface modifier selected from Table 1 that increases uptake of the NLP composition in a plant or plant part. In some embodiments, an NLP composition comprises at least two, three, four, five or more surface modifiers selected from Table 1 that increases uptake of the NLP composition in a plant or plant part.

Several embodiments relate to an NLP composition comprising one or more surface modifiers that increase uptake of the NLP composition by a cell, e.g, a plant cell. In some embodiments, the one or more surface modifiers increase the uptake of the NLP composition as a whole. In some embodiments, the one or more surface modifiers increase the uptake of a portion or component of the NLP composition, such as the uptake of a heterologous functional agent (e.g., a bactericidal agent) carried by the NLP composition. The degree to which uptake is increased may vary depending on the bacterial cell to which the NLP composition is delivered. In some embodiments, one or more surface modifiers may increase uptake of an NLP composition by a bacterial cell by at least 1%. 2%. 5%, 10%, 15%, 20%, 30%, 40%, 50%, 60%, 70%, 80%, 90%, or 100% relative to an NLP composition lacking the one or more surface modifiers. In some embodiments, an NLP composition comprises at least one surface modifier selected from Table 1 that increases uptake of the NLP composition in a bacterial cell. In some embodiments, an NLP composition comprises at least two, three, four, five or more surface modifiers selected from Table 1 that increases uptake of the NLP composition in a bacterial cell.

In some embodiments, a surface modifier may be an anionic agent, a cationic agent, or a zwitterionic agent. In some embodiments, a surface modifier may be a pegylated compound, a glycolipid, an anionic polymer, a polycarboxylate, a polysaccharide, or any combination thereof. In some embodiments, a surface modifier may be a polysaccharide with lipid chains. In some embodiments, a surface modifier is a pegylated surface modifier selected from the group consisting of a pegylated block copolymer (e.g., poloxamer) or a cocamide derivative. In some embodiments, a surface modifier is a pegylated compound selected from the group consisting of PEG2000-C18 and PEG5000-C18. In some embodiments, a surface modifier is a rhamnolipid. In some embodiments, a surface modifier is a sophorolipid. In some embodiments, a surface modifier is an anionic polymer. In some embodiments, a surface modifier is Atlox™ 500L. In some embodiments, a surface modifier is an anionic polymer. In some embodiments, a surface modifier is a styrene-acrylic copolymer. In some embodiments, the surface modifier is Atlox™ 4917. In some embodiments, a surface modifier is a polycarboxylate. In some embodiments, a surface modifier is Atlox™ CS100B. In some embodiments, a surface modifier is a polysaccharide, such as a C8-C10 alkylpolysaccharide. In some embodiments, the surface modifier is Atlox™ AL2575. In some embodiments, the surface modifier is an emulsifier. In some embodiments, a surface modifier is selected from the examples of surface modifiers suitable for NLPs production provided in Table 1.

TABLE 1
Surface modifiers

| Description | Class | Surface modifier (examples) |
|---|---|---|
| Rhamnolipid | glycolipid | Rhamnolipids, 95% (90% Di-Rhamnolipid) |
| Sophorolipid | glycolipid | Sophorolipid Biosurfactant SLM |
| Alkyl polysaccharide | Surfactant | Atlox ™ AL 2575 |
| C8-C10 | (non-ionic) | |
| Alkyl polysaccharide | Surfactant | CRODESTA ™ |
| C16-C18 | (non-ionic) | |
| Fatty acid ethoxylate | Surfactant | NINEX ® MT-615 |
| | (non-ionic) | Toximul 8240 |
| | | Toximul 8241 |
| | | NINEX ® MT-603 |
| Linear Alcohol ethoxylate | Surfactant | BIO-SOFT ® N 411 |
| | (non-ionic) | |
| Cetyl trimethyl ammonium | Surfactant | AMMONYX ® Cetac-30 |
| chloride | (cationic) | |
| Linear isopropylamine | Surfactant | BIO-SOFT ® N91-8 |
| dodecybenzene sulfonate | (anionic) | |
| Tristyrlphenol ethoxylate | Surfactant | STEPFAC ™ TSP-PE-K |
| phosphate ester potassium salt | (anionic) | |
| Modified styrene acrylic | Polymer | Atlox ™ 4917, |
| copolymer | | Atlox ™ 500L |
| | | STEP-FLOW ® 5000 |
| | | Atlox ™ 550S |
| Hydrophobically modified | Polymer | Atlox ™ CS100b |
| polycarboxylate polymer | | STEP-FLOW ® 3000 |
| Carbohydrate biopolymer | Polymer | Sugar Beet Pectin |
| Non-ionic Acrylic Copolymer | Polymer | STEP-FLOW ® 4000 |
| Nonionic comb polymer | Polymer | JEFFSPERSE ® X3202 |
| Nonionic co-block polymer | Polymer | Pluronic ® F127 |
| Tristyrlphenol polyalkylene | Polymer | STEP-FLOW ® 1500 |
| oxide block copolymer | | |
| Head group modified PEG | synthetic | 1,2-distearoyl-sn-glycero-3-phosphoethanolamine-N- |
| Lipids | ethoxylated | [methoxy(polyethylene glycol)-2000] (ammonium salt), |
| | phospholipid | or 1,2-distearoyl-sn-glycero-3-phosphoethanolamine-N- |
| | | [methoxy(polyethylene glycol)-2000] (ammonium salt) |

In some embodiments, a surface modifier may be a lipopolymer. As used herein, the term lipopolymer refers to a lipid substance modified by inclusion of a hydrophilic polymer in its polar head group. In some embodiments, the polymer head group of the lipopolymer is water-soluble. In some embodiments, the hydrophilic polymer has a molecular weight equal or above 750 Da. There are numerous polymers which may be attached to lipids to form lipopolymers, nonlimiting examples include polyethylene glycol (PEG), polysialic acid, polylactic (also termed polylactide), polyglycolic acid (also termed polyglycolide), apolylactic-polyglycolic acid, polyvinyl alcohol, polyvinylpyrrolidone, polymethoxazoline, polyethyloxazoline, poly hydroxyethyloxazoline, poly hydroxy propyloxazoline, polyaspartamide, polyhydroxypropyl methacrylamide, polymethacrylamide, polydimethylacrylamide, polyvinylmethylether, polyhydroxyethyl acrylate, and derivatized celluloses (e.g., hydroxymethylcellulose, hydroxyethylcellulose, etc.). The polymers may be employed as homopolymers or as block or random copolymers. The lipids derivatized into lipopolymers may be neutral, negatively charged, as well as positively charged. In some embodiments, the surface modifier is an emulsifier. In some embodiments the surface modifier is a nonionic co-block polymer. In some embodiments, the nonionic co-block polymer is Pluronic R F127.

In some embodiments, the surface modifier is a PEGylated lipid. Polyethylene glycol (PEG) length can vary from 1 kDa to 10 kDa. In some embodiments, an NLP composition comprising one or more PEGylated lipid having a PEG length of 2 kDa. In some embodiments, an NLP composition comprises one or more the PEGylated lipids independently selected from C14-PEG2k. C18-PEG2k, and DMPE-PEG2k. In some embodiments the PEGylated lipid is a PEG5K PEGylated lipid (e.g. C14-PEG5k. C18-PEG5k or DMPE-PEG5K). In some embodiments, an NLP composition comprises a molar ratio of at least 0.1%. 0.2%. 0.3%. 0.4%. 0.5%. 0.6%. 0.7%. 0.8%. 0.9%. 1%. 1.1%. 1.2%. 1.3%. 1.4%. 1.5%, 1.6%. 1.7%. 1.8%. 1.9%. 2%. 2.1%. 2.2%. 2.3%. 2.4%, 2.5%. 2.6%. 2.7%, 2.8%. 2.9%. 3%. 3.5%. 4%. 4.5%. 5%, 10%, 20%, 30%, 40%, 50%, or more than 50% of one or more PEGylated lipids (e.g., C14-PEG2k. C18-PEG2k. C18-PEG5K. DMPE-PEG2k, etc.). In some embodiments, an NLP composition comprises a molar ratio of at least 0.1%-0.5%. 0.5%-1%, 1%-1, 5%, 1.5%-2.5%. 2.5%-3.5%. 3.5%-5%. 5%-10%, 10%-20%, 20%-30%, 30%-40%, or 30%-50% of one or more PEGylated lipids. In some embodiments, an NLP composition comprises about 0.1%-10% (w/w) PEGylated lipid (e.g., C14-PEG2k. C18-PEG2k. DMPE-PEG2k, etc.). In some embodiments, an NLP composition comprises about 1%-3% of one or more PEGylated lipids. In some embodiments, an NLP composition comprises about 1.5% of one or more PEGylated lipids. In some embodiments, an NLP composition comprises about 2.5% of one or more PEGylated lipids.

In some embodiments, about 5%-50% (w/w) of the lipids in an NLP composition is PEGylated lipid (e.g., about 10%-20% of the lipids in an NLP composition is PEGylated lipid, e.g., about 10%. 12.5%, 16%, or 20% of the lipids in an NLP composition is PEGylated lipid). In some embodiments, about 30%-75% (e.g., about 35% or about 50% PEGylated lipid) of the lipids in an NLP composition is PEGylated lipid. In some embodiments, about 35% −50% (e.g., about 36%. 36.5%. 37%. 37.5%. 38%. 38.5%. 39%. 39.5%, 40%, 40.5%. 41%. 41.5%. 42%. 42.5%. 43%. 43.5%. 44%, 44.5%, 45%, 45.5%, 46%, 46.5%, 47%. 47.5%, 48%. 48.5%. 49%, 49.5%) of the lipids in an NLP composition is PEGylated lipid.

In some embodiments, an NLP composition comprising one or more PEGylated lipids has enhanced uptake relative to an NLP composition not comprising the one or more PEGylated lipids. In some embodiments, an NLP composition comprising one or more PEGylated lipids has altered stability (e.g., increased stability, decreased stability, etc.) relative to an NLP composition that not comprising the one or more PEGylated lipids. In some embodiments, an NLP composition comprising one or more PEGylated lipids has altered particle size relative to an NLP composition not comprising the one or more PEGylated lipids. In some embodiments, an NLP composition comprising one or more PEGylated lipids is less likely to be phagocytosed by a cell than an NLP composition not comprising the one or more PEGylated lipids. In some embodiments, an NLP composition comprises one or more surface modifiers comprising one or more PEG moieties having a molecular weight of the head group from about 750 Da to about 20.000 Da. In some embodiments, an NLP composition comprises one or more surface modifiers comprising one or more PEG moieties having a molecular weight of the head group from about 750 Da to about 12.000 Da. In some embodiments, an NLP composition comprises one or more surface modifiers comprising one or more PEG moieties having a molecular weight of the head group between about 1.000 Da to about 5,000 Da. In some embodiments, an NLP composition comprises one or more neutral (uncharged) lipopolymers. In some embodiments, an NLP composition comprises one or more positively charged lipopolymers. In some embodiments, an NLP composition comprises one or more negatively charged lipopolymers. In some embodiments, an NLP composition comprises one or more neutral distearoyl glycerol and the negatively charged distearoyl phosphatidylethanolamine, both covalently attached to methoxy poly(ethylene glycol) (mPEG or PEG) of Mw 750, 2000, 5000, or 12000.

In some embodiments, a surface modifier is a glycolipid. In some embodiments, one or more glycolipids is a rhamnolipid. In some embodiments, one or more glycolipids is a sophorolipid. In some embodiments, about 5%-50% (w/w) of the lipids in an NLP composition is glycolipid (e.g., about 10%-20% of the lipids in an NLP composition is glycolipid, e.g., about 10%. 12.5%, 16%, or 20% of the lipids in an NLP composition is glycolipid). In some embodiments, about 30%-75% (e.g., about 35% or about 50% glycolipids) of the lipids in an NLP composition is glycolipid. In some embodiments, about 35% −50% (e.g., about 36%. 36.5%, 37%, 37.5%. 38%. 38.5%. 39%. 39.5%, 40%, 40.5%. 41%. 41.5%. 42%. 42.5%, 43%. 43.5%, 44%, 44.5%. 45%. 45.5%, 46%. 46.5%. 47%. 47.5%. 48%. 48.5%. 49%, 49.5%) of the lipids in an NLP composition is glycolipid.

Systemic distribution of NLP compositions is facilitated by a combination of low particle size (preferably <150 nm), low PDI, and appropriate lipid surface composition. Formulations comprising DODMA or DDAB and exhibiting PDI <0.2 have demonstrated root-to-shoot systemic delivery in corn and Arabidopsis.

### E. Label

To aid in analysis and characterization, monitor the mobility of an NLP composition in a plant or plant part, the NLP composition may comprise a detectable label. In some embodiments, the label is a fluorescent protein (e.g., green fluorescent protein). In some embodiments, the label is a protein or a poly nucleic acid conjugated to a fluorophore. In some embodiments, an NLP composition may comprise a dye (e.g., a fluorescent dye). In some embodiments, a dye may be added to an organic phase or to an aqueous phase during production of an NLP composition, depending on the chemical properties of the dye. In some embodiments, an NLP composition can be labeled with one or more of 4-(Dicyanomethylene)-2-methyl-6-(4-dimethylaminostyryl)-4H-pyran (DCM). 3,3′-dihexyloxacarbocyanine iodide (DIOC6), a fluorescent lipophilic dye. PKH67 (Sigma Aldrich): Alexa Fluor R 488 (Thermo Fisher Scientific). Dy Light™ 800 (Thermo Fisher). Exalite 594, Nile red. Exalite 428. Coumarin 481. Coumarin 486, DiD′ solid: DiIC18 (5) solid (1.l′-Dioctadecyl-3,3,3′,3′-Tetramethy lindodicarbocy anine. 4-Chlorobenzenesulfonate Salt). DiO™ Solid: DiOΔ9.12-C18 (3). ClO₄ (3,3′-Dilinoleyloxacarbocy anine Perchlorate). Dil™ oil; DilΔ9.12-C18 (3). ClO4(1.1′-Dilinoleyl-3,3,3′0.3′-Tetramethy lindocarbocyanine Perchlorate), Dil™ solid: DiIA9,12-C18 (3), CBS (1.l′-Dilinoleyl-3,3,3′0.3′-Tetramethy lindocarbocyanine. 4-Chlorobenzenesulfonate). DiIC12 (3) (1.1′-Didodecy 1-3,3,3′0.3′-Tetramethy lindocarbocyanine Perchlorate). DiIC16 (3) (1, l′-Dihexadecyl-3,3,3′,3′-Tetramethy lindocarbocyanine Perchlorate), and DiR′: DiIC18 (7) (1, l′-Dioctadecyl-3,3,3′,3′-Tetramethy lindotricarbocyanine lodide). In some embodiments the DCM dye is added to the organic phase during production of an NLP composition. Several embodiments relate to the use of a label to quantify the total membrane content and can be used to indirectly measure the concentration of NLPs. Several embodiments relate to the use of a label (e.g., a fluorescent marker) to detect cellular uptake of an NLP composition.

Further, the production methods described herein can be supplemented with any quantitative or qualitative methods known in the art to characterize or identify the NLPs at any step of the production process. NLPs may be characterized by a variety of analysis methods to estimate NLP yield. NLP concentration. NLP purity. NLP composition, or NLP sizes. NLPs can be evaluated by a number of methods known in the art that enable visualization, quantitation, or qualitative characterization (e.g., identification of the composition) of the NLPs, such as microscopy (e.g., transmission electron microscopy), dynamic light scattering, nanoparticle tracking, spectroscopy (e.g., Fourier transform infrared analysis), or mass spectrometry (protein and lipid analysis). To aid in analysis and characterization, of the NLP fraction, the NLPs can additionally be labelled or stained. For example, the NLPs can be stained e.g, with 4-(Dicyanomethylene)-2-methyl-6-(4-dimethylaminostyryl)-4H-pyran (DCM). 3,3-dihexyloxacarbocyanine iodide (DIOC6), a fluorescent lipophilic dye. PKH67 (Sigma Aldrich): Alexa Fluor R 488 (Thermo Fisher Scientific), or DyLight™ 800 (Thermo Fisher). In the absence of sophisticated forms of nanoparticle tracking, this relatively simple approach quantifies the total membrane content and can be used to indirectly measure the concentration of NLPs (Rutter and Innes. Plant Physiol. 173 (1): 728-741, 2017; Rutter et al. Bio. Protoc. 7 (17): €2533, 2017). For more precise measurements, and to assess the size distributions of NLPs, nanoparticle tracking can be used.

### F. Physicochemical Properties

1) NLP size

In some embodiments, an NLP as described herein has a mean diameter of about 5-50 nm, about 50-100 nm, about 100-150 nm, about 150-200 nm, about 200-250 nm, about 250-300 nm, about 300-350 nm, about 350-400 nm, about 400-450 nm, about 450-500 nm, about 500-550 nm, about 550-600 nm, about 600-650 nm, about 650-700 nm, about 700-750 nm, about 750-800 nm, about 800-850 nm, about 850-900 nm, about 900-950 nm, about 950-1000 nm, about 1000-1250 nm, about 1250-1500 nm, about 1500-1750 nm, or about 1750-2000 nm. In some embodiments, an NLP as described herein has a mean diameter of about 5-950 nm, about 5-900 nm, about 5-850 nm, about 5-800 nm, about 5-750 nm, about 5-700 nm, about 5-650 nm, about 5-600 nm, about 5-550 nm, about 5-500 nm, about 5-450 nm, about 5-400 nm, about 5-350 nm, about 5-300 nm, about 5-250 nm, about 5-200 nm, about 5-150 nm, about 5-100 nm, about 5-50 nm, or about 5-25 nm. In some embodiments, an NLP as described herein has a mean diameter of about 50-200 nm. In some embodiments, an NLP as described herein has a mean diameter of about 50-300 nm. In some embodiments, an NLP as described herein has a mean diameter of about 200-500 nm. In some embodiments, an NLP as described herein has a mean diameter of about 30-150 nm. In some embodiments, an NLP as described herein has a mean diameter of at least 5 nm, at least 50 nm, at least 100 nm, at least 150 nm, at least 200 nm, at least 250 nm, at least 300 nm, at least 350 nm, at least 400 nm, at least 450 nm, at least 500 nm, at least 550 nm, at least 600 nm, at least 650 nm, at least 700 nm, at least 750 nm, at least 800 nm, at least 850 nm, at least 900 nm, at least 950 nm, or at least 1000 nm. In some embodiments, an NLP as described herein has a mean diameter less than 1000 nm, less than 950 nm, less than 900 nm, less than 850 nm, less than 800 nm, less than 750 nm, less than 700 nm, less than 650 nm, less than 600 nm, less than 550 nm, less than 500 nm, less than 450 nm, less than 400 nm, less than 350 nm, less than 300 nm, less than 250 nm, less than 200 nm, less than 150 nm, less than 100 nm, or less than 50 nm. A variety of methods (e.g., a dynamic light scattering method) standard in the art can be used to measure the particle diameter of NLPs.

In some embodiments, an NLP has a mean surface area of 77 nm² to 3.2 ×10⁶ nm² (e.g., 77-100 nm². 100-1000 nm². 1000-1×10⁴ nm². 1×10⁴-1×10⁵ nm². 1×10⁵-1×10⁶ nm², or 1×10⁶-3.2×10⁶ nm²). In some embodiments, an NLP has a mean volume of 65 nm³ to 5.3×10⁸ nm³ (e.g., 65-100 nm³. 100-1000 nm³. 1000-1×10⁴ nm³. 1×10⁴-1×10⁵ nm³. 1×10⁵-1×10⁶ nm³. 1×10⁶-1×10 nm³. 1×10-1×10⁸ nm³. 1×10⁸-5.3×10⁸ nm³). In some embodiments, an NLP has a mean surface area of at least 77 nm². (e.g., at least 77 nm², at least 100 nm², at least 1000 nm², at least 1×101 nm², at least 1×10⁵ nm², at least 1×10⁶ nm², or at least 2×10⁶ nm²). In some embodiments, an NLP may include a plant EV, or segment, portion, or extract thereof, that has a mean volume of at least 65 nm³ (e.g., at least 65 nm³, at least 100 nm³, at least 1000 nm³, at least 1×10⁴ nm³, at least 1×10⁵ nm³, at least 1×10⁶ nm³, at least 1×10 nm³, at least 1×10⁸ nm³, at least 2×10⁸ nm³, at least 3×10⁸ nm³, at least 4×10⁸ nm³, or at least 5×10⁸ nm³.

In some embodiments, the size of an NLP may be determined following loading of one or more heterologous functional agents or following other modifications to the NLP. In some embodiments, an NLP comprising one or more heterologous functional agents may have a mean surface area of 77 nm² to 1.3 ×10 nm² (e.g., 77-100 nm². 100-1000 nm². 1000-1×10⁴ nm². 1×10⁴-1×10⁵ nm². 1×10⁵-1×10⁶ nm², or 1×10⁶-1.3×10 nm²).

In some embodiments, an NLP comprising a heterologous functional agent may have a mean volume of 65 nm³ to 4.2 ×10⁹ nm³ (e.g., 65-100 nm³. 100-1000 nm³. 1000-1×10⁴ nm³. 1×10⁴-1×10⁵ nm³. 1×10⁵-1×10⁶ nm³. 1×10⁶-1×10 nm³. 1×10-1×10⁸ nm³. 1×10⁸-1×10⁹ nm³, or 1×10⁹- 4.2 ×10⁹ nm³). In some embodiments, an NLP has a mean surface area of at least 77 nm². (e.g., at least 77 nm², at least 100 nm², at least 1000 nm², at least 1×10⁴ nm², at least 1×10⁵ nm², at least 1×10⁶ nm², or at least 1×10 nm²). In some embodiments, an NLP has a mean volume of at least 65 nm³ (e.g., at least 65 nm³, at least 100 nm³, at least 1000 nm³, at least 1×10⁴ nm³, at least 1×10⁵ nm³, at least 1×10⁶ nm³, at least 1×10 nm³, at least 1×10⁸ nm³, at least 1×10⁹ nm³, at least 2×10⁹ nm³, at least 3×10⁹ nm³, or at least 4×10⁹ nm³).

2) NLP Zeta Potential

The NLP composition comprising a phospholipid, a non-polar lipid and/or an essential oil, and optionally a surface modifier may have, e.g., a zeta potential of less than 0 mV, less than −5 mV, less than −10 mV, less than −20 m V, less than −30 mV, less than −40 mV, less than −50 mV, less than-60 m V, less than −70 mV, less than −80 mV, less than −90 mV or less than −100 mV when in the absence of cargo. In some embodiments, the NLP composition comprising a phospholipid, a non-polar lipid and/or an essential oil, and optionally a surface modifier may have, e.g., a zeta potential of less than 0 mV, less than −5 mV, less than −10 mV, less than −20 mV, less than −30 mV, less than −40 mV, less than −50 mV, less than −60 mV, less than −70 m V, less than −80 mV, less than −90 mV or less than −100 mV when in the presence of cargo. In some embodiments, the zeta potential of the NLP comprising a phospholipid, a non-polar lipid and/or an essential oil, and optionally a surface modifier and a cargo (e.g, a heterologous functional agent) ranges between −10 mV and −60 m V, between −20 mV and −50 m V, or between −30 mV and −50 mV.

The zeta potential of an NLP composition may be measured using any method known in the art. Zeta potentials are generally measured indirectly, e.g., calculated using theoretical models from the data obtained using methods and techniques known in the art, e.g., electrophoretic mobility or dynamic electrophoretic mobility. Electrophoretic mobility is typically measured using microelectrophoresis, electrophoretic light scattering, or tunable resistive pulse sensing. Electrophoretic light scattering is based on dynamic light scattering. Typically, zeta potentials are accessible from dynamic light scattering (DLS) measurements, also known as photon correlation spectroscopy or quasi-elastic light scattering.

3) Polydispersity Index (PDI) of NLP Formulations

In some embodiments, the lipid nanoparticle (NLP) formulations described herein are characterized by a polydispersity index (PDI) that reflects the uniformity of the particle size distribution. A low PDI value (closer to 0)) indicates a narrow, monodisperse distribution of particle sizes, while a higher PDI (closer to 1) reflects greater size heterogeneity. For NLP applications in plant delivery, a narrow size distribution is desirable for predictable uptake, systemic movement, stability, and reproducibility of the formulation across different plant species and application methods. In some embodiments, the NLP formulations have a PDI of less than 0.3, such as less than 0.25, less than 0.2, or less than 0.15. In preferred embodiments, the PDI is in the range of 0.05 to 0.2. Formulations with PDI below 0.2 are associated with: improved colloidal stability, reducing aggregation or sedimentation during storage or use: enhanced systemic distribution in plant tissues due to uniform transport properties: better encapsulation efficiency and batch-to-batch reproducibility; more uniform uptake and trafficking across plant cell barriers.

In certain embodiments described herein. NLP formulations with mean particle sizes below 200 nm and PDI values below 0.2 demonstrate superior root-to-shoot translocation and delivery to meristematic tissues. Formulations with higher PDI values (>0).3) tended to exhibit reduced systemic movement.

In some embodiments, the movement and biodistribution of NLPs can be programmed or modulated by adjusting the polydispersity index (PDI) of the formulation. As used herein. “programming NLP movement” refers to designing physicochemical parameters of the NLP to influence its uptake, localization, and/or systemic translocation within a plant following application. In some embodiments. NLP formulations with PDI values of 0.05 to 0.15 are designed to promote root-to-shoot movement, delivering functional agents from below-ground application sites to aerial tissues. In other embodiments, formulations with moderate PDI values (e.g., 0.15-0.25) may be used to promote partial systemicity with targeted retention in certain tissues, such as stems or vasculature. Formulations with higher PDI values (e.g., >0).3) may be used intentionally to localize NLPs to specific zones (e.g., root apoplast) for sustained release or contact action. PDI may be modulated during formulation by altering: lipid composition (e.g., chain length, saturation): inclusion of stabilizers or emulsifiers (e.g., PEGylated lipids, pectin derivatives): homogenization or microfluidic parameters (e.g., pressure, cycles, mixing ratio): core polarity and cargo loading, which affect particle packing and formation dynamics. Thus, by engineering the PDI of NLPs, formulations can be tailored for desired movement patterns-ranging from localized delivery to full systemic transport-depending on the crop species, application route, and biological objective.

### G. Loading of Heterologous Functional Agents

Several embodiments relate to an NLP composition comprising one or more heterologous functional agents (e.g., a cell-penetrating agent, an agricultural agent (e.g., pesticidal agent, fertilizing agent, herbicidal agent, plant-modifying agent, plant growth promoting agent, biostimulants, or plant immunity elicitors), a therapeutic agent (e.g., an antifungal agent, an anti-oomycete agent, an antibacterial agent, antifungal agent, an anti-viral agent, an insecticidal agent, a nematocidal agent, an antiparasitic agent, an insect repellent), etc.). An NLP as described herein can carry or associate with one or more heterologous functional agents by a variety of means, e.g., by encapsulating the heterologous functional agent, incorporation of the heterologous functional agent in a lipid layer (e.g., a lipid bilayer), association (e.g., by conjugation) of one or more heterologous functional agents with the surface of a lipid layer of an NLP. In some embodiments, one or more heterologous functional agents (e.g., a cell-penetrating agent, a pesticide, etc.) is included in an NLP composition. In some embodiments, one or more heterologous functional agents are stably associated with an NLP composition prior to and following delivery e.g., to soil, to a root of a plant, to a pest, etc. In some embodiments, one or more heterologous functional agents become dissociated (e.g., are released) from an NLP following delivery e.g., to soil, to a root of a plant, to a pest, etc.

In some embodiments, the heterologous functional agent is a hydrophobic functional agent. As used herein, a “hydrophobic functional agent” refers to any biologically active molecule that exhibits low water solubility (e.g., logP >1), and which requires a nonpolar or amphiphilic environment for solubilization, stabilization, or delivery. Such agents may include lipophilic pesticides, natural products, essential oils, fatty acid derivatives, carotenoids, terpenes, or hydrophobic plant growth regulators. In some embodiments, the NLP encapsulates a hydrophobic functional agent, such as: lipophilic insecticides (e.g., deltamethrin, bifenthrin, spinosad): essential oils and components (e.g., thymol, eugenol, carvacrol): lipophilic fungicides or bactericides (e.g., azoxystrobin, pyraclostrobin): fat-soluble plant hormones or mimics (e.g., abscisic acid, brassinolide); and alkaloids or plant-derived metabolites (e.g., capsaicin, rotenone).

In some embodiments, the NLPs comprise an essential oil, e.g, cinnamon oil. In some embodiments, the cinnamon oil includes about 95, 90, 80, 70, 60, 50, 40, 30, 20, 15, 10, 9, 8, 7, 6, 5, 4, 3, 2, 1.0, 0.1, 0.01, 0.001 (or any range between about 95 and 0.001) or less weight % of the total weight percent of non-polar lipids (NP) and/or an essential oil (EO), polar lipids (P). and surface modifiers (SM) combined. In some embodiments, the presence of an essential oil, e.g, cinnamon oil, increases the loading efficiency of a hydrophobic agent, e.g. CTPR. In some embodiments, the hydrophobic agent is fully soluble in the essential oil. In some embodiments, the hydrophobic agent is partly soluble in the essential oil. In some embodiments, the encapsulation efficiency is calculated by ((initial amount of bioactive)/(NLP encapsulated amount of bioactive))*100%. In some embodiments, the encapsulation efficiency of a bioactive, e.g. CTPR, in NLPs comprising an essential oil, e.g, cinnamon oil, is increased by a factor of 1.5, 2, 3, 4, 5, 6, 7, 8, 9, 10, 100 or 1000 fold (or any range between about 1.5 and 1000) as compared to the encapsulation efficiency of the same bioactive, e.g. CTPR, in NLPs not comprising the essential oil, e.g, cinnamon oil. In some embodiments, the weight percent cinnamon oil in the NLP composition is positive correlated to the encapsulation of the bioactive, e.g. CTPR.

In some embodiments, one or more heterologous functional agents are incorporated into an NLP during formation of the NLP, using a microfluidic device. Several embodiments are related to incorporating one or more heterologous functional agents into an NLP by providing one or more phospholipids and oil in an organic phase and one or more surface modifiers and heterologous functional agents in an aqueous phase, wherein the organic and aqueous phases are combined (e.g., in a microfluidics device), to produce an NLP composition comprising the heterologous functional agent. Several embodiments are related to incorporating one or more heterologous functional agents into an NLP by providing one or more phospholipids, oils, and surface modifiers in an organic phase and providing one or more heterologous functional agents in an aqueous phase, wherein the organic and aqueous phases are combined (e.g., in a microfluidics device), to produce an NLP composition comprising the heterologous functional agent. Several embodiments are related to incorporating one or more heterologous functional agents into an NLP by providing one or more phospholipids, oils and heterologous functional agents in an organic phase and providing one or more surface modifiers in an aqueous phase, wherein the organic and aqueous phases are combined (e.g, in a microfluidics device) to produce an NLP comprising the heterologous functional agent.

In some embodiments, the NLP comprises a hydrophobic core, such as an oil droplet or lipid-rich phase, surrounded by a stabilizing shell composed of phospholipids, sterols, and/or PEGylated lipids. This architecture enables the encapsulation of hydrophobic functional agents within the core or intercalated in the lipid bilayer. Suitable hydrophobic core materials include medium-chain triglycerides, squalene, tocopherols, oleic acid, or biocompatible solvents such as benzyl benzoate or isopropyl myristate.

Several embodiments are related to incorporating one or more heterologous functional agents into an NLP by loading one or more heterologous functional agents into a pre-formed NLP by any methods known in the art that allow association, directly or indirectly, between the NLPs and one or more heterologous functional agents. The heterologous functional agent may be loaded onto or into (e.g., may be encapsulated by) an NLPs using, but not limited to, physical, chemical, and/or biological methods. In some embodiments, one or more heterologous functional agents may be introduced into an NLP by one or more of electroporation, sonication, passive diffusion, stirring, lipid extraction, and extrusion. However, it should be appreciated by those skilled in the art that the loading of a substance of interest into NLPs is not limited to the above-illustrated methods. Loaded NLPs can be assessed to confirm the presence or level of the loaded agent using a variety of methods, such as HPLC (e.g., to assess small molecules, e.g. CTPR, permethrin, or deltamethrin), immunoblotting (e.g., to assess proteins); and/or quantitative PCR (e.g., to assess nucleotides).

In some embodiments, a composition comprising NLPs is formulated or one or more NLP compositions are loaded to provide a composition comprising NLPs with various concentrations of one or more heterologous functional agents, depending on the particular agent or use. In some embodiments, a composition comprising NLPs is formulated or one or more NLP compositions are loaded such that a composition comprising NLPs as disclosed herein includes about 0.001, 0.01, 0.1, 1.0, 2, 3, 4, 5, 6, 7, 8, 9, 10, 15, 20, 30, 40, 50, 60, 70, 80, 90, 95 (or any range between about 0.001 and 95) or more weight % of one or more heterologous functional agents. In some embodiments, an NLP composition is loaded or an NLP composition is formulated such that the NLP composition includes about 95, 90, 80, 70, 60, 50, 40, 30, 20, 15, 10, 9, 8, 7, 6, 5, 4, 3, 2, 1.0, 0.1, 0.01, 0.001 (or any range between about 95 and 0.001) or less weight % of one or more heterologous functional agents. In some embodiments, an NLP composition can include about 0.001 to about 0.01 weight %, about 0.01 to about 0.1 weight %, about 0.1 to about 1 weight %, about 1 to about 5 weight %, or about 5 to about 10 weight %, about 10 to about 20 weight % of one or more heterologous functional agents. In some embodiments, an NLP composition can be loaded or an NLP composition is formulated with about 1, 5, 10, 50, 100, 200, 500, 1.000, 2.000 (or any range between about 1 and 2.000) or more pg/ml of one or more heterologous functional agents. In some embodiments, an NLP composition can be loaded or a NLP composition can be formulated with about 2.000, 1.000, 500, 200, 100, 50, 10, 5, 1 (or any range between about 2.000 and 1) or less pg/ml of one or more heterologous functional agents.

In some embodiments, an NLP composition is formulated or an NLP composition is loaded such that the NLP composition comprises at least 0.001 weight %, at least 0.01 weight %, at least 0.1 weight %, at least 1.0 weight %, at least 2 weight %, at least 3 weight %, at least 4 weight %, at least 5 weight %, at least 6 weight %, at least 7 weight %, at least 8 weight %, at least 9 weight %, at least 10 weight %, at least 15 weight %, at least 20 weight %, at least 30 weight %, at least 40 weight %, at least 50 weight %, at least 60 weight %, at least 70 weight %, at least 80 weight %, at least 90 weight %, or at least 95 weight % of one or more heterologous functional agents. In some embodiments, an NLP composition can be loaded or an NLP composition can be formulated with at least 1 μg/ml, at least 5 μg/ml, at least 10 μg/ml, at least 50 μg/ml, at least 100 μg/ml, at least 200 μg/ml, at least 500 μg/ml, at least 1.000 μg/ml, at least 2.000 μg/ml of one or more heterologous functional agents.

In some embodiments, an NLP composition is formulated with one or more heterologous functional agents by suspending (e.g., by vigorous mixing) the NLP composition in a solution comprising or consisting essentially of one or more heterologous functional agents. In some embodiments, one or more heterologous functional agents (e.g., an antifungal agent, an anti-oomycete agent, an antibacterial agent, an insecticidal agent, a molluscicidal agent, a nematocidal agent, a herbicidal agent, a virucidal agent, a peptide, a polypeptide, a nucleic acid, a polynucleotide, etc.) may comprise less than 1% or at least 1%. 5%, 10%, 20%, 30%, 40%, 50%, 60%, 70%, 80%, 90%, or 100% of a solution in which one or more NLP compositions are suspended.

### H. Heterologous Functional Agents

Several embodiments relate to an NLP composition comprising one or more heterologous functional agents, such as one or more of a pesticidal agent, fertilizing agent, herbicidal agent, plant-modifying agent, antifungal agent, an anti-oomycete agent, an antibacterial agent, a virucidal agent, an anti-viral agent, an insecticidal agent, a nematocidal agent, an antiparasitic agent, and an insect repellent. In some embodiments of an NLP composition as described herein, an NLP may encapsulate the heterologous functional agent. In some embodiments of an NLP composition as described herein, the heterologous functional agent can be embedded on or conjugated to the surface of the NLP. In some embodiments, an NLP composition may include two or more (e.g., 2, 3, 4, 5, 6, 7, 8, 9, 10), or more than 10) different heterologous functional agents. Heterologous functional agents may be added at any step during the manufacturing process effective to introduce the agent into the NLP composition. In some embodiments, the heterologous functional agent is unencapsulated.

In some embodiments, one or more heterologous functional agents comprised in an NLP composition may be any of the pesticidal agents disclosed herein. In some embodiments, a pesticidal agent may be a naturally occurring or synthetic insecticide (e.g., a larvicide, an adulticide, etc.). In some embodiments, a pesticidal agent may be a naturally occurring or synthetic insect growth regulator. In some embodiments, a pesticidal agent may be a naturally occurring or synthetic acaricide (miticides). In some embodiments, a pesticidal agent may be a naturally occurring or synthetic molluscicide, nematicide, ectoparasiticide, bactericide, fungicide, or herbicide. The term “pesticidal agent” may further encompass other bioactive molecules such as antibiotics, antivirals pesticides, antifungals, antihelminthics, nutrients, and/or agents that stun or slow insect movement, fecundity, etc. In some embodiments, a heterologous functional agent may be a therapeutic agent (e.g., a cell-penetrating agent, an antifungal agent, an antibacterial agent, a virucidal agent, an anti-viral agent, an insecticidal agent, a nematicidal agent, an antiparasitic agent, an insect repellent, etc.). In some embodiments, an NLP composition includes two or more (e.g., 2, 3, 4, 5, 6, 7, 8, 9, 10, or more than 10) different heterologous functional agents, e.g, deltamethrin and permethrin. In some embodiments, an NLP composition as described herein may comprise one or more heterologous functional agents described in PCT/US2024/015064, which is incorporated in its entirety. Exemplary pesticidal agents are disclosed in PCT/US2024/015064, which is incorporated in its entirety herein.

Several embodiments relate to an NLP composition as described herein comprising one or more insecticidal agents. In some instances, an NLP composition includes two or more (e.g., 2, 3, 4, 5, 6, 7, 8, 9, 10, or more than 10) different insecticidal agents. Several embodiments relate to a method of decreasing the fitness (e.g., decrease growth or kill) of a targeted insect by contacting the targeted insect or a plant or animal infested with or parasitized by the targeted insect with an NLP composition including an insecticidal agent, in an amount and for a time sufficient to: (a) reach a target level (e.g., a predetermined or threshold level) of insecticidal agent concentration inside or on the target insect; and (b) decrease fitness of the target insect. Insecticidal agents may be loaded/incorporated into an NLP composition as described herein and/or formulated with an NLP composition by any of the methods described herein.

In some embodiments, a heterologous functional agent (e.g., a heterologous agricultural agent (e.g., pesticidal agent, fertilizing agent, herbicidal agent, plant-modifying agent, a heterologous nucleic acid, a heterologous polypeptide, a heterologous small molecule, etc.) or a heterologous therapeutic agent (e.g., an antifungal agent, an anti-oomycete agent, an antibacterial agent, a virucidal agent, an anti-viral agent, a nematicidal agent, an antiparasitic agent, an insect repellent, etc.)) can be modified. For example, the modification can be a chemical modification, e.g., conjugation to a marker, e.g., fluorescent marker or a radioactive marker. In some embodiments, the modification can include conjugation or operational linkage of a heterologous functional agent to a moiety that enhances the stability, delivery, targeting, bioavailability, or half-life of the agent, e.g., a lipid, a glycan, a polymer (e.g., PEG), or a cation moiety.

In some embodiments herein, methods are provided for encapsulating bioactives with a high volatility, e.g, having a high vapor pressure. Exemplary volatile agents used in the field of agriculture include but are not limited to herbicides (e.g. Dicamba or 2.4-D), fumigants, pheromones, and essential oils.

In some embodiments, the heterologous functional agent is a volatile agent. A volatile heterologous functional agent has a high vapor pressure. Examples of volatile agents used in the field of agriculture are herbicides that are typically applied as a foliar spray, fumigants which are applied to soil to kill insects, pheromones to disrupt insect mating, and essential oils to repel insects. A high vapor pressure means a high environmental exposure and potential environmental hazard, to farmers, and to off-target plants (e.g, grape vines) and off-target insects (e.g, honey bees). Spray drift is a common concern for off-target injury. It occurs when small droplets comprising the bioactive move to off-target vegetation during the process of treating the target site. Furthermore, undesired spread of e.g, a herbicide can occur when a spray solution settles on-site and then changes to a vapor phase and is carried off-site by wind. NLP encapsulation of a volatile bioactive offers a means to reduce that hazard and undesired effects on off-targets.

In some embodiments. NLP encapsulation of a volatile bioactive alters the environmental exposure to the volatile bioactive. By altering the chemistry of the components of the NLPs. NLPs can be formed of various sizes, stability, and degrees of penetrability. These factors govern the speed with which the volatile bioactive ingredient encapsulated therein is released, which in turn, affects the residual performance, speed of action, and environmental exposure of the bioactive. In some embodiments, a composition comprises a mixture of NLPs comprising one or more volatile bioactives, facilitating the controlled release of the one or more bioactives over time. In some embodiments. NLP encapsulation of any of the volatile functional agents recited herein (e.g, a volatile insecticide, a volatile herbicide, a volatile fumigant or a volatile essential oil) facilitates their use in spray form. In some embodiments, an NLP composition comprising a volatile functional agent is a sprayable formulation.

In some embodiments, the volatile functional agent is an insecticide recited herein, having a high vapor pressure. In some embodiments. NLP encapsulation of any of the volatile insecticides recited herein facilitates their use in spray form. In some embodiments, an NLP composition comprising a volatile insecticide is a sprayable insecticide formulation. Exemplary volatile insecticides, herbicides, fumigants, and pheromones are recited in PCT/US2024/015064, which is incorporated in its entirety herein.

### I. Formulations

In some embodiments, an NLP composition as described herein can be formulated with other substances to allow case of application, handling, transportation, storage, effective activity, etc. In some embodiments, an NLP composition can be formulated into, for example, baits, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra-low volume solutions. In some embodiments, an NLP composition as described herein may be formulated as a formulation type described in “Catalogue of Pesticide Formulation Types and International Coding System” Technical Monograph n° 2, 5th Edition by CropLife International (2002), which is incorporated herein in its entirety.

In some embodiments, an NLP composition as described herein can be formulated as an aqueous suspension or emulsion. In some embodiments, an NLP composition as described herein can be formulated as an aqueous suspension or emulsion prepared from concentrated formulations. In some embodiments, a concentrated NLP formulation may be water-soluble, water-suspendable, or emulsifiable. In some embodiments, a concentrated NLP formulation may be a solid, such as a wettable powder or water dispersible granules, or a liquid, such as an emulsifiable concentrate or aqueous suspension. In some embodiments, a concentrated NLP formulation may be a wettable powder, which may be compacted to form water dispersible granules, comprising an intimate mixture of one or more NLP compositions, one or more carriers, and optionally, one or more surfactants. In some embodiments, an NLP composition as described herein may be formulated with one or more carriers selected from the group consisting of attapulgite clay, montmorillonite clay, diatomaceous earth, and purified silicate, or any combination thereof. In some embodiments, an NLP composition as described herein may be formulated with one or more surfactants, including from about 0.5% to about 10% of the formulation (e.g., a wettable powder) comprising one or more of sulfonated lignin, condensed naphthalenesulfonate, naphthalenesulfonate, alkylbenzenesulfonate, alkyl sulfate, and non-ionic surfactant (e.g., ethylene oxide adducts of alkyl phenols).

In some embodiments, an NLP composition as described herein can be formulated as an emulsifiable concentrate. In some embodiments, an emulsifiable concentrate comprises one or more NLP compositions as described herein at a concentration of from about 50 to about 500 grams per liter of liquid dissolved in a carrier (e.g., an organic solvent, a water miscible solvent, a mixture of water-immiscible organic solvent and emulsifiers, etc.). In some embodiments, an emulsifiable concentrate comprises one or more NLP compositions dissolved in an organic solvent. In some embodiments, an emulsifiable concentrate comprises one or more NLP compositions dissolved in an organic solvent selected from an aromatic solvent (e.g., xylene, petroleum fractions (e.g., high-boiling naphthalenic and olefinic portions of petroleum such as heavy aromatic naphtha), a terpenic solvent (e.g., rosin derivatives), aliphatic ketones such as cyclohexanone, and complex alcohols such as 2-ethoxyethanol. In some embodiments, an emulsifiable concentrate comprises one or more NLP compositions and one or more suitable emulsifiers, such as anionic and non-ionic surfactants.

In some embodiments, an NLP composition as described herein can be formulated as an aqueous suspension. In some embodiments, an aqueous suspension comprises one or more water-insoluble NLP compositions dispersed in an aqueous carrier at a concentration in the range from about 5% to about 50% by weight. In some embodiments, an aqueous suspension is prepared by finely grinding a dry formulation of one or more NLP compositions and vigorously mixing with an aqueous carrier (e.g., water) and, optionally, one or more surfactants. In some embodiments, one or more NLP compositions may be formulated in an aqueous carrier comprising one or more of an inorganic salt, synthetic gum, natural gum, etc., which may be added to increase the density and viscosity of the aqueous carrier.

In some embodiments, an NLP composition as described herein can be formulated as a granular composition. In some embodiments, a granular composition comprises from about 0.5% to about 10% by weight of one or more NLP compositions dispersed in a carrier, such as clay, starch, silicate, etc. In some embodiments, a granular composition is prepared by dispersing one or more NLP compositions in a suitable solvent and applying it to a granular carrier which has been pre-formed to the appropriate particle size, in the range of from about 0.5 to about 3 mm. In some embodiments, a granular composition is prepared by making a dough or paste of the carrier and one or more NLP compositions and crushing and drying to obtain the desired granular particle size.

In some embodiments, an NLP composition as described herein can be formulated as a powder. In some embodiments, a powder is formulated by mixing one or more NLP compositions as described herein provided in powdered form with a suitable dusty agricultural carrier, such as kaolin clay, ground volcanic rock, and the like. In some embodiments, a powder formulation of one or more NLP compositions as described herein comprises a suitable dusty agricultural carrier at a concentration from about 1% to about 10%. In some embodiments, a powder formulation of one or more NLP compositions can be applied as a seed dressing or as a foliage application with a dust blower machinc.

In some embodiments, an NLP composition as described herein can be formulated in an organic solvent (e.g., petroleum oil, such as the spray oils, which are widely used in agricultural chemistry).

In some embodiments, an NLP composition as described herein can be formulated to be applied in the form of an aerosol composition. In some embodiments, one or more NLP compositions are dissolved or dispersed in a carrier and packaged in a container comprising a pressure-generating propellant mixture. In some embodiments, an NLP composition formulated as an aerosol composition is packaged in a container from which the mixture is dispensed through an atomizing valve.

In some embodiments, an NLP composition as described herein can be formulated as an oil-in-water emulsion. In some embodiments, an NLP composition as described herein can be formulated as an oil-in-water emulsion comprising oily globules which are each provided with a lamellar liquid crystal coating dispersed in an aqueous phase, wherein each oily globule comprises at least one heterologous active agent, and is individually coated with a monolamellar or oligolamellar layer including: (1) at least one non-ionic lipophilic surface-active agent. (2) at least one non-ionic hydrophilic surface-active agent and (3) at least one ionic surface-active agent, wherein the globules having a mean particle diameter of less than 800 nanometers. Further information on the embodiment is disclosed in U.S, patent publication 20070027034 published February 1, 2007. For ease of use, this embodiment will be referred to as “OIWE.”

In some embodiments, an NLP composition as described herein can be formulated with one or more of wetters, spreaders, stickers, penetrants, buffers, sequestering agents, drift reduction agents, compatibility agents, anti-foam agents, cleaning agents, surfactants, diluents, green agents, carriers to protect against UV radiation, and emulsifiers. Exemplary components in each of these categoreis are disclosed in PCT/US2024/015064, which is incorporated in its entirety herein. In some embodiments, an NLP composition as described herein can be formulated as described in “Chemistry and Technology of Agrochemical Formulations” edited by D. A. Knowles, copyright 1998 by Kluwer Academic Publishers, which is incorporated herein by reference. In some embodiments, an NLP composition as described herein can be formulated as described in “Insecticides in Agriculture and Environment-Retrospects and Prospects” by A. S. Perry. I. Yamamoto. I. Ishaaya, and R. Perry, copyright 1998 by Springer-Verlag, which is incorporated herein by reference.

In some embodiments, an NLP composition as described herein can be freeze-dried or lyophilized. See, e.g., U.S. Pat. No. 4,311,712 incorporated by reference herein. In some embodiments, freeze-dried or lyophilized NLP compositions can be reconstituted with water or another liquid. In some embodiments, freeze-dried or lyophilized NLP compositions can be reconstituted with a solution comprising one or more heterologous functional agents, agriculturally acceptable carriers, solvents, co-solvents, dispersing agents, emulsifiers, and/or other materials in accordance with the formulations described herein.

### J. Kits

The present invention also provides a kit including e.g, a container having a NLP composition described herein. The kit may further include instructional material for applying or delivering the NLP composition to a plant in accordance with a method of the present invention. The skilled artisan will appreciate that the instructions for applying the NLP composition in the methods of the present invention can be any form of instruction. Such instructions include, but are not limited to, written instruction material (such as, a label, a booklet, a pamphlet), oral instructional material (such as on an audio cassette or CD) or video instructions (such as on a video tape or DVD).

### II. Methods

A. NLP Production Methods

In some embodiments, an NLP composition as described herein may be prepared by mixing an organic phase, comprising at least one non-polar lipid and/or an essential oil and at least one phospholipid, with an aqueous phase. In some embodiments, one or more surface modifiers is added either to the organic phase or the aqueous phase, depending on the chemical properties of the surface modifier.

In some embodiments, an NLP composition is produced by a process which comprises microfluidics. In some embodiments, an NLP composition is produced by mixing a lipid solution and an aqueous phase in a microfluidics device at any suitable ratio. In some embodiments, an NLP composition is produced by mixing a lipid solution and an aqueous phase in a microfluidics device at a 1:3 volumetric ratio. In some embodiments, an NLP composition is produced by mixing a lipid solution and an aqueous phase in a microfluidics device at a 1:1, 1:2, 1:3, 1:4, or 1:5 volumetric ratio.

In some embodiments, one or more lipids comprised in an NLP composition are extracted from a plurality of lipid sources (e.g., extracting lipids using the Bligh-Dyer method (Bligh and Dyer. J Biolchem Physiol. 37:911-917, 1959)). In some embodiments, one or more oils or lipids comprised in an NLP composition are extracted from a plant source (e.g., soy bean, citrus (e.g., lemon, orange, grapefruit, etc.), avocado, tomato, corn, etc.). In some embodiments, one or more extracted oils or lipids may be provided as a stock solution (e.g., a solution in chloroform methanol). In some embodiments one or more extracted lipids are processed to produce a lipid film. In some embodiments, a lipid film is produced by evaporation of solvent with a stream of inert gas (e.g., nitrogen). In some embodiments, a organic phase (e.g, lipid or oil) used during NLP production may comprise one or more phospholipids. In some embodiments, a organic phase used during NLP production may comprise one or more non-polar lipids and/or one or more essential oils. In some embodiments, a organic phase used during NLP production may comprise one or more polar lipids, e.g, phospholipids, one or more non-polar lipids and/or one or more essential oils. In some embodiments, a organic phase used during NLP production, e.g, an oil, may comprise one or more hydrophobic heterologous functional agents. In some embodiments, a organic phase used during NLP production may comprise one or more hydrophobic heterologous functional agents selected from the group consisting of an antifungal agent, an antibacterial agent, an insecticidal agent, a molluscicidal agent, a nematocidal agent, a herbicidal agent, a virucidal agent, a peptide, a polypeptide, a nucleic acid, and a polynucleotide, or any combination thereof. In some embodiments, a organic phase used during NLP production may comprise one or more surface modifiers. In some embodiments, a organic phase used during NLP production may comprise one or more co-solvents. In some embodiments, a organic phase used during NLP production may comprise one or more excipients.

In some embodiments, an aqueous phase used during NLP production may be a citrate buffer (e.g., a citrate buffer having a pH of about 3.2). In some embodiments, an aqueous phase used during

NLP production may be de-ionized water. In some embodiments, an aqueous phase used during NLP production may be phosphate-buffered saline (PBS). In some embodiments, an aqueous phase used during NLP production may comprise one or more hydrophilic heterologous functional agents. In some embodiments, an aqueous phase used during NLP production may comprise one or more hydrophilic heterologous functional agents selected from the group consisting of an antifungal agent, an antibacterial agent, an insecticidal agent, a molluscicidal agent, a nematocidal agent, an herbicidal agent, a virucidal agent, a peptide, a polypeptide, a nucleic acid, and a polynucleotide, or any combination thereof. In some embodiments, an aqueous phase used during NLP production may comprise one or more proteins. In some embodiments, an aqueous phase used during NLP production may comprise one or more ribonucleoproteins. In some embodiments, an aqueous phase used during NLP production may comprise one or more nucleic acids. In some embodiments, an aqueous phase used during NLP production may comprise one or more cationic molecules. In some embodiments, an aqueous phase used during NLP production may comprise one or more surface modifiers. In some embodiments, an aqueous phase used during NLP production may comprise one or more co-solvents. In some embodiments, an aqueous phase used during NLP production may comprise one or more excipients.

In some embodiments, an NLP composition may comprise at least one phospholipid. In some embodiments, an NLP composition may comprise one or more phospholipids selected from the group consisting of phosphatidylcholine, phosphatidylethanolamine, phosphatidylinositol, phosphatidic acid, phosphatidyl serine, and 1.2-dimyristoy l-sn-glycero-3-phosphate or any combination thereof. In some embodiments, an NLP composition may comprise at least one phospholipid selected from the group consisting of soy bean lecithin and sunflower lecithin. In some embodiments, an NLP composition may comprise at least one non-polar lipid. In some embodiments, an NLP composition may comprise at least one non-polar lipid comprising 40% of at least one fatty acid chain selected from the group consisting of a poly-unsaturated fatty acid, mono-unsaturated fatty acid and saturated fatty acid or any combination thereof. In some embodiments, an NLP composition may comprise one or more phospholipids and one or more non-polar lipids. In some embodiments, an NLP composition may comprise at least 0.5%, 1%. 5%, 10%, 15%, 20%, 25%, 30%, 35%, 40%, 45%, 50%, 55%, 60%, 65%, 70%, 75%, 80%, 85%, 90%, or more than 90% phospholipid (w/w) of total lipids in the NLP composition. In some embodiments, an NLP composition may comprise at least 0.5%, 1%, 5%, 10%, 15%, 20%, 25%, 30%, 35%, 40%, 45%, 50%, 55%, 60%, 65%, 70%, 75%, 80%, 85%, 90%, or more than 90% non-polar lipid (w/w) of total lipids in the NLP composition. In some embodiments, an NLP composition may comprise at least 0.5%, 1%. 5%, 10%, 15%, 20%, 25%, 30%, 35%, 40%, 45%, 50%, 55%, 60%, 65%, 70%, 75%, 80%, 85%, 90%, or more than 90% phospholipid and non-polar lipid (w/w) of total lipids and oils in the NLP composition. In some embodiments, an NLP composition may comprise one or more non-polar lipids at an amount of 25% to 40% (w/w) of total lipids in the preparation.

In some embodiments, the NLPs comprise one or more essential oils. In some embodiments, the one or more essential oils are selected from the group consisting of cinnamon, cedar, castor, clove, geranium, lemongrass, mint, thyme, turmeric, wintergreen, rosemary, anise, cardamom, chamomile, coriander, cumin, dill, mint, parsley, lavender, basil, camphor, citronella, eucalyptus, fennel, ginger, grapefruit, lemon, mandarin, orange, pine needle, pepper, rose, sweet orange, tangerine, tea tree, tea seed, caraway, garlic, peppermint, onion, and spearmint oil. In some embodiments, an NLP composition may comprise at least 0.5%, 1%. 5%, 10%, 15%, 20%, 25%, 30%, 35%, 40%, 45%, 50%, 55%, 60%, 65%, 70%, 75%, 80%, 85%, 90%, or more than 90% essential oils (w/w) of total lipids and oils in the NLP composition.

In some embodiments, an NLP composition comprises one or more surface modifiers. In some embodiments, an NLP composition comprises one or more surface modifiers selected from a group consisting of a pegylated moiety, pegylated block copolymers (e.g., as a poloxamer), cocamide derivatives, glycolipids, polysacharides, and polysacharides with lipid chains, or any combination thereof. In some embodiments one or more surface modifiers may comprise about 1%. 5%, 10%, 20%, 30%, 40%, 50%, 60%, 70%, 80%, 90%, or more than 90% (w/w) of total lipids and sterols in an NLP composition.

B. Delivery to a plant

Several embodiments relate to methods of delivering an NLP composition and/or a formulation comprising one or more NLP compositions to a plant, e.g., by contacting the plant, a part, or an environment where the plant resides (e.g., soil), with the NLP composition and/or the formulation comprising the NLP composition. In some embodiments, an NLP composition as described herein that are delivered to a plant comprise one or more heterologous functional agents selected from the group consisting of pesticidal agents, antibacterial agents, antifungal agents, nematicides, molluscicides, virucides, herbicides, pest control agents (e.g., repellents), fertilizing agents, and plant-modifying agents.

In some embodiments, the compositions disclosed herein comprise NLPs formulated to promote systemic distribution of an encapsulated functional agent within the plant. As used herein. “systemic distribution” refers to movement of the agent from the site of application (e.g., root, leaf, or stem) to distal plant tissues, including shoots, roots, vascular bundles, meristematic zones, and reproductive structures. Systemic movement may occur via the plant's xy lem and/or phloem, depending on NLP size, surface characteristics, lipid composition, and compatibility with plant transport systems. In some embodiments. NLPs are absorbed through epidermal or endodermal cells and enter the vascular system via plasmodesmata or transporter-assisted mechanisms. In some embodiments, systemicity of a functional agent is enhanced by providing the functional agent to a plant in an NLP composition as described herein wherein the NLP composition has one or more optimized feature selected from; a particle size, preferably less than 200 nm, more preferably 80-150 nm: PDI, preferably below 0.2 for uniform behavior; surface charge, where slightly positive or neutral zeta potential improves cell compatibility: use of ionizable or cationic lipids, such as DODMA, to facilitate intracellular movement: inclusion of sterols, such as cholesterol or phytosterols, which enhance membrane fusion and endosomal escape: PEGylation or surface modifiers, which can modulate vascular retention or movement.

In some embodiments. NLP formulations exhibiting systemicity deliver their cargo from root to shoot, or from foliar application sites to meristems. Encapsulated agents may include small molecules or hydrophobic functional agents.

Several embodiments relate to a method of increasing the fitness of a plant, the method including delivering to the plant an effective amount of one or more NLP compositions as described herein to increase the fitness of the plant relative to an untreated plant (e.g., a plant that has not been delivered the NLP composition). An increase in the fitness of the plant as a consequence of delivery of an NLP composition can manifest in a number of ways, e.g., improved yield (e.g., increased biomass, grain yield, seed yield, fruit yield, protein content, carbohydrate content, oil content, leaf area, etc.), improved vigor of the plant (e.g., improved tolerance of abiotic or biotic stress, improved resistance to pests, improved germination rate, etc.), or improved quality of the harvested product from the plant by a measurable amount over the fitness of a plant without the application of the NLP compositions or compared with application of conventional agricultural agents. In some embodiments, delivering an effective amount of one or more NLP compositions as described herein to a plant can increase yield by at least about 0).5%, about 1%, about 2%, about 3%, about 4%, about 5%, about 10%, about 20%, about 30%, about 40%, about 50%, about 60%, about 70%, about 80%, about 90%, about 100%, or more than 100%. Yield can be expressed in terms of an amount by weight or volume of the plant or a product of the plant on some basis. An increase in the fitness of a plant as a consequence of delivery of a NLP composition can also be measured by other methods, such as an increase or improvement of the vigor rating, the stand (the number of plants per unit of area), plant height, stalk circumference, stalk length, leaf number, leaf size, plant canopy, visual appearance (such as greener leaf color), root rating, emergence, protein content, increased tillering, bigger leaves, more leaves, less dead basal leaves, stronger tillers, less fertilizer needed, less seeds needed, more productive tillers, earlier flowering, early grain or seed maturity, less plant verse (lodging), increased shoot growth, earlier germination, or any combination of these factors, by a measurable or noticeable amount over the same factor of the plant produced under the same conditions, but without the administration of the instant compositions or with application of conventional agricultural agents. In some embodiments, delivering an effective amount of one or more NLP compositions as described herein to a plant introduces or increases a beneficial trait in the plant (e.g., by about 1%. 2%, 5%, 10%, 20%, 30%, 40%, 50%, 60%, 70%, 80%, 90%, 100%, or more than 100%) relative to an untreated plant. In some instances, the increase in plant fitness is an increase (e.g., by about 1%. 2%. 5%, 10%, 20%, 30%, 40%, 50%, 60%, 70%, 80%, 90%, 100%, or more than 100%) in disease resistance, drought tolerance, heat tolerance, cold tolerance, salt tolerance, metal tolerance, herbicide tolerance, chemical tolerance, water use efficiency, nitrogen utilization, resistance to nitrogen stress, nitrogen fixation, pest resistance, herbivore resistance, pathogen resistance, yield, yield underwater-limited conditions, vigor, growth, photosynthetic capability, nutrition, protein content, carbohydrate content, oil content, biomass, shoot length, root length, root architecture, seed weight, or amount of harvestable produce.

Several embodiments relate a method of increasing the fitness of a plant, the method including contacting one or more of a seed, protoplast, embryo, leaf, root, stem, tissue (e.g., meristematic or meristem tissue), of the plant with an effective amount of a NLP composition as disclosed herein, wherein the method increases the fitness of the plant (e.g., by about 1%. 2%, 5%, 10%, 20%, 30%, 40%, 50%, 60%, 70%, 80%, 90%, 100%, or more than 100%) relative to an untreated plant.

Several embodiments relate a method of decreasing the fitness of a plant (e.g., a weed) or a plant part (e.g., reproductive tissue), the method including contacting one or more of a seed, protoplast, embryo, leaf, root, stem, tissue (e.g., meristematic tissue, reproductive tissue), of the plant with an effective amount of an NLP composition comprising one or more herbicides. In cases where an herbicide is included in an NLP compositions, the methods may be further used to decrease the fitness of or kill weeds. In cases where an herbicide is included in an NLP composition provided to a reproductive tissue of a plant, the methods may be further used to prevent pollen production. In some embodiments, the method may be effective to decrease the fitness of the weed by about 2%. 5%, 10%, 20%, 30%, 40%, 50%, 60%, 70%, 80%, 90%, 100%, or more in comparison to an untreated weed (e.g., a weed to which the NLP composition has not been administered). For example, the method may be effective to kill the weed, thereby decreasing a population of the weed by about 2%. 5%, 10%, 20%, 30%, 40%, 50%, 60%, 70%, 80%, 90%. 100%, or more in comparison to an untreated weed. In some instances, the method substantially eliminates the weed. Examples of weeds that can be treated in accordance with the present methods are further described herein. In cases where an herbicide is included in an NLP composition provided to a reproductive tissue of a plant, the methods may be further used to prevent pollen production or germination. In some embodiments, the method may be effective to decrease pollen production by about 2%. 5%, 10%, 20%, 30%, 40%, 50%, 60%, 70%, 80%, 90%, 100%, or more in comparison to an untreated plant (a plant to which the NLP composition has not been administered).

Plant cell uptake of the NLPs can be measured by a variety of methods known in the art. For example, the NLPs, or a component thereof, can be labelled with a marker (e.g., a fluorescent marker) that can be detected in isolated cells to confirm uptake. For example, cell uptake can be detected based on fluorescence intensity in the cell, which can be determined e.g, microscopically, e.g, with a confocal microscope. Uptake can also be determined with measures of fitness, e.g., fitness the plant comprising the treated cell. For instance, efficacy of the present compositions and methods can be determined by comparing fitness changes in plants treated with NLPs comprising a heterologous functional agent, e.g, a herbicidal agent, relative to treatment of plants treated with NLPs not comprising the herbidical agent.

A variety of plants can be contacted with one or more NLP compositions as described herein. An NLP composition as described herein can be provided to a plant according to any method known in the art. In some embodiments, an NLP composition as described herein can be provided to whole plants, plant parts, including, but not limited to, shoot vegetative organs/structures (e.g., leaves, stems and tubers), roots, flowers and floral organs/structures (e.g., bracts, sepals, petals, stamens, carpels, anthers and ovules), seed (including embryo, endosperm, cotyledons, and seed coat) and fruit (the mature ovary), plant tissue (e.g., meristematic tissue, vascular tissue, ground tissue, and the like) and cells (e.g., guard cells, egg cells, and the like), and progeny of same. The class of plants that can be treated in a method or by a NLP composition disclosed herein includes the class of higher and lower plants, including angiosperms (monocoty ledonous and dicoty ledonous plants), gymnosperms, ferns, horsetails, psilophytes, lycophytes, bryophytes, and algae (e.g., multicellular or unicellular algae). Plants that can be treated in accordance with the present methods further include any vascular plant, for example monocotyledons or dicotyledons or gymnosperms, including, but not limited to alfalfa, apple. Arabidopsis, banana, barley, canola, castor bean, chrysanthemum, clover, cocoa, coffee, cotton, cottonseed, corn, crambe, cranberry, crucifers, cucumber, dendrobium, dioscorea, eucalyptus, fescuc, flax, gladiolus, liliacca, linseed, millet, muskmelon, mustard, oat, oil palm, canola or oilseed rape, papaya, peanut, pineapple, ornamental plants. Phaseolus, potato, rapeseed, rice, rye, ryegrass, safflower, sesame, sorghum, soybean, sugarbeet, sugarcane, sunflower, strawberry, tobacco, tomato, turfgrass, wheat, and vegetable crops such as lettuce, celery, broccoli, cauliflower, cucurbits; fruit and nut trees, such as apple, pear, peach, orange, grapefruit, lemon, lime, almond, pecan, walnut, hazel; vines, such as grapes (e.g., a vineyard), kiwi, hops: cannabis, fruit shrubs and brambles, such as raspberry, blackberry, gooseberry: forest trees, such as ash, pine, fir, maple, oak, chestnut, popular; with alfalfa, canola, castor bean, corn, cotton, crambe, flax, linseed, mustard, oil palm, oilseed rape, peanut, potato, rice, safflower, sesame, soybean, sugarbeet, sunflower, tobacco, tomato, and wheat.

Several embodiments relate to methods of providing one or more NLP compositions as described herein to a crop plant. Crop plants include, for example, plants grown for forage, plants grown for oil (e.g., oilseed), plants grown for grain (e.g., wheat, millet, barely, rye, etc.), plants grown for fruit, vegetables, plants grown for fiber, spice crop, plants grown for nuts, plants grown for wood, etc. In certain instances, the crop plant that is treated in the method is a soybean plant. In other certain instances, the crop plant is wheat. In certain instances, the crop plant is corn. In certain instances, the crop plant is cotton. In certain instances, the crop plant is alfalfa. In certain instances, the crop plant is sugarbeet. In certain instances, the crop plant is rice. In certain instances, the crop plant is potato. In certain instances, the crop plant is tomato.

Examples of such crop plants include, but are not limited to, monocoty ledonous and dicotyledonous plants including, but not limited to, fodder or forage legumes, ornamental plants, food crops, trees, or shrubs selected from Acer spp., Allium spp., Amaranthus spp., Ananas comosus, Apium graveolens, Arachis spp. Asparagus officinalis, Beta vulgaris, Brassica spp. (e.g., Brassica napus. Brassica rapa ssp. (canola, oilseed rape, turnip rape). Camellia sinensis, Canna indica, Cannabis sativa, Capsicum spp., Castanea spp., Cichorium endivia. Citrullus lanatus, Citrus spp., Cocos spp., Coffea spp., Coriandrum sativum, Corylus spp., Crataegus spp., Cucurbita spp., Cucumis spp., Daucus carota, Fagus spp., Ficus carica, Fragaria spp., Ginkgo biloba, Glycine spp. (e.g., Glycine max, Soja hispida or Soja max), Gossypium hirsutum, Helianthus spp. (e.g., Helianthus annuus), Hibiscus spp., Hordeum spp. (e.g., Hordeum vuigare), Ipomoca batatas, Juglans spp., Lactuca sativa, Linum usitatissimum, Litchi chinensis, Lotus spp., Luffa acutangula, Lupinus spp., Lycopersicon spp. (e.g., Lycopersicon esculenturn, Lycopersicon lycopersicum, Lycopersicon pyriforme). Malus spp., Medicago sativa, Mentha spp., Miscanthus sinensis, Morns nigra, Musa spp., Nicotiana spp., Olca spp., Oryza spp. (e.g., Oryza sativa, Oryza lati folia), Panicum miliaceum, Panicum virgatum, Passiflora edulis, Petroselinum crispum, Phaseolus spp., Pinus spp., Pistacia vera, Pisum spp., Poa spp., Populus spp., Prunus spp., Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis spp., Solanum spp. (e.g., Solanum tuberosum, Solarium integrifolium or Solarium lycopersicum), Sorghum bicolor, Sorghum halepense, Spinacia spp., Tamarindus indica, Theobroma cacao, Trifolium spp., Triticosecale rimpaui, Triticum spp. (e.g., Triticum aestivum, Triticum durum, Triticum turgidum, Triticum hybernum, Triticum macha, Triticum sativum or Triticum vuigare), Vaccinium spp., Vicia spp., Vigna spp., Viola odorata, Vitis spp., and Zea mays. In certain embodiments, the crop plant is rice, oilseed rape, canola, soy bean, corn (maize), cotton, sugarcane, alfalfa, sorghum, or wheat.

In certain instance, the compositions and methods can be used to treat post-harvest plants or plant parts, food, or feed products. In some instances, the food or feed product is a non-plant food or feed product (e.g., a product edible for humans, veterinary animals, or livestock (e.g., mushrooms)).

Several embodiments relate to a methods and compositions for decreasing the fitness of or killing weeds. In some embodiments an NLP composition comprising one or more herbicidal agents is used to decrease the fitness of or kill weeds. In some embodiments, an NLP composition comprising one or more herbicidal agents decreases the fitness of a weed by about 2%. 5%, 10%, 20%, 30%, 40%, 50%, 60%, 70%, 80%, 90%. 100%, or more in comparison to an untreated weed (e.g., a weed to which the NLP composition has not been administered). In some embodiments, an NLP composition comprising one or more herbicidal agents is used to decrease the population of a weed in a treated area by about 2%. 5%, 10%, 20%, 30%, 40%, 50%, 60%, 70%, 80%, 90%, or more in comparison to an untreated area. In some embodiments an NLP composition comprising one or more herbicidal agents is applied to control monocoty ledonous weeds (e.g., Agrostis, Alopecurus, Avena, Bromus. Cyperus. Digitaria. Echinochloa. Lolium. Monochoria. Rottboellia. Sagittaria. Scirpus. Sctaria. Sida or Sorghum) or dicotyledonous weeds (e.g., Abutilon. Amaranthus. Chenopodium. Chrysanthemum. Conyza. Galium. Ipomoca. Nasturtium. Sinapis. Solanum. Stellaria. Veronica. Viola or Xanthium). In some embodiments an NLP composition comprising one or more herbicidal agents is applied to control Lolium rigidum. Amaramthus palmeri. Abutilon theopratsi. Sorghum halepense. Conyza Canadensis. Setaria verticillata. Capsella pastoris, and Cyperus rotundas.

A plant or plant part that may be contacted with an NLP composition as described herein includes plants of any stage of plant development. In certain instances, the delivery can occur during the stages of germination, seedling growth, vegetative growth, and reproductive growth. In certain instances, delivery to the plant occurs during vegetative and reproductive growth stages. Alternatively, the delivery can occur to a seed. The stages of vegetative and reproductive growth are also referred to herein as “adult” or “mature” plants.

### C. Delivery to a Plant Pest

Several embodiments relate to methods and compositions for controlling a plant pest. In some embodiments, a plant pest is contacted with an NLP composition comprising a heterologous functional agent, such as a pesticidal agent (e.g., antibacterial agents, antifungal agents, nematicides, molluscicides, virucides, herbicides, etc.) or a pest control agent (e.g., repellents). Several embodiments relate to methods and compositions for decreasing the fitness of a pest, e.g., to prevent or treat a pest infestation as a consequence of delivery of an NLP composition.

Several embodiments relate to methods and compositions for decreasing a fungal infection in a plant having a fungal infection. In some embodiments a plant is contacted with an NLP composition comprising one or more antifungal agents. In some instances, the antifungal agent is a nucleic acid that inhibits expression of a gene (e.g., dell and dcl2 (e.g., dcH/2) in a fungus that causes the fungal infection. In some instances, the fungal infection is caused by a fungus belonging to a Sclerotinia spp. (e.g., Sclerotinia sclerotiorum), a Botrytis spp. (e.g., Botrytis cinerea), an Aspergillus spp.., a Fusarium spp. or a Penicillium spp. In some embodiments, an NLP composition comprising one or more antifungal agents is applied to prevent of treat a fungal disease selected from the group consisting of; White rust (Albugo candida), downy mildew, powdery mildew. Clubroot (Plasmodiophora brassicae). Pythium species. Sclerotinia rot (e.g., S, sclerotiorum. S, minor), Sclerotium rot (e.g., Sclerotium rolfsii. S, cepivorum). Fusarium wilts and rots (various Fusarium species including F, solani and F, oxysporum). Botrytis rots (e.g., Botrytis cinerea). Anthracnose. Rhizoctonia rots (Rhizoctonia solani). Pythium. Rhizoctonia. Phytophthora. Fusarium. Aphanomyces. Pythium sulcatum, Alternaria solani, leaf rust. Fusarium head blight. Septoria leaf blotch, stripe rust, spot blotch, and tan spot. In some instances, the method decreases or substantially eliminates the fungal infection.

Several embodiments relate to methods and compositions for decreasing a bacterial infection in a plant having a bacterial infection. In some embodiments, a plant is contacted with an NLP composition comprising one or more antibacterial agents. In some instances, the antibacterial agent is streptomycin. In some instances, the bacterial infection is caused by a bacterium belonging to a Pseudomonas spp. (e.g., Pseudomonas syringae). In some instances, the antibacterial agent is Oxytetracycline (OTC). In some instances, the bacterial infection causes Huanglongbing. In some instances, the antibacterial agent is selected from the group consisting of: amoxicillin, enrofloxacin, chloramphenicol, penicillin, oxytetracycline, quinolone, sulfonamides, sulphamethazine, sulfadimidine, sulfamethoxazole, and tetracycline. In some embodiments, an NLP composition comprising one or more antibacterial agents is applied to prevent or treat a bacterial disease caused by a bacterial pathogen selected from the group consisting of: Actinobacteria. Agrobacterium (e.g., Agrobacterium tumefaciens). Burkholderiaceac. Candidatus Liberibacter asiaticus. Clavibacter (e.g., Clavibacter michiganensis. Clavibacter sepedonicus). Corynebacterium, Dickeya (e.g., Dickeya dadantii. Dickeya solani). Erwinia (e.g., Erwinia amylovora. E, carotovora). Enterobacteriaceae. Microbacteriaceae. Pectobacterium (e.g., Pectobacterium carotovorum. Pectobacterium atrosepticum). Pseudomonas (e.g., Pseudomonas syringae. Pseudomonas savastanoi), Proteobacteria, Rhizobiaccac. Ralstonia solanaccarum. Streptomyces. Xanthomonas (e.g., Xanthomonas axonopodis. Xanthomonas campestris. Xanthomonas oryzae), and Xylella (e.g., Xylella fastidiosa). In some instances, the method decreases or substantially eliminates the bacterial infection.

Several embodiments relate to methods and compositions for decreasing the fitness of an insect plant pest. In some embodiments, an insect plant pest is contacted with an NLP composition comprising one or more insecticidal agents. In some embodiments, the plant is contacted with the NLP, which then delivers the insecticide to the insect pest, e.g, upon ingestion of the plant by the insect pest. In some instances, the insecticidal agent is a peptide nucleic acid. In some instances, the insecticidal agent is an insecticidal peptide. In some instances, the insect plant pest is an aphid. In some instances, the insect plant pest is a lepidopteran (e.g., Spodoptera frugiperda). In some instances, the insect plant pest is an arachnid, e.g., a mite. In some embodiments, an NLP composition comprising one or more insecticidal agents is provided to an insect pest selected from the group consisting of: asian citrus psyllid, asian loghorn beetle, emerald ash borer, grasshopper, false codling moth, fall army worm, stinkbug, cotton bollworm, tobacco whitefly, diamondback moth, red flour beetle, green peach aphid, cotton aphid, taro caterpillar. thrips, flea beetle. Colorado potato beetle, corn rootworm, tomato hornworn, weevils, and brown planthopper. In some instances, the method decreases the fitness of the insect plant pest relative to an untreated insect plant pest

Several embodiments relate to methods and compositions for decreasing the fitness of a nematode plant pest. In some embodiments, the nematode plant pest is contacted with an NLP composition comprising a nematicidal agent. In some embodiments, a plant at risk of or having a nematode infestation is contacted with the NLP composition comprising a nematicidal agent. In some instances, the nematicidal agent is a neuropeptide (e.g., Mi-NLP-15b). In some instances, the nematode plant pest is a root-knot nematode. In some embodiments, an NLP composition comprising one or more nematicidal agents is provided to a nematode pest selected from the group consisting of: root-knot nematodes (e.g., Meloidogyne spp.), cyst nematodes (e.g., Heterodera and Globodera spp.), root lesion nematodes (e.g., Pratylenchus spp.). Radopholus similis. Ditylenchus dipsaci, pine wilt nematode (e.g., Bursaphelenchus xylophilus), reniform nematode (e.g., Rotylenchulus reniformis). Xiphinema index. Nacobbus aberrans, and Aphelenchoides besseyi. In some instances, the method decreases the fitness of the nematode plant pest relative to an untreated nematode plant pest.

Several embodiments relate to methods and compositions for decreasing the fitness of a weed. In some embodiments, the weed is contacted with an NLP composition comprising an herbicidal agent (e.g. Glufosinate). In some instances, the weed is an Indian goosegrass. In some instances, an NLP composition comprises an agent (e.g., an RNAi agent targeting 5-enolpyruvylshikimate-3-phosphate (EPSP) synthase) that increases the sensitivity of a weed to an herbicide relative to an untreated weed. In some embodiments, an NLP composition comprising one or more herbicidal agents (and/or an agent that increases the sensitivity of a weed to an herbicide) is provided to a weed selected from the group consisting of: dandelion, yellow nutsedge, field horsetail, horsenettle, kochia, thistle, marestail, morningglories, prairie cupgrass, pokeweed, powell amaranth, quackgrass, ragweed, nutsedge, wild buckwheat, dayflower species, pigweed (Palmer amaranth), waterhemp, vetch, and volunteer plants.

Several embodiments relate to methods and compositions for decreasing the fitness of a mollusk. In some embodiments, the mollusk is contacted with an NLP composition comprising an active agent that decreases the fitness of a mollusk. In some embodiments, an NLP composition as described herein is delivered to a mollusk by contacting the mollusk with the NLP composition. In some embodiments, an NLP composition as described herein is delivered to a plant at risk of or having a mollusk infestation. In some embodiments, an NLP composition comprising one or more active agents that decrease the fitness of a mollusk is provided to a mollusk selected from the group consisting of: Achatinidac. Agriolimacidac. Ampullariidac. Arionidae. Brady baenidae, Helicidac. Hydromiidac. Lymnacidae. Milacidac. Urocyclidac, and Veronicellidac.

Several embodiments relate to methods and compositions effective to decrease the ability of a pest to carry or transmit a plant pathogen (e.g., plant virus (e.g., TYLCV) or a plant bacterium (e.g., Agrobacterium spp.)) in comparison to a pest to which the NLP composition has not been administered. Methods and compositions provided herein may be effective to decrease the pest's ability to carry or transmit a plant pathogen (e.g., a plant virus (e.g., TYLCV) or plant bacterium (e.g., Agrobacterium spp.)) by about 2%. 5%, 10%, 20%, 30%, 40%, 50%, 60%, 70%, 80%, 90%. 100%, or greater than 100% relative to a reference level (e.g., a level found in a pest that does not receive a NLP composition).

### D. Delivery to a Plant Microorganism

Several embodiments relate to methods and compositions for increasing the fitness of plant microorganism, e.g., a symbiont that is beneficial to the fitness of a plant (e.g., a bacterial endosymbiont, a fungal endosymbiont, an insect pollinator, etc.). In some embodiments, a plant or plant symbiont is contacted with an NLP composition comprising a heterologous functional agent that increases the fitness of the microorganism (e.g., fertilizing agent, nutritional supplement, etc.) relative to an untreated microorganism (e.g., a microbial symbiont that has not been delivered the NLP composition). In one aspect, an endosymbiont is contacted with an NLP composition as described herein comprising a heterologous functional agent that increases the fitness of the symbiont relative to an untreated endosymbiont. In some instances, the methods or compositions provided herein may be effective to increase the symbiont's resistance to parasites or pathogens (e.g., fungal, bacterial, or viral pathogens: or parasitic mites (e.g., Varroa destructor mite in honey bees)) in comparison to a symbiont organism to which the NLP composition has not been administered. In some instances, the methods or compositions provided herein may be effective to increase the symbiont's resistance to a pathogen or parasite (e.g., fungal, bacterial, or viral pathogens: or parasitic mites (e.g., Varroa destructor mite in honey bees)) by about 2%. 5%, 10%, 20%, 30%, 40%, 50%, 60%, 70%, 80%, 90%. 100%, or greater than 100% relative to a reference level (e.g., a level found in a symbiont that does not receive a NLP composition). In some embodiments, a plant symbiont treated with an NLP composition as described herein may be an endosymbiotic fungus. Examplary endosymbiotic fungal species are disclosed in PCT/US2024/015064, which is incorporated herein in its entirety.

Several embodiments relate to methods and compositions for increasing the fitness of an insect (e.g., an insect symbiont of a plant) that is beneficial to a plant. In some embodiments, a beneficial insect is contacted with an NLP composition comprising a heterologous functional agent that increases the fitness of the beneficial insect compared to an untreated insect. For example, the host may include insects that are used in agricultural applications, including insects that aid in the pollination of crops, spreading seeds, or pest control. In some instances, the insect is a plant pollinator. For example, the insect may be of the genus Hymenoptera or Diptera. In some instances, the insect of the genus Hymenoptera is a bee. In other instances, the insect of the genus Diptera is a fly.

### E. Delivery to a Pathogen Vector

Several embodiments relate to methods and compositions for decreasing the fitness of a pathogen vector. In some embodiments, an NLP composition comprising one or more heterologous functional agents to a pathogen vector. As used herein, the term “vector” refers to an organism (e.g., an insect) that can carry or transmit an animal pathogen from a reservoir to an animal. Examples of vectors include insects, such as those with piercing-sucking mouthparts, as found in Hemiptera and some Hymenoptera and Diptera such as mosquitoes, bees, wasps, midges, lice, tsetse fly, fleas and ants, as well as members of the Arachnidae such as ticks and mites. In some instances, the vector of the animal pathogen may be treated with an NLP composition comprising a heterologous therapeutic agent (e.g., antibacterial agent, antifungal agent, insecticide, nematicide, antiparasitic agent, antiviral agent, or a repellent). In some embodiments, an NLP composition comprising a heterologous functional agent is provided to decrease the fitness of a pathogen vector, e.g., to control the spread of a pathogen. For example, provided herein is a method of decreasing the fitness of an animal pathogen vector, the method including delivering to the vector an effective amount of an NLP composition as described herein, wherein the method decreases the fitness of the vector relative to an untreated vector.

### F. Application Methods

In some embodiments, the NLP composition is applied to the plant, soil, insect, fungus or seed to deliver a hydrophobic functional agent for insecticidal, fungicidal, or plant growth regulatory purposes. The NLP facilitates translocation of the agent across plant barriers or pest cuticle and may improve retention or systemic movement within the plant.

A plant described herein can be contacted with an effective amount of an NLP composition in any suitable manner that permits delivering or administering the composition to the plant. An NLP composition may be delivered either alone or in combination with other active (e.g., fertilizing agents) or inactive substances and may be applied by, for example, spraying, injection (e.g., microinjection), dipping, providing to the soil, etc. An NLP composition may be provided in the form of concentrated liquids, gels, solutions, suspensions, sprays, powders, pellets, briquettes, bricks and the like, formulated to deliver an effective concentration of the NLP composition. Amounts and locations for application of NLP compositions as described herein are generally determined by the habitat of the plant, the lifecycle stage at which the plant can be targeted by the NLP composition, the site where the application is to be made, and the physical and functional characteristics of the NLP composition.

In some instances, an NLP composition is sprayed directly onto a plant e.g., crops, by e.g., backpack spraying, aerial spraying, crop spraying/dusting etc. In instances where the NLP composition is delivered to a plant, the plant receiving the NLP composition may be at any stage of plant growth. For example, formulated NLP compositions can be applied as a seed-coating or root treatment in early stages of plant growth or as a total plant treatment at later stages of the crop cycle. In some instances, the NLP composition may be applied as a topical agent to a plant. In some instances, the NLP composition may be applied in the soil in which a plant grows. In some instances, the NLP composition may be applied in the water that is used to water the plant. In some instances, the NLP composition may be applied as a systemic agent that is absorbed and distributed through the tissues of a plant.

In some embodiments, delayed or continuous release of an NLP composition can be accomplished by coating the NLP composition with a dissolvable or biodegradable coating layer, such as gelatin, which coating dissolves or erodes in the environment of use, to then make the NLP composition available, or by dispersing the agent in a dissolvable or erodable matrix. Such continuous release and/or dispensing devices may be advantageously employed to consistently maintain an effective concentration of one or more of the NLP compositions described herein.

In some embodiments, an NLP composition is delivered to a part of the plant, e.g., a leaf, seed, pollen, root, fruit, shoot, or flower, or a tissue, cell, or protoplast thereof. In some instances, the NLP composition is delivered to a cell of the plant. In some instances, the NLP composition is delivered to a protoplast of the plant. In some instances, the NLP composition is delivered to a tissue of the plant. For example, the composition may be delivered to meristematic tissue of the plant (e.g., apical meristem, lateral meristem, or intercalary meristem). In some instances, the composition is delivered to reproductive tissue of the plant (e.g., pollen, egg, ovary, etc.). In some instances, the composition is delivered to a plant embryo. In some instances, the composition is delivered to a seed.

In certain embodiments, the method of delivery comprises precision delivery (also referred to as “precision injection”) of a formulation into a plant, e.g, a citrus plant. Precision delivery refers to delivering the formulation only or substantially only into a target location in the plant. For example, in some embodiments, the target location is the active vasculature of the plant. In certain embodiments, the method comprises injecting an injection formulation into and no further than the active vasculature of the plant. In some embodiments, the composition enters the active vasculature and is transported throughout the plant. In some variations, the active vasculature of the plant is the xylem and/or the phloem. In one variation, the active vasculature is active xylem (such as sapstream) and phloem. In further embodiments, precision delivery involves delivering the formulation into the active vasculature of the plant while minimizing damage to the plant relative to traditional forms of injection drilling systems. In yet other embodiments, precision delivery involves using a system that can be configured to deliver formulation into and no further than the active vasculature of a plant. Exemplary injection technologies are disclosed in WO2020021041, which is incorporated in its entirety herein.

In some instances, an NLP composition may be recommended for field application as an amount of NLPs per hectare (g/ha or kg/ha) or the amount of active ingredient (e.g., NLP with a heterologous functional agent) per hectare (g/ha or kg/ha). In some instances, a lower amount of heterologous functional agent comprised in an NLP composition may be required to be applied to soil, plant media, seeds plant tissue, or plants to achieve the same results as where the heterologous functional agent is not comprised in an NLP composition. For example, the amount of heterologous functional agent comprised in an NLP composition may be applied at levels about 2, 3, 4, 5, 6, 7, 8, 9, 10, 15, 20, 30, 50, or 100-fold (or any range between about 2 and about 100-fold, for example about 2- to 10-fold: about 5- to 15-fold, about 10- to 20-fold: about 10- to 50-fold) less than the same heterologous functional agent applied in a non-NLP composition, e.g., direct application of the same heterologous functional agent without NLPs. NLP compositions as described herein can be applied at a variety of amounts per hectare, for example at about 0.0001, 0.001, 0.005, 0.01, 0.1, 1. 2, 10, 100, 1.000, 2.000, 5.000 (or any range between about 0.0001 and 5.000) kg/ha. For example, about 0.0001 to about 0.01, about 0.01 to about 10, about 10 to about 1.000, about 1.000 to about 5.000 kg/ha.

### EXAMPLES

The following are examples of the methods of the invention. It is understood that various other embodiments may be practiced, given the general description provided above.

### Example 1. NLP Compositions Comprising Chlorantraniliprole (CTPR)

This Example describes the preparation of NLP compositions comprising an insecticide chlorantraniliprole (CTPR).

### Experimental Procedure:

1) NLP constituents

Table 2 summarizes the constituents used to prepare NLPs compositions described in the Examples herein.

2) Determination of CTPR solubility in essential oils

Chlorantraniliprole (CTPR) is a hydrophobic insecticide. The solubility of CTPR in a variety of essential oils was determined by adding CTPR at a 2 mg/ml concentration. The concentration of dissolved CTPR in oil was subsequently determined by RP-HPLC, by reference to a CTPR standard (Table 3).

3) Preparation of NLPs comprising CTPR

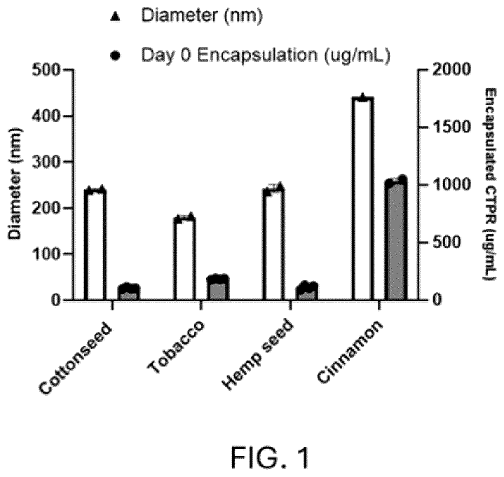

A first set of NLP compositions were prepared using methods described in Example 5, producing NLPs comprising CTPR as the bioactive, and either cotton seed oil as the non-polar lipid or one of the following essential oils: tobacco oil, hemp seed oil or cinnamon oil. The particle size diameter and encapsulation efficiency were determined and are compared in FIG. 1. Based on the results obtained, cinnamon oil (Cin) was selected for the preparation of a second batch of NLPs, comprising either pure cinnamon oil, a cinnamon oil-sunflower oil blend, or pure sunflower oil, in combination with a variety of different surface modifiers (Table 4).

4) Determination of physicochemical parameters (zeta potential, size, polydispersity)

Particle size, polydispersity index (PDI) and zeta potential were measured using a Malvern Panalytical Zetasizer Ultra Red Label (Table 4)
5) Determination of encapsulation efficiency

The NLP solution was mixed with acetonitrile such that the final concentration of the CTPR was between 0.5 to 500 μg/mL. The mixture was thoroughly shaken in a vortex, spun down at 14.500 g for 15 min, and the supernatant was used to measure the concentration of the CTPR by RP-HPLC relative to a CTPR standard. The encapsulation efficiency was calculated using the following formula: (100*amount of CTPR in NLP as measured by HPLC)/amount of CTPR that was used to make the NLP (Table 4).

6) Correlation analysis

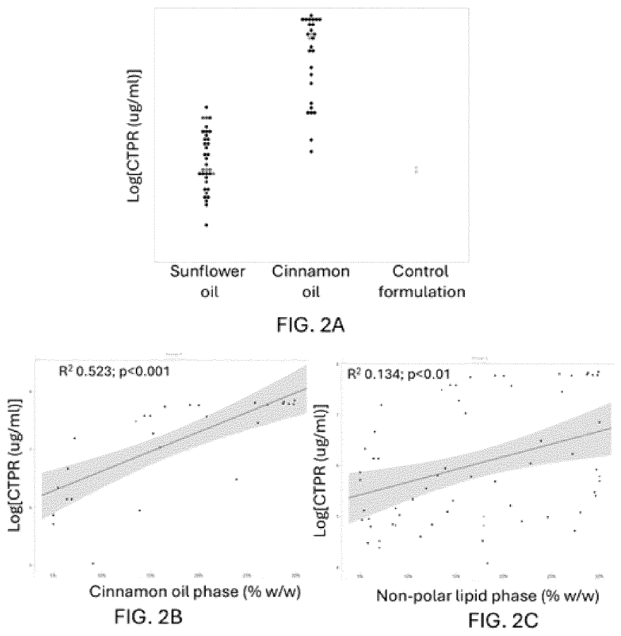

Correlation between NLP particle composition and CTPR encapsulation efficiency carried out with JMP software. FIG. 2A shows that on average the NLPs comprising cinnamon oil encapsulated CTPR more efficiently than particles not comprising cinnamon oil. FIG. 2B and FIG. 2C show that there is a positive correlation between the amount of cinnamon oil comprised in the NLP particle and the amount of CTPR encapsulated, as a measure for the encapsulation efficiency (R² 0.523, p<0.001).

TABLE 2
NLP constituents

| | |
|---|---|
| Non-polar | Sunflower oil |
| lipid (NP) | Soybean oil |
| Essential | Cinamon oil |
| oil (EO) | Spearmint oil |
| | Thyme oil |
| | Tobacco oil |
| | Hemp seed oil |
| Polar lipid | Soybean lecithin (de-oiled) |
| (PL) | Sunflower lecithin (de-oiled) |
| | Emulfluid |
| | Cotton seed oil |
| Surface | JEFFSPERSE ® X3202 |
| modifier (SM) | Atlox ™ 500L |
| | Atlox ™ 550S |
| | Atlox ™ AL2575 |
| | Atlox ™ CS100B |
| | NINEX ® MT-615 |
| | STEP-FLOW ® 1500 |
| | STEP-FLOW ® 4000 |
| | BIO-SOFT ® N91-8 |
| | BIO-SOFT ® N-411 |
| | Sugarbeet pectin |
| | CRODESTA ™ F160-PW-(JP) |
| | Rhamnolipid (Deguan) |
| | Sophoro lipid (SLM) |
| | STEPFAC ™ TSP-PE K |
| | AMMONYX ® CETAC-30 |
| | Pluronic ® F127 |
| Cargo | CTPR |
| | DCM (dye) |
| | Permethrin |
| | Permethrin + DCM |

TABLE 3
Comparison of the solubility of CTPR in essential oils^{a}

| | CTPR solubility normalized |
|---|---|
| Oil/Solvent | (2000 ug/ml) at 24 h |
| Tea Tree Oil | 2461.31686 |
| Cinnamon oil | 2061.29785 |
| Clove essential oil | 2037.47049 |
| Eucalyptus oil | 1782.2525 |
| Hemp seed | 1777.20234 |
| Patchouli oil | 1754.67591 |
| Marjoram Oil | 1746.08028 |
| Thyme oil | 1714.88901 |
| Sweet almond oil | 1682.13328 |
| Cassia Oil | 1650.72576 |
| Lavendar Essential Oil | 1575.02617 |
| Neem oil | 1455.95715 |
| Basil oil | 1440.59604 |
| Castor oil | 1262.88569 |
| Pumpkin seed oil | 1261.31378 |
| Citronella oil | 1232.49794 |
| Cumin | 1162.25844 |
| Amaranth | 1149.9737 |
| Camphor oil | 1133.95846 |
| Red Raspberry Oil | 1128.82293 |
| Peanut | 1103.99914 |
| Pine Oil | 1005.25772 |
| Tobacco Oil | 990.64713 |
| Carrot seed Oil | 990.49322 |

^{a}Determined by RP-HPLC.

TABLE 4
Compositions of CTPR-comprising NLPs^{e}

| | | | | NP:PL:SM | CTPR | Zeta | Diameter |
|---|---|---|---|---|---|---|---|
| NLP# | Np^{a} | PL^{b} | SM | Ratio | EE (%)^{c} | potential | (nm) |
| NLP833 | SF | SB Lec | JEFFSPERSE ® | 53:34:13 | 10.1 | −32.93 | 149.6 |
| NLP834 | Cin | SB Lec | JEFFSPERSE ® | 62:17:21 | 100 | −29.13 | 128.6 |
| NLP835 | SF | SB Lec | Atlox ™ 500L | 41:31:28 | 16.5 | −52.96 | 183 |
| NLP836 | SF | SB Lec | JEFFSPERSE ® | 29:40:31 | 8.3 | −34.22 | 121.2 |
| NLP837 | SF | SB Lec | Atlox ™ 500L | 70:05:25 | 6.2 | −51.64 | 283.2 |
| NLP838 | SF | SB Lec | JEFFSPERSE ® | 27:33:40 | 6.9 | −32.97 | 199.3 |
| NLP839 | SF | SB Lec | Atlox ™ 500L | 81.3:18.4:0.3 | 11.15 | −49.37 | 325.1 |
| NLP840 | SF | SF Lec | JEFFSPERSE ® | 28:40:32 | 6.1 | −22.75 | 179.7 |
| NLP842 | SF | SF Lec | JEFFSPERSE ® | 54:32:14 | 4.55 | −29.26 | 172.8 |
| NLP843 | SF | SB Lec | Atlox ™ 500L | 57:23:20 | 12.8 | −50.69 | 235.7 |
| NLP844 | Cin | SF Lec | JEFFSPERSE ® | 66:19:15 | 100 | −24.82 | 171.1 |
| NLP845 | SF | SF Lec | JEFFSPERSE ® | 50:48:02 | 8.7 | −32.03 | 141.8 |
| NLP846 | SF | SB Lec | JEFFSPERSE ® | 84:04:12 | 7.35 | −22.78 | 248.9 |
| NLP847 | SF | SB Lec | JEFFSPERSE ® | 73:16:11 | 6.75 | −35.83 | 175.7 |
| NLP848 | SF | SF Lec | Atlox ™ 500L | 86:09:05 | 9.6 | −50.67 | 311.7 |
| NLP849 | Cin | SF Lec | JEFFSPERSE ® | 53:27:20 | 100 | −21.73 | 161.9 |
| NLP850 | SF | SF Lec | JEFFSPERSE ® | 45:15:40 | 5 | −18.55 | 158.9 |
| NLP851 | Cin | SB Lec | JEFFSPERSE ® | 70:28:02 | 88.65 | −46.63 | 161.5 |
| NLP852 | Cin | SF Lec | JEFFSPERSE ® | 92:05:03 | 100 | −24.79 | 203.2 |
| NLP853 | Cin | SB Lec | Atlox ™ 500L | 33:51:16 | 23.2 | −93.6 | 122.5 |
| NLP854 | Cin | SF Lec | Atlox ™ 500L | 68:07:25 | 86.25 | −54.2 | 413.3 |
| NLP855 | Cin | SB Lec | Atlox ™ 500L | 56:24:20 | 97.9 | −66.37 | 161.2 |
| NLP857 | Cin | SB Lec | Atlox ™ 500L | 82:16:02 | 17.55 | −45.55 | 82.22 |
| NLP858 | Cin | SB Lec | Atlox ™ 500L | 37:18:45 | 15.1 | −45.41 | 2981 |
| NLP860 | SF | SB Lec | Atlox ™ 500L | 55:42:03 | 6.3 | −46.08 | 219.9 |
| NLP861 | SF | SB Lec | JEFFSPERSE ® | 80:17:03 | 4.4 | −47.21 | 250.5 |
| NLP862 | SF | SF Lec | JEFFSPERSE ® | 70:17:13 | 14.8 | −22.39 | 178.3 |
| NLP865 | SF | SB Lec | Atlox ™ 500L | 72:13:15 | 14.75 | −52.98 | 280.7 |
| NLP866 | SF | SF Lec | Atlox ™ 500L | 35:41:24 | 6.35 | −51.01 | 176.1 |
| NLP867 | Cin | SB Lec | Atlox ™ 500L | 32:10:58 | 28.15 | −72.51 | 188.9 |
| NLP868 | Cin | SF Lec | JEFFSPERSE ® | 58:05:37 | 97.7 | −11.69 | 83.25 |
| NLP869 | Cin | SB Lec | Atlox ™ 500L | 82.7:16.8:0.5 | 72.15 | −55.91 | 69.73 |
| NLP870 | Cin | SF Lec | Atlox ™ 500L | 71:27:01 | 100 | −33.97 | 187 |
| NLP871 | SF | SF Lec | JEFFSPERSE ® | 49:22:29 | 16.15 | −19.1 | 137.4 |
| NLP872 | SF | SF Lec | Atlox ™ 500L | 92.3:7.3:0.4 | 20.95 | −45.78 | 798 |
| NLP873 | Cin | SB Lec | Atlox ™ 500L | 70:04:26 | 32.6 | −66.12 | 200.6 |
| NLP874 | SF | SB Lec | JEFFSPERSE ® | 67:11:22 | 5.6 | −21.28 | 227.9 |
| NLP875 | SF | SF Lec | Atlox ™ 500L | 31:24:45 | 7.05 | −47.86 | 183 |
| NLP876 | Cin | SF Lec | Atlox ™ 500L | 88:06:06 | 19.05 | −52.64 | 182.4 |
| NLP877 | SF | SF Lec | Atlox ™ 500L | 63:19:18 | 11.95 | −53.29 | 241.3 |
| NLP878 | Cin | SF Lec | Atlox ™ 500L | 59:26:15 | 56.35 | −51.63 | 61.08 |
| NLP879 | SF | SF Lec | Atlox ™ 500L | 56:15:29 | 2.95 | −53.42 | 264.8 |
| NLP880 | SF | SB Lec | JEFFSPERSE ® | 73:03:24 | 18.65 | −12.88 | 188.4 |
| NLP881 | SF | SF Lec | Atlox ™ 500L | 82:15:03 | 8 | −62.83 | 295.6 |
| NLP882 | SF | SB Lec | Atlox ™ 500L | 39:26:35 | 10.35 | −53.69 | 215.1 |
| NLP883 | Cin | SF Lec | Atlox ™ 500L | 59:07:34 | 7.65 | −63.96 | 293.2 |
| NLP884 | Cin | SB Lec | JEFFSPERSE ® | 73:24:03 | 100 | −41.58 | 168.5 |
| NLP885 | SF | SB Lec | JEFFSPERSE ® | 69.5:29.9:07 | 9.2 | −44.88 | 185.2 |
| NLP886 | Cin | SF Lec | Atlox ™ 500L | 51.2:48:0.8 | 39.1 | −30.1 | 107.1 |
| NLP887 | SF | SB Lec | JEFFSPERSE ® | 96.5:3.2:0.3 | 46.95 | −47.77 | 980.1 |
| NLP888 | Cin | SB Lec | JEFFSPERSE ® | 46:09:45 | 66.25 | −9.137 | 91.74 |
| NLP889 | SF | SF Lec | Atlox ™ 500L | 87:06:07 | 25.2 | −53.77 | 308.1 |
| NLP890 | Cin | SB Lec | JEFFSPERSE ® | 82:07:11 | 100 | −23.57 | 216.2 |
| NLP891 | Cin | SF Lec | JEFFSPERSE ® | 74:11:15 | 100 | −19.93 | 171 |
| NLP892 | Cin | SB Lec | Atlox ™ 500L | 67:22:11 | 100 | −72.71 | 444.6 |
| NLP893 | Cin | SF Lec | JEFFSPERSE ® | 27:36:37 | 23.15 | −19.98 | 106.4 |
| NLP895 | SF | SF Lec | JEFFSPERSE ® | 70.1:29.5:0.4 | 4.6 | −31.03 | 315.8 |
| NLP896 | Cin | SB Lec | JEFFSPERSE ® | 62:17:21 | 100 | −25.98 | 85.82 |
| NLP898 | SF | SF Lec | Atlox ™ 500L | 86:09:05 | 9.2 | −50.88 | 303.5 |
| NLP899 | SF | SF Lec | JEFFSPERSE ® | 66:18:16 | 8.15 | −28.8 | 200.6 |
| NLP901 | Cin | SF Lec | Atlox ™ 500L | 63:20:17 | 96.6 | −55.02 | 69.81 |

^{a}SF, sunflower; Cin, cinnamon
^{b}SB lec, soybean lecithin; SF lec, sunflower lecithin
^{c}Determined by RP-HPLC relative to a CTPR standard. Input for all the formulations was 2 mg/ml of CTPR

### Example 2. NLP Compositions Comprising a Fluorescent Dye (DCM)

This Example describes the preparation of NLP compositions comprising a fluorescent dye DCM (4-(Dicyanomethylene)-2-methyl-6-(4-dimethylaminostyryl)-4 H-pyran). NLP compositions comprising DCM were produced with sonication and high pressure homogenization methods described in Example 5. The composition and physicochemical characteristics of NLPs produced are summarized in Table 5.

TABLE 5
Compositions of DCM-comprising NLPs used to study corn root uptake and distribution

| | NP, EO, | | | | | | | | |
|---|---|---|---|---|---|---|---|---|---|
| | or NP-EO | | | | DCM | Zeta | Diameter | | Plant |
| NLP# | blend^{a} | PL/Emulsifier^{b} | SM | Ratio | (ug/ml)^{c} | potential | (nm) | PDI | Uptake^{d} |
| NLP1052 | SF^{a} | Emulfluid ™ | — | 96.8:3.2:0.0 | 600 | −48.12 | 388 | 0.3731 | 10/12 |
| NLP1053 | SF | Emulfluid ™ | Atlox ™ AL 2575 | 66.7:11.1:22.2 | 600 | −50.97 | 99.65 | 0.2873 | 0/12 |
| NLP1054 | SF | SF Lec | Atlox ™ CS100B | 73.2:12.2:14.6 | 600 | −54.2 | 277.9 | 0.4243 | 10/12 |
| NLP1055 | SF | Pluronic ® F127 | — | 89.5:10.5:0.0 | 440 | −17.36 | 199 | 0.1187 | 0/12 |
| NLP1056 | SF | SF Lec | STEP-FLOW ® 4000 | 66.7:6.7:26.7 | 200 | −27.45 | 220 | 0.1605 | 0/12 |
| NLP1057 | SF-SM^{a} | Pluronic ® ® F127 | BIO-SOFT ® N91-8 | 45.0:5.0:50.0 | 280 | −21.26 | 139.1 | 0.2359 | 0/12 |
| NLP1058 | SF-TM^{a} | SF Lec | BIO-SOFT ® N-411 | 6.9:2.0:91.1 | 400 | −51.43 | 190.1 | 0.04878 | 0/12 |
| NLP1059 | SF-SM | Emulfluid ™ | Atlox ™ AL 2575 | 75.0:4.2:20.8 | 560 | −38.34 | 150.2 | 0.2839 | 0/12 |
| NLP1060 | SF-TM | SF Lec | BIO-SOFT ® N91-8 | 60.0:3.6:36.4 | 880 | −25.99 | 229.4 | 0.1237 | 0/12 |
| NLP1061 | SF-TM | Pluronic ® F127 | sugar beet pectin | 42.9:28.6:28.6 | 400 | −19.41 | 157.3 | 0.2997 | 0/12 |
| NLP1062 | SF-SM | Emulfluid ™ | STEP-FLOW ® 1500 | 64.3:3.2:32.5 | 616 | −28.76 | 127.6 | 0.2638 | 0/12 |
| NLP1063 | SF-SM | SF Lec | Atlox ™ CS100B | 71.1:2.6:26.3 | 840 | −74.87 | 198.2 | 0.2516 | 0/12 |
| NLP1064 | SF-TM | SF Lec | — | 81.8:18.2:0.0 | 1200 | −30.62 | 156.5 | 0.07103 | 0/12 |
| NLP1065 | SF-TM | SF Lec | NINEX ® MT-615 | 50.0:22.7:27.3 | 400 | −23.83 | 131.7 | 0.2818 | 0/12 |
| NLP1066 | SF-SM | Emulfluid ™ | STEP-FLOW ® 1500 | 37.5:20.8:41.7 | 280 | −33.9 | 1028 | 1 | 0/12 |
| NLP1067 | SF-TM | SF Lec | CRODESTA ™ F160- | 67.2:3.0:29.9 | 1200 | n/a | n/a | n/a | 0/12 |
| | | | PW-(JP) | | | | | | |
| NLP1068 | SF-SM | SF Lec | — | 94.2:5.8:0.0 | 504 | −38.56 | 418.3 | 0.313 | 0/12 |
| NLP1069 | SF-TM | Emulfluid ™ | Rhamnolipid-Deguan | 52.2:4.3:43.5 | 640 | −38.68 | 119.2 | 0.2696 | 0/12 |
| NLP1070 | SF | SF Lec | — | 96.8:3.2:0.0 | 600 | −37.88 | 1600 | 0.5205 | 0/12 |
| NLP1071 | SF-TM | Pluronic ® F127 | — | 95.7:4.3:0.0 | 1200 | −15.81 | 240.8 | 0.2093 | 0/12 |
| NLP1072 | SF-SM | SF Lec | — | 79.2:20.8:0.0 | 448 | −31.51 | 395.6 | 0.3918 | 0/12 |
| NLP1073 | SF | Emulfluid ™ | — | 76.7:23.3:0.0 | 200 | −44.86 | 235.8 | 0.1968 | 0/12 |
| NLP1074 | SF-SM | Emulfluid ™ | NINEX ® MT-615 | 45.0:5.0:50.0 | 280 | −26.03 | 153.6 | 0.2422 | 0/12 |
| NLP1075 | SF | Emulfluid ™ | Sophoro (SLM) | 50.0:25.0:25.0 | 200 | −39.02 | 146.1 | 0.117 | 0/12 |
| NLP1076 | SF | Pluronic ® F127 | STEP-FLOW ® 1500 | 66.7:11.1:22.2 | 600 | −4.102 | 120 | 0.1171 | 0/12 |
| NLP1077 | SF-SM | Pluronic ® F127 | STEP-FLOW ® 4000 | 45.0:5.0:50.0 | 280 | −21.62 | 183.2 | 0.1317 | 0/12 |
| NLP1078 | SF | SF Lec | STEP-FLOW ® 1500 | 71.3:10.6:18.1 | 400 | −29.76 | 186.5 | 0.1095 | 0/12 |
| NLP1079 | SF-TM | SF Lec | CRODESTA ™ F160- | 64.9:13.0:22.1 | 800 | −37.2 | 171 | 0.1722 | 0/12 |
| | | | PW-(JP) | | | | | | |
| NLP1080 | SF-TM | Pluronic ® F127 | Sophoro (SLM) | 40.5:5.4:54.1 | 400 | −17.43 | 172.9 | 0.05704 | 0/12 |
| NLP1081 | SF | SF Lec | JEFFSPERSE ® | 65.5:17.2:17.2 | 380 | −20.26 | 177.7 | 0.09596 | 0/12 |
| | | | X3202 | | | | | | |
| NLP1082 | SF | SF Lec | Atlox ™ CS100B | 42.6:14.7:42.6 | 200 | −52.28 | 220.2 | 0.1822 | 0/12 |
| NLP1083 | SF-SM | Pluronic ® F127 | JEFFSPERSE ® | 62.1:6.9:31.0 | 616 | 19.2 | 164.8 | 0.1333 | 0/12 |
| | | | X3202 | | | | | | |
| NLP1084 | SF | Pluronic ® F127 | — | 78.3:21.7:0.0 | 360 | −6.993 | 156.5 | 0.02831 | 0/12 |
| NLP1085 | SF-SM | Pluronic ® F127 | CRODESTA ™ F160- | 52.9:29.4:17.6 | 280 | −24.79 | 149.8 | 0.1954 | 0/12 |
| | | | PW-(JP) | | | | | | |
| NLP1086 | SF-SM | SF Lec | STEP-FLOW ® 4000 | 66.4:9.3:24.3 | 840 | −28.58 | 235.3 | 0.2037 | 0/12 |
| NLP1087 | SF | Pluronic ® F127 | Rhamnolipid-Deguan | 73.2:2.4:24.4 | 600 | −65.98 | 189.6 | 0.1302 | 0/12 |
| NLP1088 | SF | Pluronic ® F127 | STEP-FLOW ® 1500 | 71.3:10.6:18.1 | 400 | −4.453 | 150.1 | 0.09155 | 0/12 |
| NLP1089 | SF-SM | Emulfluid ™ | — | 90.0:10.0:0.0 | 840 | −56.36 | 205.1 | 0.1472 | 0/12 |
| NLP1090 | SF-SM | Pluronic ® F127 | JEFFSPERSE ® | 59.4:14.5:26.1 | 280 | 23.26 | 154.9 | 0.0873 | 0/12 |
| | | | X3202 | | | | | | |
| NLP1091 | SF-TM | SF Lec | BIO-SOFT ® N91-8 | 76.3:3.4:20.3 | 1200 | −29.21 | 195.2 | 0.04717 | 0/12 |
| NLP1092 | SF-TM | Pluronic ® F127 | Atlox ™ 550S | 67.2:3.0:29.9 | 1200 | −37.84 | 135.3 | 0.1647 | 0/12 |
| NLP1093 | SF-SM | Pluronic ® F127 | — | 84.4:15.6:0.0 | 840 | −6.559 | 147.7 | 0.05527 | 0/12 |
| NLP1094 | SF | Emulfluid ™ | JEFFSPERSE ® | 41.9:16.1:41.9 | 200 | −34.64 | 185.8 | 0.1058 | 0/12 |
| | | | X3202 | | | | | | |
| NLP1095 | SF-SM | Emulfluid ™ | Atlox ™ 550S | 64.3:11.9:23.8 | 840 | −43.51 | 178.1 | 0.2835 | 5/12 |
| NLP1096 | SF-TM | SF Lec | Atlox ™ 550S | 33.3:22.2:44.4 | 400 | −47.12 | 110 | 0.1121 | 0/12 |
| NLP1097 | SF-SM | SF Lec | — | 96.4:3.6:0.0 | 840 | −61.17 | 792.2 | 0.4164 | 0/12 |
| NLP1098 | SF-SM | Pluronic ® F127 | Atlox ™ AL 2575 | 37.5:20.8:41.7 | 280 | −39.15 | 127.2 | 0.1267 | 0/12 |
| NLP1099 | SF-TM | SF Lec | Rhamnolipid-Deguan | 60.0:13.3:26.7 | 1200 | −37.42 | 80.91 | 0.1676 | 0/12 |
| NLP1100 | SF-TM | Pluronic ® F127 | — | 81.8:18.2:0.0 | 1200 | −15.61 | 118.5 | 0.08924 | 0/12 |
| NLP1101 | SF-TM | Emulfluid ™ | BIO-SOFT ® N91-8 | 44.4:18.5:37.0 | 640 | −55.82 | 107.5 | 0.1701 | 0/12 |
| NLP1102 | SF | Pluronic ® F127 | Rhamnolipid-Deguan | 40.0:20.0:40.0 | 200 | −23.03 | 146.7 | 0.138 | 0/12 |
| NLP1103 | SF | Pluronic ® F127 | Atlox ™ 550S | 59.5:13.5:27.0 | 440 | −28.76 | 139.6 | 0.1408 | 0/12 |
| NLP1104 | SF-SM | SF Lec | sugar beet pectin | 71.1:2.6:26.3 | 840 | n/a | n/a | n/a | 0/12 |
| NLP1105 | SF-TM | Emulfluid ™ | — | 81.8:18.2:0.0 | 1200 | −43.51 | 186.9 | 0.114 | 0/12 |
| NLP1106 | SF | SF Lec | — | 94.7:5.3:0.0 | 360 | −34.21 | 665 | 0.4733 | 0/12 |
| NLP1107 | SF | SF Lec | STEPFAC ™ TSP-PE | 78.7:7.9:13.4 | 600 | −43.15 | 221.8 | 0.1578 | 0/12 |
| | | | K | | | | | | |
| NLP1108 | SF-TM | Pluronic ® F127 | — | 60.0:40.0:0.0 | 400 | −10.84 | 126.8 | 0.1803 | NA |
| NLP1109 | SF-TM | Emulfluid ™ | sugar beet pectin | 37.7:13.0:49.4 | 400 | −29.78 | 1089 | 0.165 | NA |
| NLP1110 | SF | Pluronic ® F127 | NINEX ® MT-615 | 40.0:20.0:40.0 | 200 | −33.9 | 62.21 | 0.1496 | NA |
| NLP1111 | SF | Pluronic ® F127 | — | 85.7:14.3:0.0 | 600 | −14.23 | 168.6 | 0.0902 | NA |
| NLP1112 | SF-SM | Emulfluid ™ | STEP-FLOW ® 1500 | 37.5:20.8:41.7 | 280 | −38.45 | 75.67 | 0.2032 | NA |
| NLP1113 | SF-SM | Emulfluid ™ | AMMONYX ® | 37.5:20.8:41.7 | 280 | 49.71 | 146.3 | 0.1372 | NA |
| | | | CETAC-30 | | | | | | |
| NLP1114 | SF-TM | Emulfluid ™ | — | 60.0:40.0:0.0 | 400 | −48.98 | 178 | 0.1176 | NA |
| NLP1115 | SF-SM | Emulfluid ™ | STEP-FLOW ® 1500 | 77.1:14.3:8.6 | 840 | −56.07 | 104.8 | 0.09187 | NA |
| NLP1116 | SF-TM | Emulfluid ™ | — | 86.8:13.2:0.0 | 1200 | −42.75 | 153.2 | 0.06313 | NA |
| NLP1117 | SF-SM | SF Lec | NINEX ® MT-615 | 51.9:12.3:35.8 | 448 | −22.68 | 90.37 | 0.1644 | NA |
| NLP1118 | SF-SM | Pluronic ® F127 | CRODESTA ™ F160- | 64.3:11.9:23.8 | 840 | −16.33 | 128 | 0.0861 | NA |
| | | | PW-(JP) | | | | | | |
| NLP1119 | SF-TM | Pluronic ® F127 | Sophoro (SLM) | 67.2:14.9:17.9 | 1200 | −14.88 | 193.9 | 0.07555 | NA |
| NLP1120 | SF | Pluronic ® F127 | JEFFSPERSE ® | 73.2:2.4:24.4 | 600 | 21.46 | 231.2 | 0.2212 | NA |
| | | | X3202 | | | | | | |
| NLP1121 | SF | Emulfluid ™ | — | 66.7:33.3:0.0 | 200 | −50.89 | 505 | 0.2813 | NA |
| NLP1122 | SF | SF Lec | — | 85.5:14.5:0.0 | 400 | −37 | 142.8 | 0.2965 | NA |
| NLP1123 | SF-TM | Emulfluid ™ | Atlox ™ 550S | 64.9:13.0:22.1 | 800 | −75.96 | 184.5 | 0.1183 | NA |
| NLP1124 | SF-SM | Pluronic ® F127 | CRODESTA ™ F160- | 42.7:10.4:46.9 | 280 | −48.83 | 209.1 | 0.1372 | NA |
| | | | PW-(JP) | | | | | | |
| NLP1125 | SF | Emulfluid ™ | — | 66.7:33.3:0.0 | 200 | −32.57 | 113.5 | 0.1238 | NA |
| NLP1126 | SF | Pluronic ® F127 | — | 90.9:9.1:0.0 | 200 | −43.51 | 178.1 | 0.2835 | NA |
| NLP1131 | SF | Pluronic ® F127 | Rhamnolipid-Deguan | 71.3:10.6:18.1 | 400 | −30.33 | 183 | 0.1666 | NA |
| NLP1132 | SF-TM | SF Lec | NINEX ® MT-615 | 62.1:3.4:34.5 | 960 | −29.76 | 115.2 | 0.2509 | NA |
| NLP1133 | SF | Emulfluid ™ | Atlox ™ AL 2575 | 47.6:4.8:47.6 | 200 | −32.54 | 140.1 | 0.1359 | NA |
| NLP1134 | SF | SF Lec | — | 66.7:33.3:0.0 | 200 | −27.45 | 312.4 | 0.2757 | NA |
| NLP1135 | SF-SM | SF Lec | — | 74.4:25.6:0.0 | 448 | −29.83 | 356.8 | 0.3048 | NA |
| NLP1136 | SF-SM | Emulfluid ™ | STEP-FLOW ® 1500 | 77.1:14.3:8.6 | 840 | −43.29 | 125.9 | 0.0672 | NA |
| NLP1137 | SF | SF Lec | STEPFAC ™ TSP-PE | 78.7:7.9:13.4 | 600 | −40.09 | 217.7 | 0.1772 | NA |
| | | | K | | | | | | |
| NLP1138 | SF-TM | Emulfluid ™ | — | 74.4:25.6:0.0 | 400 | −40.51 | 169.2 | 0.1016 | NA |
| NLP1139 | SF | SF Lec | BIO-SOFT ® N91-8 | 45.5:22.7:31.8 | 200 | −25.4 | 154.1 | 0.131 | NA |
| NLP1140 | SF | Emulfluid ™ | Atlox ™ 550S | 47.6:4.8:47.6 | 200 | −42.93 | 215.3 | 0.09844 | NA |

^{a}NP, non-polar lipid; EO, essential oil; SF, sunflower; SM, spearmint; TM, thyme; SF-SM (90%-10%), sunflower and spearmint oil blend; SF-TM (75%-25%), sunflower and thyme oil blend
^{b}SF Lec, sunflower lecithin
^{c}DCM concentration indicated is the starting concentration
^{d}Number of plants with positive uptake among 12 replicates

### Example 3. NLP Compositions Comprising Permethrin and DCM

This Example describes the preparation of NLP compositions comprising an insecticide Permethrin and the fluorescent dye DCM. The first batch of compositions prepared are summarized in Table 6A. The second batch of compositions prepared are summarized in Table 6B.

TABLE 6A
First batch of compositions of Permethrin-comprising NLPs

| | | | | | Permethrin | DCM in | Zeta | Diameter | |
|---|---|---|---|---|---|---|---|---|---|
| NLP# | NP | PL^{a} | SM | Ratio | (mg/ml) | (mg/ml) | potential | (nm) | PDI |
| NLP1127-1 | — | SF | Toximul | 0:50:50 | 100 | 0.1 | −32.43 | 110.4 | 0.189 |
| | | Lec | 8234 | | | | | | |
| NLP1128-1 | — | SF | Atlox ™ | 0:66.7:33.3 | 100 | 0.1 | −47.5 | 218.2 | 0.203 |
| | | Lec | 500L | | | | | | |
| NLP1129-1 | — | SF | Atlox ™ | 0:55.6:44.4 | 100 | 0.1 | −43.8 | 242.8 | 0.196 |
| | | Lec | 500L | | | | | | |
| NLP1130-1 | SF | SF | — | 38.5:61.5:0 | 50 | 0.05 | −35.75 | 238.9 | 0.239 |
| | oil | Lec | | | | | | | |

^{a}SF, sunflower; SF Lec, sunflower lecithin

TABLE 6B
Second batch of NLP compositions comprising Permethrin

| | | | | | Permethrin | DCM in | Zeta | Diameter | |
|---|---|---|---|---|---|---|---|---|---|
| NLP# | NP | PL | SM | Ratio | (mg/ml) | (mg/ml) | potential | (nm) | PDI |
| NLP1127-2 | — | SF Lec | Toximul | 0:50:50 | 100 | 1000 | −24.53 | 138 | 0.18 |
| | | | 8234 | | | | | | |
| NLP1128-2 | — | SF Lec | Atlox ™ | 0:66.7:33.3 | 100 | 1000 | −69.45 | 261.1 | 0.2 |
| | | | 500L | | | | | | |
| NLP1129-2 | — | SF Lec | Atlox ™ | 0:55.6:44.4 | 100 | 1000 | −63.71 | 306 | 0.19 |
| | | | 500L | | | | | | |
| NLP1130-2 | SF | SF Lec | — | 38.5:61.5:0 | 100 | 1100 | −46.66 | 288.8 | 0.19 |
| | oil | | | | | | | | |
| NLP1141-2 | SF | Emulfluid ™ | — | 95.2:4.8:0^{a} | 100 | 1400 | −53.01 | 326.4 | 0.31 |
| | oil | | | | | | | | |
| NLP1142-2 | SF | SF Lec | Atlox ™ | 64.5:16.1:19.4^{a} | 100 | 1400 | −70.32 | 244 | 0.32 |
| | oil | | CS100B | | | | | | |

### Example 4. NLP Compositions Comprising More than One Bioactive (PE and DE)

This Example describes NLPs comprising more than one heterologous functional agent, e.g., deltamethrin and permethrin.

### Experimental Procedure:

NLPs are produced with any of the methods described in Example 5 wherein the organic phase comprising phospholipids, non-polar lipids and/or essential oils, a surface modifier and at least two heterologous functional agents (e.g, two insecticides), are mixed with an aqueous phase comprising de-ionized water and applying a source of energy to facilitate the formation of NLPs. In some embodiments the heterologous functional agents encapsulated are deltamethrin (DE) and permethrin (PE), at the concentrations indicated in Table 7.

TABLE 7
NLPs produced comprising DE and PE

| | | Concentration | | Concentration |
|---|---|---|---|---|
| Combination^{a} | Insecticide 1 | (μg/ml)^{b} | Insecticide 2 | (μg/ml) |
| 1. NLP(DE + PE) | Deltamethrin | 100 | Permethrin | 400 |
| 2. NLP(DE + PE) | Deltamethrin | 400 | Permethrin | 400 |
| 3. NLP(DE + PE) | Deltamethrin | 2,000 | Permethrin | 400 |
| 4. NLP(DE + PE) | Deltamethrin | 400 | Permethrin | 100 |
| 5. NLP(DE + PE) | Deltamethrin | 400 | Permethrin | 400 |
| 6. NLP(DE + PE) | Deltamethrin | 400 | Permethrin | 2,000 |
| 7. NLP (DE + PE) | Deltamethrin | 100 | Permethrin | 100 |

^{a}DE, deltamethrin; PE, permethrin.
^{b}Concentration refers to ug DE or PE comprised per ml of NLP suspension.

### Example 5. Methods of Making NLPs

NLPs described herein were prepared by mixing an organic phase comprising one or more non-polar lipids or/or one or more essential oils (NP, e.g cinnamon oil), one or more polar lipid (PL, e.g, a sunflower lecithin), at least one cargo (e.g. CTPR, or permethrin), optionally a surface modifier (SM), and optionally a dye (e.g. 4-(Dicyanomethylene)-2-methyl-6-(4-dimethylaminostyryl)-4H-pyran (DCM)), with an aqueous phase comprising deionized water and optionally at least one surface modifier, applying a form of energy, e.g, heat, sonication, high pressure or shear force, to form liposome vesicles (NLPs).

The formulations were produced by mixing an organic phase comprising a at least one non-polar lipid (NP) and/or at least one essential oil (EO), at least one polar lipid (PL) and optionally at least one surface modifier (SM) and optionally a hydrophobic dye (e.g. DCM dye: 4-(Dicyanomethylene)-2-methyl-6-(4-dimethylaminostyryl)-4H-pyran) and/or a heterologous functional agent (e.g, permethrin) with an aqueous phase, optionally comprising at least one surface modifier, applying a form of energy (e.g, sonication, or high pressure), thereby forming the lipid nanoparticles (NLPs). Any of the formulations comprising any of the constituents of Table 1 and any of the of the NP: PL: SM ratios shown in Tables 2-5 are produced with any of the methods described herein.

Methods for forming liposome vesicles are well known in the art, see e.g. Tenchov et al., ACS Nano 15 (11): 16982-17017 (2021). John et al., Pharmaceutics 16, 131 (2024) and PCT/US2024/015064, which are incorporated in their entireties herein.

### Example 6. NLP Corn Root Uptake with Florescent Readout

This example describes systemicity of NLP in a corn plant upon root uptake in a hydroponic setup.

### Experimental Procedure

a) Seed germination:

On Day 1, about 90 grams of MBS corn seeds (MBS2302×MBS8148 purchased from Gro Alliance, Cuba City. WI) were sterilized in bleach sterilization solution (20% bleach+0.2% Triton X-100 +80% water) in a 500 mL glass bottle. The bottle was shaken on a horizontal shaker at 200 rpm for 20 min and rinsed with sterile water 4 times before being air-dried in a biosafety cabinet.

Once seeds were dry, a fungicide slurry was made by homogenously mixing 0.27 g of Captan (Southern Ag. Rubonia. FL) with 270 μL of water. The sterilized seeds were mixed with the fungicide slurry in a clean bottle and shaken vigorously for 30 seconds until the seeds were fully coated with slurry.

The fungicide-coated corn seeds were placed in the autoclaved germination papers (NASCO. Cat #SB39211) that were saturated with sterile water. A total of 10 seeds were placed about 1 cm apart and 1 cm from the top of the paper. The paper was gently rolled with seeds inside and secured with a rubber band. Three paper rolls were placed with seed side up in the 1L bottle with 150 mL of 1% Plant Preservative Mixture (PPM: Plant Cell Technology. Washington, D.C.) solution. The 1L bottle was covered with an aluminum foil and placed in an incubator (25° C., and 50% humidity).

b) Root Uptake in Tube Setup:

On Day 7, the paper rolls were unfolded and the 7-day-old seedlings were assessed and chosen for similar size and good development (leaves starting to unfurl, developed root system, and no contamination).

c) Treatments in Tubes

Add 15 mL conical tubes to the racks and there were 12 replicates per treatment. NLPs were diluted 20× with water and 12 mL of the respective treatment solution was added to each tube.

Treatment solutions were one of the following: 1) water only: 2) NLP1052-empty comprising 0) ug of DCM per ml of suspension (NLP1052-Empty): 3) NLP1054-empty comprising (ug of DCM per ml of suspension (NLP1054-Empty); and those NLPs listed as tested in table 3:4) DCM in water (60 ug/ml; control): 5) fluorescein in water (800 μg/ml: control).

One corn seedling was placed in each tube with all the roots in the solution without being damaged. The seed shell was at the surface of the solution. The seedlings in the tubes were placed back to the same incubator for 3 days. After the 3 day incubation period, all tubes from the incubator were taken out and plant health was visually assessed. If a seedling was discolored, wilted, or otherwise in poor health, they were deemed as poor health not submitted for further analysis. For the seedlings of good health, the stem was cut at the first “collar” area by a razor blade and the first leaf was peeled off completely.

d) Uptake Analysis

Analytical assays for fluorescence quantitation in the corn shoots was carried out by grinding the shoot/leaves, extracting the DCM dye in acetonitrile, and measuring fluorescence in a spectrophotometer with excitation at 481 nm and emission at 630 nm.

For the fluorescence imaging of the intact shoots, the corn shoot without 1st leaf were placed on the iBright FL1500 imager (Thermo Fisher), gray scale images of DCM fluorescence were acquired with excitation at 455-485 nm and emission at 568-617 nm, gray scale images of fluorescein fluorescence were acquired with excitation at 455-485 nm and emission at 508-557 nm, both channels with an exposure time of 1s. In Addition, a gray scale image of the leaves was also acquired using white light. The images were analyzed for amount of dye uptake in the plant using ImageJ. The gray scale image under white light was used to draw regions of interest masks hugging the outline of the bottom 4 cm of the leaves in the image for each leaf. Using the same regions of interest overlayed on the DCM and fluorescein channel images, the mean pixel intensity was measured. The mean of mean pixel intensity of all leaves of each treatment was compared to the water treatment.

Further, the 12 replicate leaves in each treatment were assessed visually from the DCM channel gray scale images for uptake of the dye compared to the water treated leaves as the reference. Shoots that were visually showing fluorescence above background upon macroscopic assessment were scored as positive for dye uptake and distribution and expressed as a number relative to the 12 shoots analyzed (e.g. 5/12).

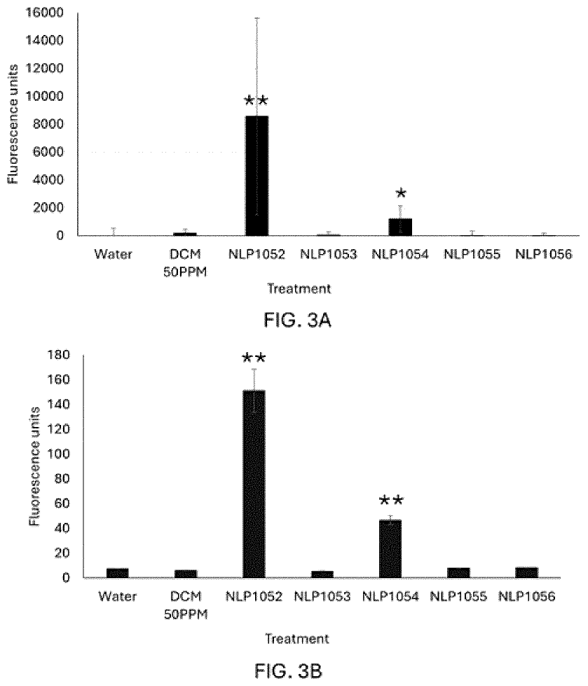

Results: NLP1052 and NLP1054 showed a significantly higher uptake in the corn leaves than e.g. NLP1053. NLP1055 or NLP1056, all comprising the dye DCM, as assessed by quantitation of DCM in the twelve homogenized shoots (FIG. 3A) as well as in fluorescence imaging of the twelve intact shoots (FIG. 3B). These results show that the uptake of NLPs is specific, and composition-dependent. Data presented in Table 5 show that in fact only three compositions. NLP1052. NLP1054 and NLP1095, out of 56 compositions analyzed demonstrate uptake and biodistribution in the corn plants.

### Example 7. Evaluation of NLP Formulations Comprising PE Against FAW in a Hydroponic Corn Uptake Assay

This example describes a method to assess the protection offered by NLPs comprising encapsulated Permethrin (PE) as active in corn plants against a foliar lepidopteran pest. Fall armyworm (FAW) when administered via roots in a hydroponic assay.

### Experimental Procedure

a) Seed germination:

On Day 1, about 90 grams of MBS seeds (MBS2302×MBS8148 purchased from Gro Alliance. Cuba City. WI) are sterilized in bleach sterilization solution (20% bleach+0.2% Triton X-100+80% water) in a 500 mL glass bottle. The bottle is shaken on a horizontal shaker at 200 rpm for 20 min and rinsed with sterile water 4 times before being air-dried in a biosafety cabinet.

Once seeds are dry, the fungicide slurry is made by homogenously mixing 0.27 g of Captan (Southern Ag. Rubonia. FL) with 270 μL of water. The sterilized seeds are mixed with the fungicide slurry in a clean bottle and shaken vigorously for 30 seconds until the seeds are fully coated with slurry.

The fungicide coated corn seeds are placed in the autoclaved germination papers (NASCO. Cat #SB39211) that are saturated with sterile water. A total of 10 seeds are placed about 1 cm apart and 1 cm from the top of the paper. The paper is gently rolled with seeds inside and secured with a rubber band. Three paper rolls are placed with seed side up in the 1L bottle with 150 mL of 1% Plant Preservative Mixture (PPM: Plant Cell Technology. Washington. D.C.) solution. The 1L bottle is covered with an aluminum foil and placed in an incubator (25 C and 50% humidity).

b) Root uptake in tube setup:

On Day 7, the paper rolls are unfolded and the 7-day-old seedlings are assessed and chosen for similar size and good development (leaves starting to unfurl, developed root system, and no contamination).

c) Set up the treatments in tubes

Add 15 ml conical tubes to the racks and there are 12 replicates per treatment. NLPs are diluted 20× with water and 12 mL of the respective treatment solution is added to each tube.

Treatment solutions are one of the following: 1) water: 2) Poncho™ (Clothianidin): 3) NLP comprising permethrin at 100 mg per ml of suspension: 4) NLP comprising permethrin and deltamethrin each at 100 mg per ml of suspension: 5) Permethrin in water at 100 mg per ml of suspension: 6) Permethrin and deltamethrin in water each at 100 mg per ml of suspension.

One corn seedling is placed in each tube with all the roots in the solution without being damaged. The seed shell is at the surface of the solution. The seedlings in the tubes are placed back to the same incubator.

d) FAW Infestation

FAW eggs are shipped from the supplier (Benzon Research. Carlisle PA USA) and stored at 10° C. until ready for use (less than a week). The eggs are hatched in an incubator (25 C. 16h: 8h: L: D) and neonatal FAW larvae are used and infestations are conducted 7 days after seed planting.

Corn plants are collected on day 10 and lower part of whorl and leaves are cut after removal of the 1st leaf. The lower part of whorl and leaves from a single plant are placed into a petri dish and infested with 5 neonatal FAW.

e) Readout and Analysis

The mortality of FAW on 2, 4, and 7 days after infestation are recorded.

Results: Selected NLPs cause significantly higher mortality of FAW feeding on the corn leaves than the water and permethrin in water treatments. Selected NLPs cause higher FAW mortality as the positive control. Poncho™

### Example 8. Evaluation of NLP Formulations Comprising PE Against FAW in a Soil Corn Uptake Assay

This example describes a method to assess the protection offered by NLPs comprising encapsulated Permethrin (PE) as active in corn plants against a foliar lepidopteran pest. Fall armyworm (FAW) when administered via roots in a soil assay.

### Experimental Procedure:

Small scale (Green house 10″ pot) in-furrow treatment

a) In furrow treatment

Jumbo cotton balls are packed into the bottom of 10″ tall and 2.7″ diameter cylindrical containers. Wide straws are inserted for infestation later, then packed with ˜660g of silt loam soil. Soil is then watered with about 150 ml of water in three 50 ml increments 24 hrs before planting. A hole is made at a depth of 1.5 inch from the top of the soil. The soil is treated by pipetting 1 ml of treatments selected from 1) water: 2) Poncho™ (Clothianidin): 3) NLP comprising permethrin at 100 mg per ml of suspension: 4) NLP comprising permethrin and deltamethrin each at 100 mg per ml of suspension: 5) Permethrin in water at 100 mg per ml of suspension: 6) Permethrin and deltamethrin in water each at 100 mg per ml of suspension.

The treatments are added around the edge of the hole and on seed for planting. A seed is then planted in the hole and covered with soil. Containers with seeds are then placed in the greenhouse to continue growing for 14 days until ready for infestation.

b) FAW infestation

FAW eggs are shipped from the supplier (Benzon Research. Carlisle PA USA) and stored at 10° C. until ready for use (less than a week). The eggs are hatched in an incubator (25 C. 16h: 8h: L: D) and neonatal FAW larvae are used and infestations are conducted 14 days after seed planting.

Corn plants at V2-V3 stage are Collected and lower part of whorl and leaves are cut after removal of the 1st leaf. The lower part of whorl and leaves from a single plant are placed into a petri dish and infested with 5 neonatal FAW.

### c) Readout and Analysis

The mortality of FAW on 2, 4, and 7 days after infestation are recorded.

Results: Selected NLPs cause significantly higher mortality of FAW feeding on the corn leaves than the water and permethrin in water treatments. Selected NLPs cause higher FAW mortality as the positive control. Poncho™

### Example 9. Efficacy of permethrin-NLP formulations against FAW in field trial

This example describes a method to assess the protection offered by NLPs comprising encapsulated Permethrin (PE) as active in corn plants against a foliar lepidopteran pest. Fall armyworm (FAW) when administered as an in-furrow application in the field.

### Experimental Procedure:

Field-scale in-furrow treatment

a) Field plot design

The experimental design is a randomized complete block with four replications. Corn rootworm field plots are either 2 or 4 rows wide and 35 feet in length. Plots are cut back to 30 feet in length after planting to facilitate root digging.

b) Seed planting

The field with silt loam soil is tilled before the planting. The corn seeds are pre-bagged in the laboratory and then planted with a four-row John Deere Max Emerge™ 7100 Integral Rigid Frame Planter that has 30-inch row spacing. Seeds are planted at a depth of 2 inches with a spacing of 6 inches between seeds (35.600 seeds per acre).

c) In-furrow application of NLP

Treatments are selected from 1) NLP comprising permethrin at 100 mg per ml of suspension: 2) NLP comprising permethrin and deltamethrin each at 100 mg per ml of suspension: 3) unencapsulated PE in water at 100 mg/ml: 4) Permethrin and deltamethrin in water each at 100 mg per ml of suspension; 5) Poncho™ (Clothianidin at 2 mg/ml): or 6) water are applied in-furrow at planting with a compressed-air system built directly into the planter by Almaco manufacturing (Nevada. IA). All liquid formulations are applied at 6 liter per 1000 row feet. All liquid NLP formulations are applied with a Teejet XR80015EVS spray nozzles at 21 psi to deliver 5 GPA of finished spray at a tractor speed of 4 mph. Before the field season begins, new spray nozzles are installed and calibrated with water to ensure proper application of product. For these liquid applications each row is checked for correct spray pattern prior to plot application and monitored during application to ensure that insecticides are applied correctly. The T-band spraying aims at the center of the furrow with a width of 7 inch from left to right.

d) Corn leaves collection and FAW infestation

Corn plants at V2-V3 stage are collected and lower part of whorl and leaves are cut after removal of the 1st leaf. The lower part of whorl and leaves from a single plant are placed into a petri dish and infested with 5 neonatal FAW.

e) Data collection and analysis:

Data are analysed with analysis of variance (ANOVA) procedures using SAS Enterprise Guide 7.1. When a significant treatment effect is present pairwise comparisons made among means with an experiment-wide error rate of P<0.05.

Results: Selected NLPs are expected to cause significantly higher mortality of FAW feeding on the corn leaves than the water and permethrin in water treatments. NLPs that cause higher FAW mortality as the positive control, Poncho™ are selected.

### Example 10. Uptake of NLP Compositions in Corn Root Cells

NLP compositions as described in Table 8 below comprising DCM were produced as described in Example 5. The roots of corn seedlings were treated with the NLP compositions as described in Example 2 and uptake of the dye into the root cells was detected by microscopic Imaging. The results of the uptake analysis are described in Table 8.

TABLE 8
NLP Compositions tested for uptake into corn root cells.

| NLP | Uptake | Non-Polar | PhospoLipid | Surface Modifier | Ratio |
|---|---|---|---|---|---|
| Formulation # | Observed? | Lipid (NP) | (PL) | (SM) | NP:PL:SM |
| 1041 | N | | | | |
| 1052 | Y | sunflower | Emulfluid | Atlox 550S | 30, 1, 0 |
| 1053 | N | sunflower | Emulfluid | Atlox AL 2575 | 6, 1, 2 |
| 1054 | Y | sunflower | sunflower lecithin | Atlox CS100B | 6, 1, 1.2 |
| 1055 | N | sunflower | Pluronic F127 | NINEX MT-615 | 8.5, 1, 0 |
| 1056 | N | sunflower | sunflower lecithin | STEPFLOW 4000 | 10, 1, 4 |
| 1057 | N | spearmint | Pluronic F127 | BIO-SOFT N91-8 | 9, 1, 10 |
| | | blend | | | |
| 1058 | N | thyme blend | sunflower lecithin | BIO-SOFT N-411 | 3.4, 1, 45 |
| 1059 | N | spearmint | Emulfluid | Atlox AL 2575 | 18, 1, 5 |
| | | blend | | | |
| 1060 | N | thyme blend | sunflower lecithin | BIO-SOFT N91-8 | 16.5, 1, 10 |
| 1061 | N | thyme blend | Pluronic F127 | sugar beet pectin | 1.5, 1, 1 |
| 1062 | N | spearmint | Emulfluid | STEPFLOW 1500 | 19.8, 1, 10 |
| | | blend | | | |
| 1063 | N | spearmint | sunflower lecithin | Atlox CS100B | 27, 1, 10 |
| | | blend | | | |
| 1064 | N | thyme blend | sunflower lecithin | Atlox AL 2575 | 4.5, 1, 0 |
| 1065 | N | thyme blend | sunflower lecithin | NINEX MT-615 | 2.2, 1, 1.2 |
| 1068 | N | spearmint | sunflower lecithin | Atlox 550S | 16.2, 1, 0 |
| | | blend | | | |
| 1069 | N | thyme blend | Emulfluid | Rhamnolipid-Deguan | 12, 1, 10 |
| 1071 | N | thyme blend | Pluronic F127 | Atlox CS100B | 22.5, 1, 0 |
| 1072 | N | spearmint | sunflower lecithin | JEFFSPERSE ® | 3.8, 1, 0 |
| | | blend | | X3202 | |
| 1073 | N | sunflower | Emulfluid | Atlox 550S | 3.3, 1, 0 |
| 1074 | N | spearmint | Emulfluid | NINEX MT-615 | 9, 1, 10 |
| | | blend | | | |
| 1075 | N | sunflower | Emulfluid | Sophoro (SLM) | 2, 1, 1 |
| 1076 | N | sunflower | Pluronic F127 | STEPFLOW 1500 | 6, 1, 2 |
| 1077 | N | spearmint | Pluronic F127 | STEPFLOW 4000 | 9, 1, 10 |
| | | blend | | | |
| 1078 | N | sunflower | sunflower lecithin | STEPFLOW 1500 | 6.7, 1, 1.7 |
| 1080 | N | thyme blend | Pluronic F127 | Sophoro (SLM) | 7.5, 1, 10 |
| 1081 | N | sunflower | sunflower lecithin | JEFFSPERSE ® | 3.8, 1, 1 |
| | | | | X3202 | |
| 1082 | N | sunflower | sunflower lecithin | Atlox CS100B | 2.9, 1, 2.9 |
| 1083 | N | spearmint | Pluronic F127 | JEFFSPERSE ® | 9, 1, 4.5 |
| | | blend | | X3202 | |
| 1084 | N | sunflower | Pluronic F127 | Atlox AL 2575 | 3.6, 1, 0 |
| 1085 | N | spearmint | Pluronic F127 | CRODESTA | 1.8, 1, 0.6 |
| | | blend | | F160-PW-(JP) | |
| 1086 | N | spearmint | sunflower lecithin | STEPFLOW 4000 | 7.1, 1, 2.6 |
| | | blend | | | |
| 1087 | N | sunflower | Pluronic F127 | Rhamnolipid-Deguan | 30, 1, 10 |
| 1088 | N | sunflower | Pluronic F127 | STEPFLOW 1500 | 6.7, 1, 1.7 |
| 1089 | N | spearmint | Emulfluid | Sophoro (SLM) | 9, 1, 0 |
| | | blend | | | |
| 1090 | N | spearmint | Pluronic F127 | JEFFSPERSE ® | 4.1, 1, 1.8 |
| | | blend | | X3202 | |
| 1091 | N | thyme blend | sunflower lecithin | BIO-SOFT N91-8 | 22.5, 1, 6 |
| 1092 | N | thyme blend | Pluronic F127 | Atlox 550S | 22.5, 1, 10 |
| 1093 | N | spearmint | Pluronic F127 | JEFFSPERSE ® | 5.4, 1, 0 |
| | | blend | | X3202 | |
| 1094 | N | sunflower | Emulfluid | JEFFSPERSE ® | 2.6, 1, 2.6 |
| | | | | X3202 | |
| 1095 | Y | spearmint | Emulfluid | Atlox 550S | 5.4, 1, 2 |
| | | blend | | | |
| 1096 | N | thyme blend | sunflower lecithin | Atlox 550S | 1.5, 1, 2 |
| 1098 | N | spearmint | Pluronic F127 | Atlox AL 2575 | 1.8, 1, 2 |
| | | blend | | | |
| 1099 | N | thyme blend | sunflower lecithin | Rhamnolipid-Deguan | 4.5, 1, 2 |
| 1100 | N | thyme blend | Pluronic F127 | Atlox 550S | 4.5, 1, 0 |
| 1101 | N | thyme blend | Emulfluid | BIO-SOFT N91-8 | 2.4, 1, 2 |
| 1102 | N | sunflower | Pluronic F127 | Rhamnolipid-Deguan | 2, 1, 2 |
| 1103 | N | sunflower | Pluronic F127 | Atlox 550S | 4.4, 1, 2 |
| 1105 | N | thyme blend | Emulfluid | STEPFAC TSP-PE K | 4.5, 1, 0 |
| 1107 | N | sunflower | sunflower lecithin | STEPFAC TSP-PE K | 10, 1, 1.7 |
| 1108 | N | thyme blend | Pluronic F127 | Atlox CS100B | 1.5, 1, 0 |
| 1110 | N | sunflower | Pluronic F127 | NINEX MT-615 | 2, 1, 2 |
| 1111 | N | sunflower | Pluronic F127 | NINEX MT-615 | 6, 1, 0 |
| 1112 | N | spearmint | Emulfluid | STEPFLOW 1500 | 1.8, 1, 2 |
| | | blend | | | |
| 1113 | N | spearmint | Emulfluid | AMMONYX | 1.8, 1, 2 |
| | | blend | | CETAC-30 | |
| 1114 | N | thyme blend | Emulfluid | JEFFSPERSE ® | 1.5, 1, 0 |
| | | | | X3202 | |
| 1115 | N | spearmint | Emulfluid | STEPFLOW 1500 | 5.4, 1, 0.6 |
| | | blend | | | |
| 1116 | N | thyme blend | Emulfluid | BIO-SOFT N91-8 | 6.6, 1, 0 |
| 1117 | N | spearmint | sunflower lecithin | NINEX MT-615 | 4.2, 1, 2.9 |
| | | blend | | | |
| 1119 | N | thyme blend | Pluronic F127 | Sophoro (SLM) | 4.5, 1, 1.2 |
| 1120 | N | sunflower | Pluronic F127 | JEFFSPERSE ® | 30, 1, 10 |
| | | | | X3202 | |
| 1121 | N | sunflower | Emulfluid | BIO-SOFT N-411 | 2, 1, 0 |
| 1122 | N | sunflower | sunflower lecithin | Atlox CS100B | 5.9, 1, 0 |
| 1123 | N | thyme blend | Emulfluid | Atlox 550S | 5, 1, 1.7 |
| 1124 | N | spearmint | Pluronic F127 | CRODESTA F160- | 4.1, 1, 4.5 |
| | | blend | | PW-(JP) | |
| 1125 | N | sunflower | Emulfluid | sugar beet pectin | 2, 1, 0 |
| 1126 | N | sunflower | Pluronic F127 | Rhamnolipid-Deguan | 10, 1, 0 |
| 1131 | N | sunflower | Pluronic F127 | Rhamnolipid-Deguan | 6.7, 1, 1.7 |
| 1132 | N | thyme/ | sunflower lecithin | NINEX MT-615 | 18, 1, 10 |
| | | sunflower | | | |
| | | blend | | | |
| 1133 | N | sunflower | Emulfluid | Atlox AL 2575 | 10, 1, 10 |
| 1134 | N | sunflower | sunflower lecithin | AMMONYX | 2, 1, 0 |
| | | | | CETAC-30 | |
| 1135 | N | spearmint/ | sunflower lecithin | Atlox 550S | 2.9, 1, 0 |
| | | sunflower | | | |
| | | blend | | | |
| 1136 | N | spearmint/ | Emulfluid | STEPFLOW 1500 | 5.4, 1, 0.6 |
| | | sunflower | | | |
| | | blend | | | |
| 1137 | N | sunflower | sunflower lecithin | STEPFAC TSP-PE K | 10, 1, 1.7 |
| 1138 | N | thyme/ | Emulfluid | STEPFLOW 1500 | 2.9, 1, 0 |
| | | sunflower | | | |
| | | blend | | | |
| 1139 | N | sunflower | sunflower lecithin | BIO-SOFT N91-8 | 2, 1, 1.4 |
| 1140 | N | sunflower | Emulfluid | Atlox 550S | 10, 1, 10 |

### Example 11. Systemic Delivery of NLP Compositions in Corn

This example describes NLP formulations developed for enhanced systemicity from roots to shoots in corn. Formulations were screened using a fluorescence-based uptake assay.

### Experimental Procedure:

a) Treatment

Corn kernels were germinated on filter paper for 7 days and transferred to hydroponic tubes containing 15 mL of NLP formulations as described herein labeled with DCM dye. The corn seedlings were transferred to the tubes with care, so only the root contacted the treatment solution, and not the shoot or aerial part. The corn seedlings were treated in a growth chamber for 3 days, covered in tinfoil.

b) Detection of uptake and distribution

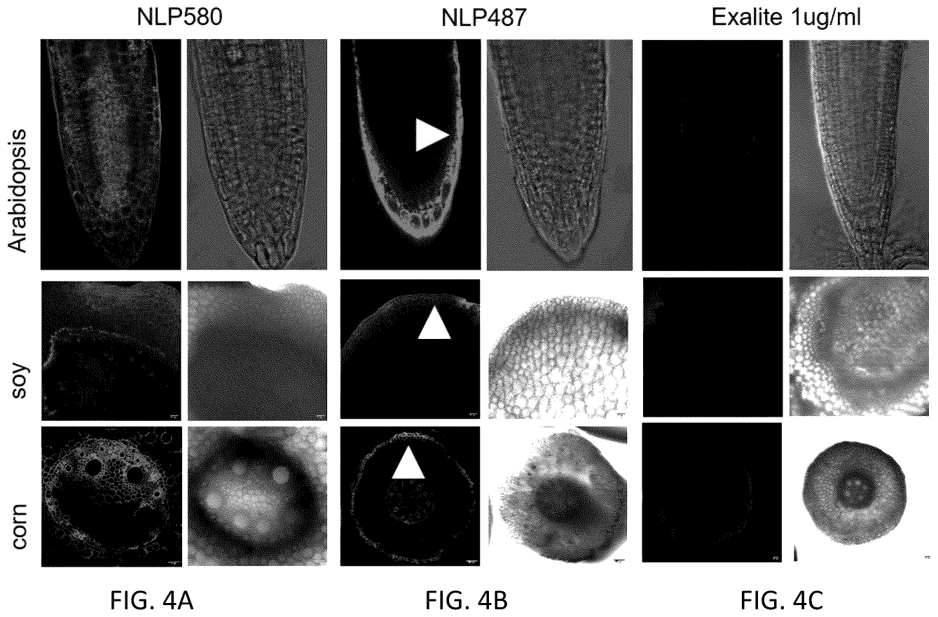

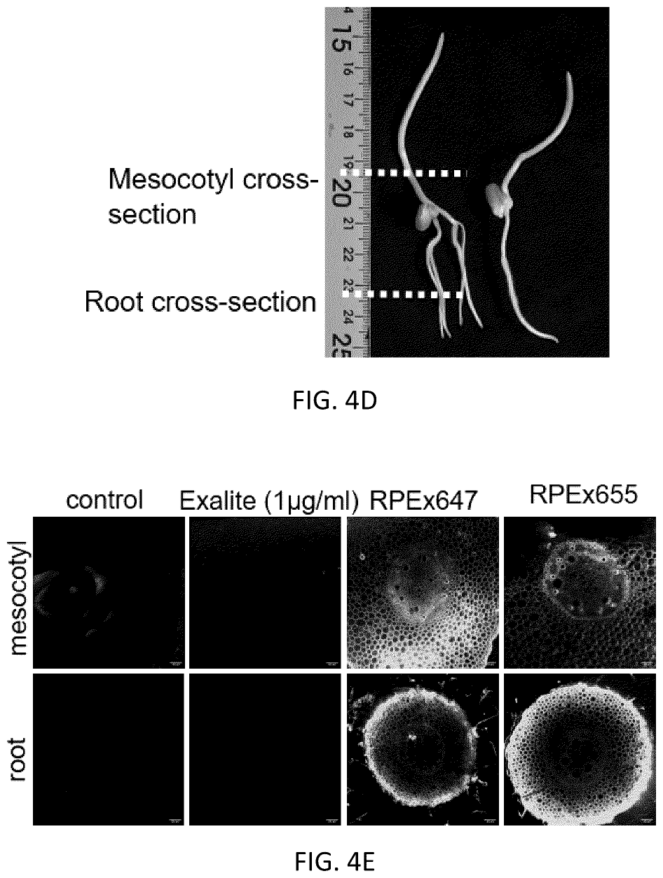

After 3 days, root samples (taken from the submerged part of the root) and mesocotyl or shoot samples (from the aerial part of the seedling) were collected and imaged for presence of the DCM dye in root and shoot cells. Sec, e.g., FIG. 4D-E. The composition and physicochemical properties of NLP compositions exhibiting systemic distribution in corn seedlings is provided in Table 9.

TABLE 9
Composition and Physicochemical Properties of NLPs exhibiting systemic distribution in corn seedlings

| | | | | | DCM | DCM | Zeta | Diameter | |
|---|---|---|---|---|---|---|---|---|---|
| Formulation | NP | PL | SM | Ratio | (ug/ml) | fluorescence | potential | (nm) | PDI |
| 1052 | sunflower | Emulfluid | Atlox 550S | 30, 1, 0 | 600 | 45490 | −48.12 | 388 | 0.3731 |
| 1054 | sunflower | sunflower | Atlox | 6, 1, 1.2 | 600 | 32 | −54.2 | 277.9 | 0.4243 |
| | | lecithin | CS100B | | | | | | |
| 1095 | spearmint | Emulfluid | Atlox 550S | 5.4, 1, 2 | 840 | 57462 | −43.51 | 178.1 | 0.2835 |
| | blend | | | | | | | | |
| 1176 | thyme | Emulfluid | Atlox | 6.6, 1, 2.9 | 1200 | 45171 | −77.91 | 168.6 | 0.5241 |
| | blend | | CS100B | | | | | | |
| 1188 | sunflower | Emulfluid | Sugar beet | 30, 1, 4 | 600 | 2653 | −32.06 | 4551 | 0.4773 |
| | | | pectin | | | | | | |
| 1195 | sunflower | sunflower | STEPFLOW | 30, 1, 0 | 600 | 15608 | −63.27 | 2381 | 0.4509 |
| | | lecithin | 1500 | | | | | | |
| 1196 | sunflower | Emulfluid | STEPFLOW | 6, 1, 0 | 600 | 30272 | −62.08 | 294.1 | 0.2278 |
| | | | 4000 | | | | | | |
| 1197 | spearmint | sunflower | STEPFAC | 27, 1, 0 | 840 | 22917 | −46.23 | 548 | 0.2367 |
| | blend | lecithin | TSP-PE K | | | | | | |
| 1198 | sunflower | Emulfluid | Atlox AL | 30, 1, 0 | 600 | 21202 | −52.88 | 421.1 | 0.3057 |
| | | | 2575 | | | | | | |
| 1236 | sunflower | Emulfluid | | 20, 1, 0 | 600 | | −54.93 | 334 | 0.3497 |
| 1245 | sunflower | sunflower | sugar beet | 6.6, 1, 1.6 | 400 | 9325 | −25.54 | 2048 | 0.09226 |
| | | lecithin | pectin | | | | | | |
| 1253 | sunflower | Emulfluid | Atlox | 20, 1, 7 | 400 | 16987 | −57.45 | 225.8 | 0.1772 |
| | | | CS100B | | | | | | |
| 1256 | sunflower | sunflower | Sophoro | 4, 1, 0 | 400 | 11529 | −29.94 | 422.4 | 0.3592 |
| | | lecithin | (SLM) | | | | | | |
| 1267 | sunflower | Emulfluid | CRODESTA | 3.6, 1, 9 | 360 | 20081 | −52.49 | 216.7 | 0.285 |
| | | | F160-PW- | | | | | | |
| | | | (JP) | | | | | | |
| 1184 | sunflower | sunflower | Atlox | 29, 5, 6 | 600 | 45825 | −54.58 | 258.9 | 0.2508 |
| | | lecithin | CS100B | | | | | | |
| 1185 | sunflower | Emulfluid | | 29, 1, 0 | 600 | 46585 | −48.97 | 317.8 | 0.2552 |

As shown in FIG. 4E, distribution of NLP647-DCM and NLP655-DCM was observed in all tissues of root and mesocotyl cross sections of 10-day old corn plants treated by confocal microscopy, indicating that NLP647 and NLP655 exhibit robust uptake and distribution in corn plants. NLP647 and NLP655 showed strong root-to-shoot translocation of DCM, indicating systemicity. No evidence of uptake and distribution was observed in corn seedlings treated with non-encapsulated Exalite.

### Example 12. Evaluation of NLP Formulations Comprising PE Against FAW in a Hydroponic Corn Uptake Assay

This example describes a method to assess the protection offered by NLPs comprising encapsulated Permethrin (PE) as active in corn plants against a foliar lepidopteran pest, Fall armyworm (FAW) when administered via roots in a hydroponic assay.

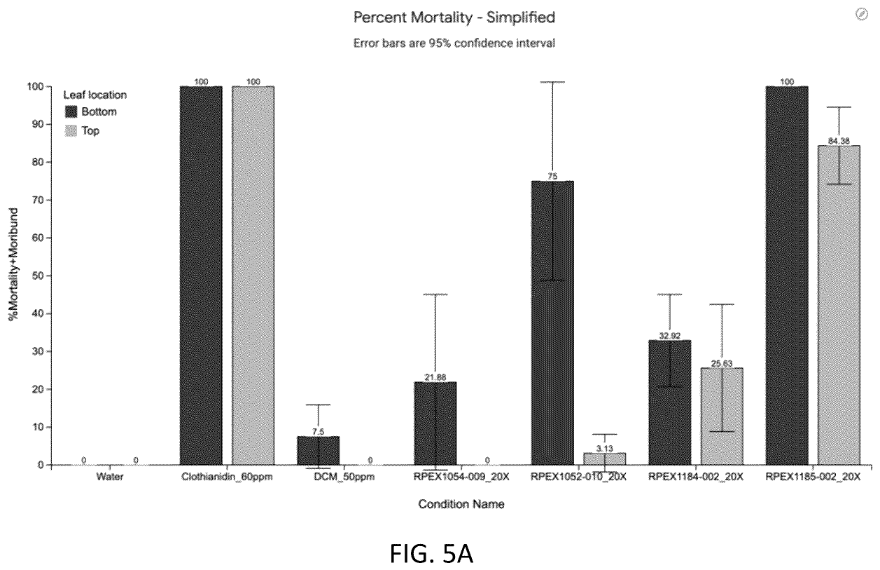

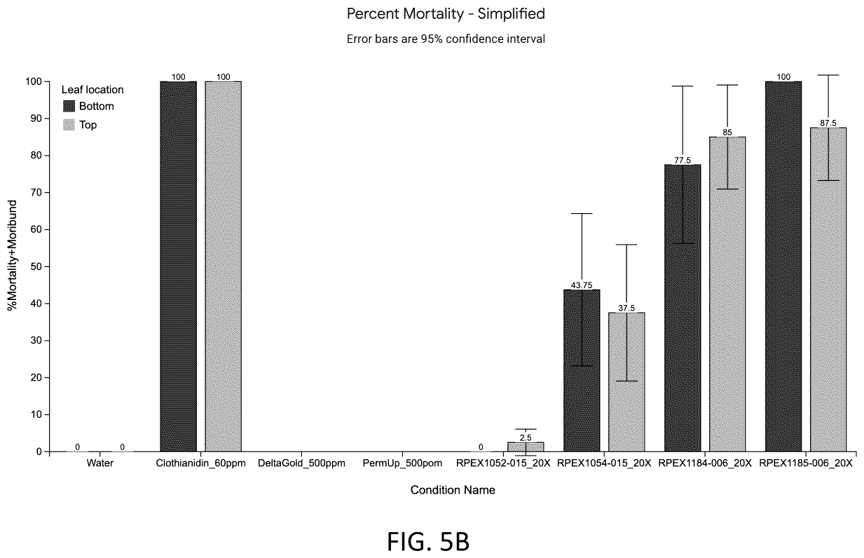

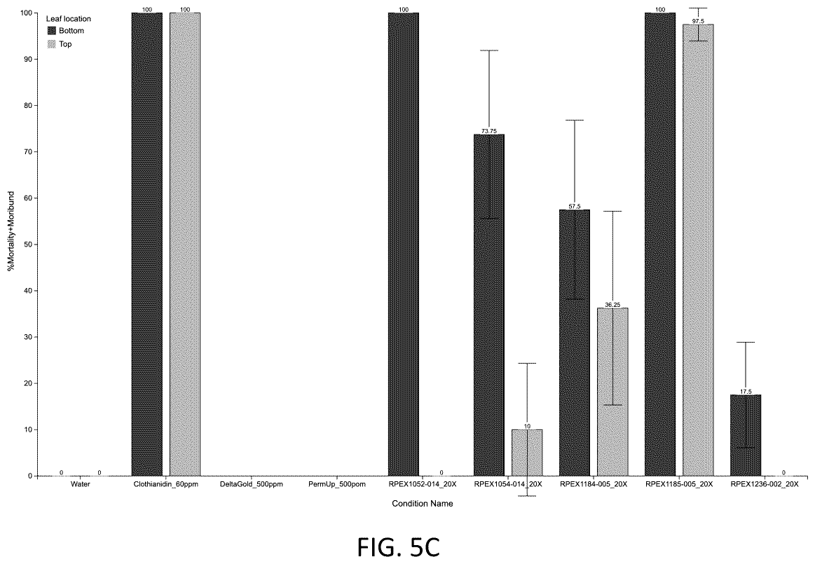

Selected NLP formulations which showed systemic distribution in Example 11 were utilized to encapsulate Permethrin and tested as described in Example 7 for mortality in Fall Army Worm. As shown in FIG. 5, corn seedlings treated with NLP1184, NLP1185, NLP1054 and NLP1052 encapsulated PE caused mortality when fed to FAW. The composition and physicochemical properties of PE-NLP compositions exhibiting FAW mortality is provided in Table 10.

TABLE 10
Composition and Physicochemical Properties of PE-NLPs exhibiting FAW mortality

| | | | | | DCM | DCM | Zeta | Diameter | |
|---|---|---|---|---|---|---|---|---|---|
| Formulation | NP | PL | SM | Ratio | (ug/ml) | fluorescence | potential | (nm) | PDI |
| 1052 | sunflower | Emulfluid | Atlox | 30, 1, 0 | 600 | 45490 | −48.12 | 388 | 0.3731 |
| | | | 550S | | | | | | |
| 1054 | sunflower | sunflower | Atlox | 6, 1, 1.2 | 600 | 32 | −54.2 | 277.9 | 0.4243 |
| | | lecithin | CS100B | | | | | | |
| 1184 | sunflower | sunflower | Atlox | 29, 5, 6 | 600 | 45825 | −54.58 | 258.9 | 0.2508 |
| | | lecithin | CS100B | | | | | | |
| 1185 | sunflower | Emulfluid | | 29, 1, 0 | 600 | 46585 | −48.97 | 317.8 | 0.2552 |

### ENUMERATED EMBODIMENTS

1. An agricultural composition comprising a plurality of nature-derived lipid particles (NLPs) each comprising: at least one essential oil; at least one phospholipid; and at least one surface modifier; wherein the NLPs comprise a hydrophobic core.

2. The agricultural composition of paragraph 1, wherein the essential oil is derived from a plant or plant part, and comprises at least one or more of a phenolic, alcoholic and terpenoid compound.

3. The agricultural composition of paragraph 1, wherein the essential oil is selected from the group consisting of cinnamon oil, tea tree oil, clove oil. Eucalyptus oil, hemp seed oil, patchouli oil, marjoram oil, thyme oil, sweet almond oil, cassia oil, lavender oil, basil oil, castor oil, pumpkinseed oil, citronella oil, cumin oil, amaranth oil, camphor oil, red raspberry oil, peanut oil, pine oil, tobacco oil, carrot seed oil, and spearmint oil.

4. The agricultural composition of paragraph 1, wherein the at least one essential oil is cinnamon oil.

5. The agricultural composition of paragraph 1, further comprising a non-polar lipid comprising at least one fatty acid.

6. The agricultural composition of paragraph 1, wherein the non-polar lipid comprising at least one fatty acid is soybean oil or sunflower oil.

7. The agricultural composition of paragraph 1, wherein the at least one phospholipid is selected from the group consisting of phosphatidylcholine, phosphatidylethanolamine, phosphatidylinositol, phosphatidic acid, phosphatidyl serine, and 1.2-dimyristoyl-sn-glycero-3-phosphate.

8. The agricultural composition of paragraph 1, wherein the at least one phospholipid is derived from a lecithin.

9. The agricultural composition of paragraph 3, wherein the lecithin is sunflower lecithin, soybean lecithin, or a synthetic lecithin.

10. The agricultural composition of paragraph 1, wherein the hydrophobic core comprises the essential oil.

11. The agricultural composition of paragraph 5, wherein the hydrophobic core comprises the at least one essential oil and the at least one non-polar lipid comprising at least one fatty acid.

12. The agricultural composition of paragraph 1, wherein the NLPs comprise at least one phospholipid layer.

13. The agricultural composition of paragraph 1, wherein the NLPs comprise at least one phospholipid bilayer.

14. The agricultural composition of paragraph 1, wherein the NLPs have a micellar structure.

15. The agricultural composition of paragraph 1, wherein the surface modifier is selected from the group consisting of a glycolipid, a polysaccharide, a fatty acid ethoxylate, a linear alcohol ethoxylate, a cetyl trimethyl, a linear isopropylamine dodecy benzene sulfonate, a tristyrlphenol ethoxylate phosphate ester, a modified styrene acrylic co-polymer, a hydrophobically modified polycarboxylate polymer, an anionic polymer, a non-ionic acrylic copolymer, a non-ionic combination polymer, a tristyrlphenol polyalkylene oxide block copolymer, or a head group modified PEG lipid.

16. The agricultural composition of paragraph 15, wherein the surface modifier is a modified styrene acrylic polymer.

17. The agricultural composition of paragraph 15, wherein the surface modifier is a nonionic comb polymer.

18. The agricultural composition of paragraph 1, wherein the surface modifier is integrated in the phospholipid layer.

19. The agricultural composition of paragraph 1, wherein the surface modifier stabilizes the integrity of the NLPs.

20. The agricultural composition of paragraph 1, wherein the NLPs exhibit a negative surface charge as evidenced from a negative zeta potential.

21. The agricultural composition of paragraph 20, wherein the negative zeta potential ranges between −5 and −100 m V.

22. The agricultural composition of paragraph 1, wherein the NLP particle size ranges between 50-1000 nm.

23. The agricultural composition of any of paragraph 1-22, wherein the composition further comprises at least one heterologous functional agent.

24. The agricultural composition of paragraph 23, wherein the heterologous functional agent is selected from the group consisting of a a pesticidal agent, a fertilizing agent, a herbicidal agent, a plant-modifying agent, an insect attractant, a plant growth promoting agent, a biostimulant, and a plant immunity elicitor. 25. The agricultural composition of paragraph 24, wherein the pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.

26. The agricultural composition of paragraph 25, wherein (a) the antifungal agent includes at least one of azoxystrobin, mancozeb, prothioconazole, folpet, tebuconazole, difenoconazole, captan, bupirimate, fosetyl-AI, a strobilurin, dimoxystrobin, enestroburin, fluoxastrobin, kresoxim-methyl, metominostrobin, picoxystrobin, pyraclostrobin, trifloxystrobin, orysastrobin, a carboxamide, a carboxanilide, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M, methfuroxam, metsulfovax, ofurace, oxadixyl, oxycarboxin, penthiopyrad, pyracarbolid, salicylanilide, tecloftalam, thifluzamide, tiadinil, an N-biphenylamide, bixafen, boscalid, a carboxylic acid morpholide, dimethomorph, flumorph, a benzamide, flumetover, fluopicolid, zoxamid, carpropamid, diclocymet, mandipropamid, silthiofam, an azole, a triazole, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, an imidazole, cyazofamid, imazalil, pefurazoate, prochloraz, triflumizole, a benzimidazole, benomyl, carbendazim, fuberidazole, thiabendazole, cthaboxam, ctridiazole, hymexazol, a pyridine, fuazinam, pyrifenox, pyrimidines, cyprodinil, ferimzone, fenarimol, mepanipyrim, nuarimol, pyrimethanil, a piperazine, triforine, a pyrrole, fludioxonil, fenpiclonil, a morpholine, aldimorph, dodemorph, fenpropimorph, tridemorph, a dicarboximide, iprodionc, procymidonc, vinclozolin, acibenzolar-S-methyl, anilazine, captafol, dazomet, diclomezin, fenoxanil, folpet, fenpropidin, famoxadon, fenamidon, octhilinone, probenazole, proquinazid, pyroquilon, quinoxyfen, tricyclazole, a carbamate, a dithiocarbamate, ferbam, maneb, metiram, metam, propineb, thiram, zineb, ziram, diethofencarb, flubenthiavalicarb, iprovalicarb, propamocarb, a guanidinc, dodinc, iminoctadine, guazatine, kasugamycin, a polyoxin, streptomycin, validamycin A, a fentin salt, a sulfur-containing heterocyclyl compound, isoprothiolanc, dithianone, an organophosphorous compound, cdifenphos, fosctyl, fosctyl-aluminum, iprobenfos, pyrazophos, tolclofos-methyl, an organochlorine compound, thiophanate-methyl, chlorothalonil, dichlofluanid, tolylfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon. N-2-cyanophenyl-3.4-dichloroisothiazol-5-carboxamidc. N-(3′0.4′,5′-trifluorobiphenyl-2-yl)-3-difluoromethyl-1-methylpyrazole-4-carboxamide. 3-[5-(4-chlorophenyl)-2.3-dimethy lisoxazolidin-3-yl]-pyridine. N-(3′0.4′-dichloro-4-fluorobiphenyl-2-yl)-3-difluoromethyl-1-methylpyrazol-e-4-carboxamide. 5-chloro-7-(4-methylpiperidin-1-yl)-6-(2.4.6-trifluorophenyl)-]1.2.4]tria-zolo] 1.5-a]pyrimidinc. 2-butoxy-6-iodo-3-propy lchromen-4-one. N,N-dimethyl-3-(3-bromo-6-fluoro-2-methylindole-1-sulfonyl)-]1.2.4]triazo-le-1-sulfonamide, methyl-(2-chloro-5-[1-(3-methylbenzyloxyimino)-ethyl]benzyl) carbamate, methyl-(2-chloro-5-[1-(6-methylpyrid in-2-ylmethoxy-imino)ethyl]benzyl) carbamate, methyl 3-(4-chlorophenyl)-3-(2-isopropoxy carbonylamino-3-methyl butyryl-amino) propionate. 4-fluorophenyl N-(1-(1-(4-cyanophenyl) cthanesulfonyl) but-2-yl) carbamate. N-(2-(4-[3-(4-chlorophenyl) prop-2-ynyloxy]-3-methoxyphenyl)ethyl)-2-metha-nesulfonylamino-3-methylbutyramide. N-(2-(4-[3-(4-chlorophenyl) prop-2-ynyloxy]-3-methoxyphenyl)ethyl)-2-ethan-esulfonylamino-3-methylbutyramide. N-(4′-bromobiphenyl-2-yl)-4-difluoromethyl-2-methylthiazol-5-carboxamide. N-(4′-trifluoromethylbiphenyl-2-yl)-4-difluoromethyl-2-methylthiazol-5-carboxamide. N-(4′-chloro-3′-fluorobiphenyl-2-yl)-4-difluoromethyl-2-methylt-hiazol-5-carboxamide, methyl 2-(ortho-((2.5-dimethylphenyloxy-methylene) phenyl)-3-methoxyacrylate, oxathiapiprolin, and esters and salts thereof: (b) the antibacterial agent includes at least one of a hypochlorite, sodium hypochlorite, a chloramine, dichloroisocyanurate, trichloroisocyanurate, wet chlorine, chlorine dioxide, a peroxide, peracetic acid, potassium persulfate, sodium perborate, sodium percarbonate, urea perhydrate, iodine, iodpovidone, ethanol. 1-propanol. 2-propanol. 2-phenoxyethanol, phenol, a cresol, a halogenated phenol, hexachlorophene, triclosan, trichlorophenol, tribromophenol, pentachlorophenol, a cationic surfactant, benzalkonium chloride, cetyl trimethylammonium bromide, cetyl trimethylammonium chloride, didecy ldimethylammonium chloride, cetylpyridinium chloride, benzethonium chloride, chlorhexidine, glucoprotamine, octenidine dihydrochloride, an ozone solution, colloidal silver, silver nitrate, mercury chloride, phenylmercury salts, copper sulfate, copper oxide-chloride, copper hydroxide, copper octanoate, copper oxychloride sulfate, copper sulfate pentahydrate, phosphoric acid, nitric acid, sulfuric acid, amidosulfuric acid, toluenesulfonic acid, sodium hydroxide, potassium hydroxide, calcium hydroxide, sorbic acid, benzoic acid, lactic acid, salicylic acid, a penicillin, a cephalosporin, vancomycin, a polymyxin, a rifamycin, a lipiarmycin, a quinolone, a sulfonamide, an aminoglycoside, kasugamycin, a macrolide, a lincosamide, a tetracycline, a cyclic lipopeptide, daptomycin, a glycylcycline, tigecycline, an oxazolidinone, linczolid, fidaxomicin, rifampicin, ciprofloxacin, doxycycline, ampicillin, polymyxin B, gramicidin, isoniazid, pyrazinamide, ethambutol, myambutol, streptomycin, and esters and salts thereof: (c) the insecticidal agent includes at least one of a chloronicotinyl, a neonicotinoid, acetamiprid, clothianidin, dinotefuran, imidacloprid, nitenpyram, nithiazine, thiacloprid, thiamethoxam, imidaclothiz. (2E)-1-[(2-chloro-1.3-thiazol-5-yl)methyl]-3,5-dimethyl-N-nitro-1.3.5-tri-azinan-2-imine, an acetylcholinesterase (AChE) inhibitor, a carbamate, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chlocthocarb, dimetilan, cthiofencarb, fenobucarb, fenothiocarb, formetanate, furathiocarb, isoprocarb, metam-sodium, methiocarb, methomyl, metolcarb, oxamyl, phosphocarb, pirimicarb, promecarb, propoxur, thiodicarb, thiofanox, triazamate, trimcthacarb. XMC, xylylcarb, an organophosphate, acephate, azamethiphos, azinphos (-methyl.-ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton. EPN, cthion, ethoprophos, ctrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propctamphos, prothiofos, prothoate, pyraclofos, pyridaphenthion, pyridathion, quinalphos, sebufos, sulfotcp, sulprofos, tebupirimfos, temephos, terbufos, tetrachlorvinphos, thiometon, triazophos, triclorfon, vamidothion, a pyrethroid, acrinathrin, allethrin (d-cis-trans, d-trans), cypermethrin (alpha-, beta-, theta-, zeta-), permethrin (cis-, trans-), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cyphenothrin. DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda, metofluthrin, phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralocythrin, tralomethrin, transfluthrin. ZXI 8901, a pyrethrin, pyrethrum, an oxadiazine, indoxacarb, an acetylcholine receptor modulator, a spinosyn. Spinosad, a cyclodiene, camphechlor, chlordane, endosulfan, gamma-HCH. HCH, heptachlor, an organochlorine, lindane, methoxychlor, a fiprole, acetoprole, ethiprole, vaniliprole, fipronil, a mectin, abamectin, avermectin, emamectin, emamectin-benzoate, fenoxycarb, hydroprene, kinoprene, methoprenc, ivermectin, lepimectin, epofenonane, pyriproxifen, milbemectin, milbemycin, triprene, a diacy lhydrazine, chromafenozide, halofenozide, methoxyfenozide, tebufenozide, a benzoylurca, bistrifluoron, chlorfluazuron, diflubenzuron, fluazuron, flucycloxuron, flufenoxuron, hexaflumuron, lufenuron, novaluron, noviflumuron, penfluoron, teflubenzuron, triflumuron, an organotin, azocyclotin, cyhexatin, fenbutatin oxide, a pyrrole, chlorfenapyr, a dinitrophenol, binapacyrl, dinobuton, dinocap. DNOC, a METI, fenazaquin, fenpyroximate, pyrimidifen, pyridaben, tebufenpyrad, tolfenpyrad, rotenone, acequinocyl, fluacrypyrim, a microbial disrupter of the intestinal membrane of insects, a Bacillus thuringiensis strain, an inhibitor of lipid synthesis, a tetronic acid, a tetramic acid, spirodiclofen, spiromesifen, spirotetramat, cis-3-(2.5-dimethylphenyl)-8-methoxy-2-oxo-1-azaspi ro [4.5]dec-3-en-4-yl ethyl carbonate, a carboxamide, flonicamid, an octopaminergic agonist, amitraz, an inhibitor of the magnesium-stimulated ATPase, propargite, a ryanodin receptor agonist, a phthalamide, rynaxapyr. N2-[1.1-dimethyl-2-(methylsulphonyl)ethyl]-3-iodo-N1-]2-methyl--4-[1.2.2.2-tetrafluoro-1-(trifluoromethyl)ethyl]phenyl]-1.2-benzenedi-carboxamide, spidoxamat, nicofluprole, tetraniliprolc, tioxazafen, flupyradifuron, fluopyram, flubendiamide, deltametrin, permethrin, dimpropyridaz, broflanilide, afidopyropen, fluopyram, fluazaindolizinc, triflumezopyrim, sulfoxaflor, spinctoram, chlorpyrifos, spinosad, cyantraniliprole, chlorantraniliprole, cypermethrin, plinazolin, cyclobutrifluram, spiropidion, fluensulfone, pymetrozinc, thiamethoxam, lamda cyhalothrin, oxazosulfyl, benzpyrimoxan, dichloromezotiaz, flupentiofenox, fluhexafon, fluxametamide, flupyrimin, cyhalodiamide, acynonapyr, cyclaniliprole, cyetpyrafen, cyproflanilide, tetrachlorantraniliprole, isocycloscram, broflanilide, spiropidion, and esters and salts thereof: (d) the molluscicidal agent includes at least one of a metal salt, iron phosphate, aluminium sulfate, ferric sodium EDTA, metaldehyde, mcthiocarb, and an acetylcholinesterase inhibitor: (c) the nematicidal agent includes at least one of a fumigant. D-D,1.3-dichloropropene, ethylene dibromide. 1.2-dibromo-3-chloropropane, methyl bromide, chloropicrin, metam sodium, dazomet, methyl Isothiocyanate (MITC), sodium tetrathiocarbonate, a carbamate, aldicarb, aldoxycarb, carbofuran, oxamyl, cleothocarb, an organophosphate, ethoprophos, fenamiphos, cadusafos, fosthiazate, fensulfothion, thionazin, Isazofos, and a biochemical; and (f) the herbicidal agent includes at least one of glufosinate, propaquizafop, metamitron, metazachlor, pendimethalin, flufenacet, diflufenican, clomazonc, nicosulfuron, mesotrione, pinoxaden, sulcotrione, prosulfocarb, sulfentrazone, bifenox, quinmerac, triallate, terbuthylazine, atrazine, oxyfluorfen, diuron, trifluralin, chlorotoluron, a benzoic acid herbicide, dicamba, a phenoxyalkanoic acid herbicide. 2.4-D. MCPA, a 2.4-DB ester, an aryloxyphenoxypropionic acid herbicide, clodinafop, cyhalofop, fenoxaprop, fluazifop, haloxyfop, a quizalofop ester, a pyridinecarboxy lic acid herbicide, aminopyralid, picloram, a clopyralid ester, a pyrimidinecarboxy lic acid herbicide, an aminocyclopyrachlor ester, a pyridyloxyalkanoic acid herbicide, fluoroxypyr, triclopyr, a hydroxy benzonitrile herbicide, bromoxynil, ioxynil, an arylpyridine carboxy lic acid, an arylpyrimidine carboxylic acid, acetochlor, acifluorfen, alachlor, ametryn, amitrole, asulam, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate. DCPA, desmedipham, dichlobenil, diclofop, diclosulam, diethatyl, difenzoquat, diflufenzopyr, dimethenamid-p, diquat. DSMA, endothall. EPTC, ethalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glyphosate, halosulfuron, haloxyfop, hexazinone, imazamethabenz, imazamox, imazapic, imazaquin, imazethapyr, isoxaben, isoxaflutole, lactofen, linuron. MCPB, methazole, metolachlor-s, metribuzin, metsulfuron, molinate, MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triflusulfuron, vernolate, and esters and salts thereof.

27. The agricultural composition of paragraph 23, wherein the heterologous functional agent is hydrophobic.

28. The agricultural composition of paragraph 23, wherein the heterologous functional agent is chlorantraniliprole (CTPR).

29. The agricultural composition of any of paragraphs 23-26, wherein the heterologous functional agent is fully soluble in the essential oil.

30. The agricultural composition of any of paragraphs 23-26, wherein the heterologous functional agent is fully dissolved in the essential oil.

31. The agricultural composition of any of paragraphs 23-26, wherein the heterologous functional agent is fully dissolved in the hydrophobic core.

32. The agricultural composition of any of paragraphs 23-26, wherein the heterologous functional agent is encapsulated in the NLP.

33. The agricultural composition of any of paragraphs 23-26, wherein the essential oil increases the encapsulation efficiency of the heterologous functional agent in the NLP.

34. The agricultural composition of paragraph 33, wherein the essential oil is cinnamon oil. 35. The agricultural composition of paragraph 33, wherein the encapsulation efficiency is 100%.

36. The agricultural composition of paragraph 1, wherein the composition is formulated for delivery to a plant, a plant part, or a plant pest.

37. The agricultural composition of paragraph 1, further comprising an agriculturally acceptable carrier.

38. The agricultural composition of paragraph 1, wherein the heterologous functional agent is a volatile agent.

39. An agricultural composition for increasing the solubility of a hydrophobic heterologous functional agent, comprising a plurality of NLPs each comprising: at least one essential oil; at least one phospholipid; and at least one surface modifier; and a heterologous functional agent wherein the NLPs comprise a hydrophobic core.

40. An agricultural composition, comprising a plurality of NLPs each comprising; soybean or sunflower lecithin: cinnamon oil; a nonionic, polymeric dispersant or a modified styrene acrylic polymer; and CTPR: wherein the NLPs comprise a hydrophobic core, and wherein the percent of cinnamon oil in the NLPs is at least 50% (w/w).

41. A method of making an agricultural composition comprising a plurality of NLPs each comprising a heterologous functional agent, the method comprising the step of: applying energy to a solution comprising: at least one phospholipid: at least one essential oil; at least one surface modifier; a heterologous functional agent; and an aqueous solution; thereby forming the NLPs, wherein the NLPs comprise a hydrophobic core.

42. An agricultural composition for increasing the uptake of a hydrophobic heterologous functional agent in a plant, the composition comprising a plurality of NLPs each comprising: at least one non-polar lipid comprising at least one fatty acid: at least one phospholipid or a synthetic lecithin derivative; and at least one heterologous functional agent; wherein the NLPs comprise a hydrophobic core.

43. The agricultural composition of paragraph 42, wherein the synthetic lecithin derivative is a lysophosphatidylcholine analog.

44. The agricultural composition of paragraph 42, further comprising an essential oil.

45. The agricultural composition of paragraph 44, wherein the essential oil is spearmint oil or thyme oil.

46. The agricultural composition of any of paragraphs 42-45, further comprising at least one surface modifier.

47. The agricultural composition of paragraph 45, wherein the surface modifier is a hydrophobically modified polycarboxylate or a modified styrene acrylic polymer.

48. The agricultural composition of paragraph 42, wherein the surface charge of the NLPs range between −20 to 60 mV.

49. The agricultural composition of paragraph 49, wherein the size of the NLPs range 150 and 450 nm.

50. The agricultural composition of paragraph 42, wherein the heterologous functional agent is selected from the group consisting of a pesticidal agent, a fertilizing agent, a herbicidal agent, a plant-modifying agent, an insect attractant, a plant growth promoting agent, a biostimulant, and a plant immunity elicitor.

51. The agricultural composition of paragraph 50, wherein the pesticidal agent is selected from the group consisting of an antifungal agent, an anti-oomycete agent, an antibacterial agent, an insecticidal agent, a molluscicidal agent, a nematicidal agent, a herbidical agent, and a virucidal agent.

52. The agricultural composition of paragraph 51, wherein (a) the antifungal agent includes at least one of azoxystrobin, mancozeb, prothioconazole, folpet, tebuconazole, difenoconazole, captan, bupirimate, fosetyl-AI, a strobilurin, dimoxystrobin, enestroburin, fluoxastrobin, kresoxim-methyl, metominostrobin, picoxystrobin, pyraclostrobin, trifloxystrobin, orysastrobin, a carboxamide, a carboxanilide, benalaxyl, benalaxyl-M, benodanil, carboxin, mebenil, mepronil, fenfuram, fenhexamid, flutolanil, furalaxyl, furcarbanil, furametpyr, metalaxyl, metalaxyl-M, methfuroxam, metsulfovax, ofurace, oxadixyl, oxycarboxin, penthiopyrad, pyracarbolid, salicylanilide, tecloftalam, thifluzamide, tiadinil, an N-biphenylamide, bixafen, boscalid, a carboxylic acid morpholide, dimethomorph, flumorph, a benzamide, flumetover, fluopicolid, zoxamid, carpropamid, diclocymet, mandipropamid, silthiofam, an azole, a triazole, bitertanol, bromuconazole, cyproconazole, diniconazole, enilconazole, epoxiconazole, fenbuconazole, flusilazol, fluquinconazole, flutriafol, hexaconazole, imibenconazole, ipconazole, metconazole, myclobutanil, penconazole, propiconazole, prothioconazole, simeconazole, tetraconazole, triadimenol, triadimefon, triticonazole, an imidazole, cyazofamid, imazalil, pefurazoate, prochloraz, triflumizole, a benzimidazole, benomyl, carbendazim, fuberidazole, thiabendazole, ethaboxam, etridiazole, hymexazol, a pyridine, fuazinam, pyrifenox, pyrimidines, cyprodinil, ferimzone, fenarimol, mepanipyrim, nuarimol, pyrimethanil, a piperazine, triforine, a pyrrole, fludioxonil, fenpiclonil, a morpholine, aldimorph, dodemorph, fenpropimorph, tridemorph, a dicarboximide, iprodione, procymidone, vinclozolin, acibenzolar-S-methyl, anilazine, captafol, dazomet, diclomezin, fenoxanil, folpet, fenpropidin, famoxadon, fenamidon, octhilinone, probenazole, proquinazid, pyroquilon, quinoxyfen, tricyclazole, a carbamate, a dithiocarbamate, ferbam, maneb, metiram, metam, propineb, thiram, zineb, ziram, diethofencarb, flubenthiavalicarb, iprovalicarb, propamocarb, a guanidine, dodine, iminoctadine, guazatine, kasugamycin, a polyoxin, streptomycin, validamycin A, a fentin salt, a sulfur-containing heterocyclyl compound, isoprothiolane, dithianone, an organophosphorous compound, edifenphos, fosetyl, fosctyl-aluminum, iprobenfos, pyrazophos, tolclofos-methyl, an organochlorine compound, thiophanate-methyl, chlorothalonil, dichlofluanid, tolylfluanid, flusulfamide, phthalide, hexachlorobenzene, pencycuron, quintozene, nitrophenyl derivatives, binapacryl, dinocap, dinobuton, spiroxamine, cyflufenamid, cymoxanil, metrafenon. N-2-cyanophenyl-3.4-dichloroisothiazol-5-carboxamide. N-(3′0.4′0.5′-trifluorobiphenyl-2-yl)-3-difluoromethyl-1-methylpyrazole-4-carboxamide. 3-[5-(4-chlorophenyl)-2.3-dimethy lisoxazolidin-3-yl]-pyridine. N-(3′0.4′-dichloro-4-fluorobiphenyl-2-yl)-3-difluoromethyl-1-methylpyrazol-e-4-carboxamide. 5-chloro-7-(4-methylpiperidin-1-yl)-6-(2.4.6-trifluorophenyl)-[1.2.4] tria-zolo [1.5-a]pyrimidine. 2-butoxy-6-iodo-3-propy lchromen-4-one. N,N-dimethyl-3-(3-bromo-6-fluoro-2-methylindole-1-sulfonyl)-[1.2.4]triazo-le-1-sulfonamide, methyl-(2-chloro-5-[1-(3-methylbenzyloxyimino)-ethyl]benzyl) carbamate, methyl-(2-chloro-5-[1-(6-methylpyrid in-2-ylmethoxy-imino)ethyl]benzyl) carbamate, methyl 3-(4-chlorophenyl)-3-(2-isopropoxy carbonylamino-3-methyl butyryl-amino) propionate. 4-fluorophenyl N-(1-(1-(4-cyanophenyl) cthanesulfonyl) but-2-yl) carbamate. N-(2-(4-[3-(4-chlorophenyl) prop-2-ynyloxy]-3-methoxyphenyl)ethyl)-2-metha-nesulfonylamino-3-methylbutyramide. N-(2-(4-[3-(4-chlorophenyl) prop-2-ynyloxy]-3-methoxy phenyl)ethyl)-2-ethan-esulfonylamino-3-methylbutyramide. N-(4′-bromobiphenyl-2-yl)-4-difluoromethyl-2-methylthiazol-5-carboxamide. N-(4′-trifluoromethylbiphenyl-2-yl)-4-difluoromethyl-2-methylthiazol-5-carboxamide. N-(4′-chloro-3′-fluorobiphenyl-2-yl)-4-difluoromethyl-2-methylt-hiazol-5-carboxamide, methyl 2-(ortho-((2.5-dimethylphenyloxy-methylene)phenyl)-3-methoxyacrylate, oxathiapiprolin, and esters and salts thereof: (b) the antibacterial agent includes at least one of a hypochlorite, sodium hypochlorite, a chloramine, dichloroisocyanurate, trichloroisocyanuratc, wet chlorine, chlorine dioxide, a peroxide, peracetic acid, potassium persulfate, sodium perborate, sodium percarbonate, urea perhydrate, iodine, iodpovidone, ethanol. 1-propanol. 2-propanol. 2-phenoxyethanol, phenol, a cresol, a halogenated phenol, hexachlorophene, triclosan, trichlorophenol, tribromophenol, pentachlorophenol, a cationic surfactant, benzalkonium chloride, cetyl trimethylammonium bromide, cetyl trimethylammonium chloride, didecy ldimethylammonium chloride, cetylpyridinium chloride, benzethonium chloride, chlorhexidine, glucoprotamine, octenidine dihydrochloride, an ozone solution, colloidal silver, silver nitrate, mercury chloride, phenylmercury salts, copper sulfate, copper oxide-chloride, copper hydroxide, copper octanoate, copper oxychloride sulfate, copper sulfate pentahydrate, phosphoric acid, nitric acid, sulfuric acid, amidosulfuric acid, toluenesulfonic acid, sodium hydroxide, potassium hydroxide, calcium hydroxide, sorbic acid, benzoic acid, lactic acid, salicylic acid, a penicillin, a cephalosporin, vancomycin, a polymyxin, a rifamycin, a lipiarmycin, a quinolone, a sulfonamide, an aminoglycoside, kasugamycin, a macrolide, a lincosamide, a tetracycline, a cyclic lipopeptide, daptomycin, a glycylcycline, tigecycline, an oxazolidinone, linezolid, fidaxomicin, rifampicin, ciprofloxacin, doxycycline, ampicillin, polymyxin B, gramicidin, isoniazid, pyrazinamide, ethambutol, myambutol, streptomycin, and esters and salts thereof: (c) the insecticidal agent includes at least one of a chloronicotinyl, a neonicotinoid, acctamiprid, clothianidin, dinotefuran, imidacloprid, nitenpyram, nithiazinc, thiacloprid, thiamethoxam, imidaclothiz. (2E)-1-[(2-chloro-1.3-thiazol-5-yl)methyl]-3.5-dimethyl-N-nitro-1.3.5-tri-azinan-2-imine, an acetylcholinesterase (AChE) inhibitor, a carbamate, alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, chlocthocarb, dimetilan, cthiofencarb, fenobucarb, fenothiocarb, formetanate, furathiocarb, isoprocarb, metam-sodium, methiocarb, methomyl, metolcarb, oxamyl, phosphocarb, pirimicarb, promecarb, propoxur, thiodicarb, thiofanox, triazamatc, trimcthacarb. XMC, xylylcarb, an organophosphate, acephate, azamethiphos, azinphos (-methyl.-ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, demeton-S-methyl, demeton-S-methylsulphon, dialifos, diazinon, dichlofenthion, dichlorvos/DDVP, dicrotophos, dimethoate, dimethylvinphos, dioxabenzofos, disulfoton. EPN, cthion, cthoprophos, ctrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propctamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion, a pyrethroid, acrinathrin, allethrin (d-cis-trans, d-trans), cypermethrin (alpha-, beta-, theta-, zeta-), permethrin (cis-, trans-), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cyphenothrin, DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cy halothrin, imiprothrin, kadethrin, lambda, metofluthrin, phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralocythrin, tralomethrin, transfluthrin. ZXI 8901, a pyrethrin, pyrethrum, an oxadiazine, indoxacarb, an acetylcholine receptor modulator, a spinosyn. Spinosad, a cyclodiene, camphechlor, chlordane, endosulfan, gamma-HCH. HCH, heptachlor, an organochlorine, lindane, methoxychlor, a fiprole, acetoprole, cthiprole, vaniliprole, fipronil, a mectin, abamectin, avermectin, emamectin, emamectin-benzoate, fenoxycarb, hydroprene, kinoprene, methoprenc, ivermectin, lepimectin, epofenonane, pyriproxifen, milbemectin, milbemycin, triprene, a diacy lhydrazine, chromafenozide, halofenozide, methoxyfenozide, tebufenozide, a benzoylurea, bistrifluoron, chlorfluazuron, diflubenzuron, fluazuron, flucycloxuron, flufenoxuron, hexaflumuron, lufcnuron, novaluron, noviflumuron, penfluoron, teflubenzuron, triflumuron, an organotin, azocyclotin, cyhexatin, fenbutatin oxide, a pyrrole, chlorfenapyr, a dinitrophenol, binapacyrl, dinobuton, dinocap. DNOC, a METI, fenazaquin, fenpyroximate, pyrimidifen, pyridaben, tebufenpyrad, tolfenpyrad, rotenone, acequinocyl, fluacrypyrim, a microbial disrupter of the intestinal membrane of insects, a Bacillus thuringiensis strain, an inhibitor of lipid synthesis, a tetronic acid, a tetramic acid, spirodiclofen, spiromesifen, spirotetramat, cis-3-(2.5-dimethylphenyl)-8-methoxy-2-oxo-1-azaspi ro [4.5]dec-3-en-4-yl ethyl carbonate, a carboxamide, flonicamid, an octopaminergic agonist, amitraz, an inhibitor of the magnesium-stimulated ATPasc, propargite, a ryanodin receptor agonist, a phthalamide, rynaxapyr. N2-[1, 1-dimethyl-2-(methylsulphonyl)ethyl]-3-iodo-N1-[2-methyl--4-[1.2.2.2-tetrafluoro-1-(trifluoromethyl)ethyl]phenyl]-1.2-benzenedi-carboxamide, spidoxamat, nicofluprole, tetraniliprole, tioxazafen, flupyradifuron, fluopyram, flubendiamide, deltametrin, permethrin, dimpropyridaz, broflanilide, afidopyropen, fluopyram, fluazaindolizinc, triflumczopyrim, sulfoxaflor, spinctoram, chlorpyrifos, spinosad, cyantraniliprole, chlorantraniliprole, cypermethrin, plinazolin, cyclobutrifluram, spiropidion, fluensulfone, pymetrozinc, thiamethoxam, lamda cyhalothrin, oxazosulfyl, benzpyrimoxan, dichloromezotiaz, flupentiofenox, fluhexafon, fluxametamide, flupyrimin, cyhalodiamide, acynonapyr, cyclaniliprole, cyetpyrafen, cyproflanilide, tetrachlorantraniliprole, isocycloscram, broflanilide, spiropidion, and esters and salts thereof: (d) the molluscicidal agent includes at least one of a metal salt, iron phosphate, aluminium sulfate, ferric sodium EDTA, metaldehyde, mcthiocarb, and an acetylcholinesterase inhibitor: (c) the nematicidal agent includes at least one of a fumigant. D-D,1.3-dichloropropene, ethylene dibromide. 1.2-dibromo-3-chloropropane, methyl bromide, chloropicrin, metam sodium, dazomet, methyl Isothiocyanate (MITC), sodium tetrathiocarbonate, a carbamate, aldicarb, aldoxycarb, carbofuran, oxamyl, cleothocarb, an organophosphate, cthoprophos, fenamiphos, cadusafos, fosthiazate, fensulfothion, thionazin, Isazofos, and a biochemical; and (f) the herbicidal agent includes at least one of glufosinate, propaquizafop, metamitron, metazachlor, pendimethalin, flufenacet, diflufenican, clomazone, nicosulfuron, mesotrione, pinoxaden, sulcotrione, prosulfocarb, sulfentrazone, bifenox, quinmerac, triallate, terbuthylazine, atrazine, oxyfluorfen, diuron, trifluralin, chlorotoluron, a benzoic acid herbicide, dicamba, a phenoxyalkanoic acid herbicide. 2.4-D. MCPA, a 2.4-DB ester, an aryloxy phenoxypropionic acid herbicide, clodinafop, cyhalofop, fenoxaprop, fluazifop, haloxyfop, a quizalofop ester, a pyridinecarboxy lic acid herbicide, aminopyralid, picloram, a clopyralid ester, a pyrimidinecarboxy lic acid herbicide, an aminocyclopyrachlor ester, a pyridyloxyalkanoic acid herbicide, fluoroxypyr, triclopyr, a hydroxy benzonitrile herbicide, bromoxynil, ioxynil, an arylpyridine carboxy lic acid, an arylpyrimidine carboxylic acid, acetochlor, acifluorfen, alachlor, ametryn, amitrole, asulam, azafenidin, benefin, bensulfuron, bensulide, bentazon, bromacil, butylate, carfentrazone, chloramben, chlorimuron, chlorproham, chlorsulfuron, clethodim, clopyralid, cloransulam, cyanazine, cycloate. DCPA, desmedipham, dichlobenil, diclofop, diclosulam, diethatyl, difenzoquat, diflufenzopyr, dimethenamid-p, diquat. DSMA, endothall. EPTC, ethalfluralin, ethametsulfuron, ethofumesate, fluazifop-P, flucarbazone, flumetsulam, flumiclorac, flumioxazin, fluometuron, fluroxypyr, fluthiacet, fomesafen, foramsulfuron, glyphosate, halosulfuron, haloxyfop, hexazinone, imazamethabenz, imazamox, imazapic, imazaquin, imazethapyr, isoxaben, isoxaflutole, lactofen, linuron, MCPB, methazole, metolachlor-s, metribuzin, metsulfuron, molinate. MSMA, napropamide, naptalam, norflurazon, oryzalin, oxadiazon, oxasulfuron, oxyfluorfen, paraquat, pebulate, pelargonic acid, pendimethalin, phenmedipham, primisulfuron, prodiamine, prometryn, pronamide, propachlor, propanil, prosulfuron, pyrazon, pyridate, pyrithiobac, quinclorac, quizalofop, rimsulfuron, sethoxydim, siduron, simazine, sulfometuron, sulfosulfuron, tebuthiuron, terbacil, thiazopyr, thifensulfuron, thiobencarb, tralkoxydim, triallate, triasulfuron, tribenuron, triflusulfuron, vernolate, chlorantraniliprole, and esters and salts thereof.

53. The agricultural composition of paragraph 42, wherein the heterologous functional agent is hydrophobic.

54. The agricultural composition of paragraph 42, wherein the at least one heterologous functional agent is a pyrethroid.

55. The agricultural composition of paragraph 54, wherein the pyrethroid is permethrin.

56. The agricultural composition of paragraph 42, wherein the at least one heterologous functional agent is pyrethroid and deltamethrin.

57. The agricultural composition of paragraph 55, wherein the concentration of permethrin is about 10-100 mg/ml.

58. The agricultural composition of any of paragraphs 42-52, wherein the heterologous functional agent is fully dissolved in the hydrophobic core.

59. The agricultural composition of any of paragraphs 42-52, wherein the heterologous functional agent is encapsulated in the NLP.

60. An agricultural composition comprising a plurality of NLPs each comprising; sunflower oil or a sunflower-spearmint oil blend; sunflower lecithin or a modified lecithin: at least one hydrophobic heterologous functional agent; and optionally, a hydrophobically modified polycarboxylate or modified styrene acrylic polymer: wherein the NLPs comprise a hydrophobic core.

61. An agricultural composition comprising a plurality of nature-derived lipid particles (NLPs) each comprising; sunflower oil; a synthetic lecithin derivative; and at least one hydrophobic heterologous functional agent; wherein the NLPs comprise a hydrophobic core.

62. The composition of paragraph 61, wherein the synthetic lecithin derivative is a lysophosphatidylcholine analog.

63. An agricultural composition comprising a plurality of NLPs each comprising; sunflower oil; sunflower lecithin; a hydrophobically modified polycarboxylate; and at least one hydrophobic heterologous functional agent; wherein the NLPs comprise a hydrophobic core.

64. An agricultural composition comprising a plurality of NLPs each comprising; a sunflower-spearmint oil blend; a synthetic lecithin derivative; a modified styrene acrylic polymer; and at least one hydrophobic heterologous functional agent; wherein the NLPs comprise a hydrophobic core.

65. The composition of paragraph 64, wherein the synthetic lecithin derivative is a lysophosphatidylcholine analog.

66. The composition of any of paragraphs 42-65, wherein the composition comprises an agriculturally acceptable carrier.

67. A method of making an agricultural composition comprising a plurality of NLPs each comprising a heterologous functional agent, the method comprising the step of: applying energy to a solution comprising; sunflower oil or a sunflower-spearmint oil blend; sunflower lecithin or a modified lecithin: at least one hydrophobic heterologous functional agent; optionally, a hydrophobically modified polycarboxylate or a modified styrene acrylic polymer; and an aqueous solution; thereby forming the NLPs, wherein the NLPs comprise a hydrophobic core.

68. A method of increasing the uptake of a heterologous functional agent in a plant, the method comprising contacting the plant with any of the compositions of paragraphs 42-64, wherein the uptake of the heterologous functional agent is increased compared to the uptake of the same heterologous functional agent contacted with the plant in an unencapsulated form.

69. The method of paragraph 68, wherein the plant is a corn plant.

70. The method of paragraph 69, wherein the composition comprising a plurality of NLPs is contacted with the corn seedlings in a hydroponic system.

71. The method of paragraph 70, wherein the heterologous functional agent is detectable in the shoots of the corn within 7 days of contacting the roots in the hydroponic system with the composition comprising the plurality of NLPs.

72. A method of reducing the viability of foliar insect pest, the method comprising: applying to soil infested with root worm any of the compositions of paragraphs 42-64, wherein the heterologous functional agent contacts the foliar insect pest, thereby reducing the viability of the foliar insect pest.

73. The method of paragraph 72, wherein the foliar insect pest is a lepidopteran, coleopteran, hemipteran insect pest.

74. The method of paragraph 72, wherein the foliar insect pest is a fall army worm.

75. The method of paragraph 72, wherein the NLP composition is applied to soil as a soil drench.

76. The method of paragraph 72, wherein the NLP composition is applied to soil in furrow.

77. The method of paragraph 72, wherein the NLP composition is applied to a plant part.

78. A method of treating a disease in a plant, the method comprising contacting the plant with any of the compositions of paragraphs 42-64, thereby treating the disease in the plant.

79. A method of preventing a plant from developing a disease, the method comprising contacting the plant with any of the compositions of paragraphs 42-64, thereby preventing disease development.

80. A kit comprising an agricultural composition, the composition comprising a plurality of NLPs each comprising: at least one essential oil; at least one phospholipid; at least one surface modifier; and a heterologous functional agent; wherein the NLPs comprise a hydrophobic core.

81. A kit comprising an agricultural composition, the composition comprising a plurality of NLPs each comprising: at least non-polar lipid comprising at least one fatty acid a phospholipid or a synthetic lecithin derivative optionally at least one surface modifier; and a heterologous functional agent; wherein the NLPs comprise a hydrophobic core.

1. An agricultural composition comprising a plurality of nature-derived lipid particles (NLPs) each comprising:
at least one essential oil;
at least one phospholipid; and
at least one surface modifier;
wherein the NLPs comprise a hydrophobic core.

2. The agricultural composition of claim 1, wherein the essential oil is derived from a plant or plant part, and comprises at least one or more of a phenolic, alcoholic and terpenoid compound.

3. The agricultural composition of claim 1, wherein the essential oil is selected from the group consisting of cinnamon oil, tea tree oil, clove oil, Eucalyptus oil, hemp seed oil, patchouli oil, marjoram oil, thyme oil, sweet almond oil, cassia oil, lavender oil, basil oil, castor oil, pumpkinseed oil, citronella oil, cumin oil, amaranth oil, camphor oil, red raspberry oil, peanut oil, pine oil, tobacco oil, carrot seed oil, and spearmint oil.

4. The agricultural composition of claim 1, wherein the at least one essential oil is cinnamon oil.

5. The agricultural composition of claim 1, further comprising a non-polar lipid comprising at least one fatty acid.

6. The agricultural composition of claim 5, wherein the non-polar lipid comprising at least one fatty acid is soybean oil or sunflower oil.

7. The agricultural composition of claim 1, wherein the at least one phospholipid is selected from the group consisting of phosphatidylcholine, phosphatidylethanolamine, phosphatidylinositol, phosphatidic acid, phosphatidyl serine, and 1,2-dimyristoyl-sn-glycero-3-phosphate.

8. The agricultural composition of claim 1, wherein the at least one phospholipid is derived from a lecithin.

9. The agricultural composition of claim 8, wherein the lecithin is sunflower lecithin, soybean lecithin, or a synthetic lecithin.

10. The agricultural composition of claim 1, wherein the hydrophobic core comprises the essential oil.

11. (canceled)

12. The agricultural composition of claim 1, wherein the NLPs comprise at least one phospholipid layer, wherein the NLPs comprise at least one phospholipid bilayer, or wherein the NLPs have a micellar structure.

13-14. (canceled)

15. The agricultural composition of claim 1, wherein the surface modifier is selected from the group consisting of a glycolipid, a polysaccharide, a fatty acid ethoxylate, a linear alcohol ethoxylate, a cetyl trimethyl, a linear isopropylamine dodecybenzene sulfonate, a tristyrlphenol ethoxylate phosphate ester, a modified styrene acrylic co-polymer, a hydrophobically modified polycarboxylate polymer, an anionic polymer, a non-ionic acrylic copolymer, a non-ionic combination polymer, a tristyrlphenol polyalkylene oxide block copolymer, or a head group modified PEG lipid.

16. The agricultural composition of claim 15, wherein the surface modifier is a modified styrene acrylic polymer or a non-ionic combination polymer.

17-19. (canceled)

20. The agricultural composition of claim 1, wherein the NLPs exhibit a negative surface charge as evidenced from a negative zeta potential, and wherein the negative zeta potential ranges between −5 and −100 mV.

21. (canceled)

22. The agricultural composition of claim 1, wherein the NLP particle size ranges between 50-1000 nm.

23. The agricultural composition of claim 1, wherein the composition further comprises at least one heterologous functional agent.

24. The agricultural composition of claim 23, wherein the heterologous functional agent is selected from the group consisting of a pesticidal agent, a fertilizing agent, a herbicidal agent, a plant-modifying agent, an insect attractant, a plant growth promoting agent, a biostimulant, and a plant immunity elicitor.

25. The agricultural composition of claim 24, wherein the pesticidal agent is selected from the group consisting of an antifungal agent, an anti-oomycete agent, an antibacterial agent, an insecticidal agent, a molluscicidal agent, a nematicidal agent, a herbicidal agent, and a virucidal agent.

26-40. (canceled)

41. A method of making an agricultural composition comprising a plurality of NLPs each comprising a heterologous functional agent, the method comprising the step of:
applying energy to a solution comprising;
at least one phospholipid;
at least one essential oil;
at least one surface modifier;
a heterologous functional agent; and
an aqueous solution;
thereby forming the NLPs, wherein the NLPs comprise a hydrophobic core.

42-67. (canceled)

68. A method of increasing the uptake of a heterologous functional agent in a plant, the method comprising contacting the plant with the composition of claim 23, wherein the uptake of the heterologous functional agent is increased compared to the uptake of the same heterologous functional agent contacted with the plant in an unencapsulated form.

69-81. (canceled)
